(19) United States
(12) Patent Application Publication
(10) Pub. No.: US 2021/0119785 A1
(43) Pub. Date: Apr. 22, 2021

(54) DECENTRALIZED PROTOCOL FOR MAINTAINING CRYPTOGRAPHICALLY PROVEN MULTI-STEP REFERRAL NETWORKS

(71) Applicant: 2KEY NEW ECONOMICS LTD., Tel Aviv (IL)

(72) Inventors: Ehud BEN-REUVEN, Tel Aviv (IL); eiTan LAVI, Tel Aviv (IL)

(21) Appl. No.: 17/048,776

(22) PCT Filed: Apr. 18, 2019
(86) PCT No.: PCT/US19/28212

§ 371 Date: Oct. 19, 2020

Related U.S. Application Data
(60) Provisional application No. 62/659,622, filed on Apr. 18, 2018.
(60) Provisional application No. 62/659,645, filed on Apr. 18, 2018.
(60) Provisional application No. 62/659,653, filed on Apr. 18, 2018.

(51) Int. Cl. H04L 9/08; H04L 9/14; H04L 9/32

(52) U.S. Cl. CPC H04L 9/0825; H04L 9/14; H04L 2209/38; H04L 9/3221; H04L 9/085; H04L 9/3247

(57) ABSTRACT

Systems and methods are disclosed for a decentralized protocol for maintaining cryptographically proven multi-step referral networks. In one implementation, a first link is received. Such a first link can include a first private key generated with respect to a first user. A key pair is generated with respect to a second user. Such a key pair can include a second private key and a second public key. Using the first private key, a cryptographic signature of the second public key is computed. A second link which includes the second private key and the cryptographic signature is generated.

### CROSS-REFERENCE TO RELATED APPLICATIONS

This application is related to and claims the benefit of priority to U.S. Patent Application No. 62/659,622, filed Apr. 18, 2018, U.S. Patent Application No. 62/659,645, filed Apr. 18, 2018, and U.S. Patent Application No. 62/659,653, filed Apr. 18, 2018, each of which is incorporated herein by reference in its respective entirety.

### TECHNICAL FIELD

Aspects and implementations of the present disclosure relate to data processing and, more specifically, but without limitation, to a decentralized protocol for maintaining cryptographically proven multi-step referral networks.

### BACKGROUND

Tracking codes can be used across the Internet for marketing-attributions and conversion tracking. Such codes require complex integrations and ongoing management by site/app owners and influencers.

Data/records can be stored on a decentralized or distributed ledger such as blockchain that is synchronized across multiple computing/storage devices. Various cryptographic techniques can be utilized to secure such records.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system, in accordance with an example embodiment.

FIG. 2 illustrates an example system, in accordance with an example embodiment.

FIG. 3 is a flow chart illustrating aspects of a method for implementing a decentralized protocol for maintaining cryptographically proven multi-step referral networks, in accordance with an example embodiment.

FIG. 4 is a flow chart illustrating aspects of a method for implementing a decentralized protocol for maintaining cryptographically proven multi-step referral networks, in accordance with an example embodiment.

FIGS. 5A-5C are flow charts illustrating aspects of a method for implementing a decentralized protocol for maintaining cryptographically proven multi-step referral networks, in accordance with an example embodiment.

FIGS. 6A-6C are flow charts illustrating aspects of a method for implementing a decentralized protocol for maintaining cryptographically proven multi-step referral networks, in accordance with an example embodiment.

FIGS. 7A-7C are flow charts illustrating aspects of a method for implementing a decentralized protocol for maintaining cryptographically proven multi-step referral networks, in accordance with an example embodiment.

FIG. 8 is a block diagram illustrating components of a machine able to read instructions from a machine-readable medium and perform any of the methodologies discussed herein, according to an example embodiment.

### DETAILED DESCRIPTION

Aspects and implementations of the present disclosure are directed to a decentralized protocol for maintaining cryptographically proven multi-step referral networks.

Existing referral-tracking technologies rely on tracking codes for marketing-attributions and conversion tracking. Such codes require complex integrations and ongoing management by site/app owners and influencers that are tasked in propagating the products being sold. Additionally, such codes often require no visibility outside the websites/apps in which they're installed and therefore cannot be placed on a public service such as a blockchain. Additionally, information that is tracked using such codes by separate competing website/app owners will be segregated (such that information tracked by one service may be unavailable to another service). As a result, the influencers are required to do some integration work in advance with the owner. For example, the owner and each influencer can agree on a separate code. In addition, one influencer cannot pass the code to another influencer and give hint some of the credit for any referral made.

Accordingly, described herein in various implementations are technologies that enable referral tracking and other related technologies that don't require the web site to hold a secret code. As described in detail herein, the disclosed technologies can migrate the Internet's tracking from siloed code integrations within business websites or apps into the tracking links themselves.

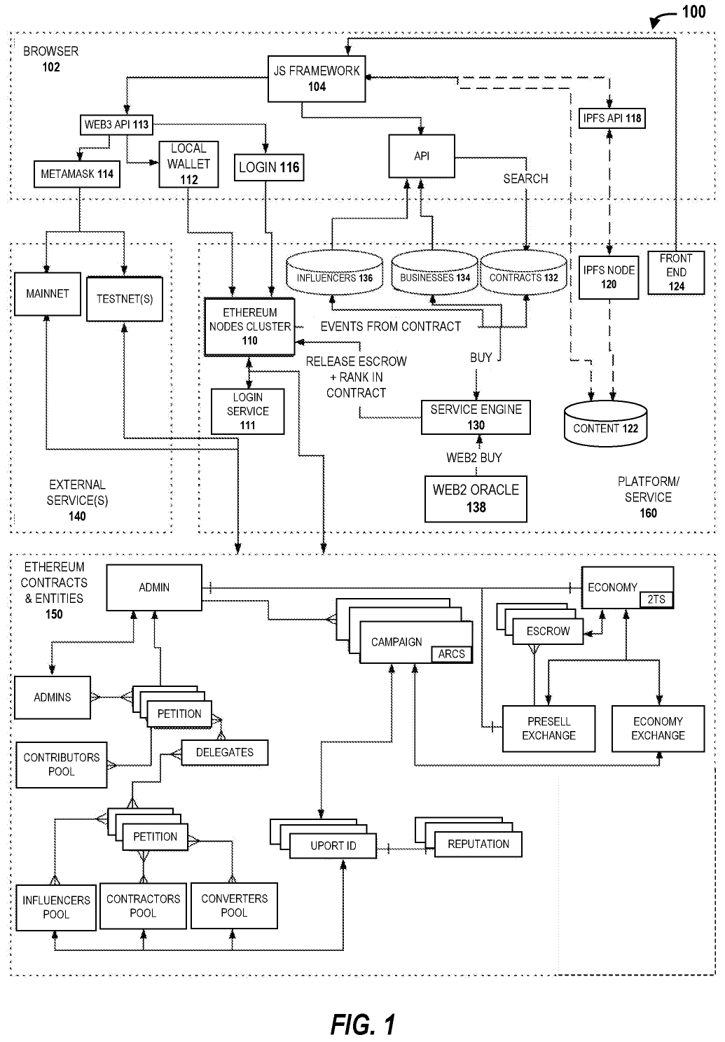

An example environment (including system 100) is depicted in FIG. 1. As shown in FIG. 1, the described technologies (including systems, methods, services, platforms, etc., such as those described/referenced herein) can be implemented in conjunction with various devices, components, elements, etc. For example, an example platform can include or otherwise interface with a decentralized or distributed ledger such as a blockchain (e.g., Ethereum 150, as shown in FIG. 1) that can be distributed/stored across multiple connected nodes. Examples of such nodes are depicted in FIG. 1 and described herein.

The referenced nodes can be computing devices, storage device, and/or any other such connected device or component configured to generate and/or provide verification (e.g., for a transaction, operation, etc.). Various nodes can be connected to one another (directly or indirectly) via various network connections, thereby forming a distributed computing environment or network.

In an example transaction, ownership of a digital token can be transferred from one address to another. To authenticate the transaction, the transaction recording the transfer can be signed by the originating party using a private key associated with that originating party (e.g., as stored on a device or wallet, such as “wallet” as shown in FIG. 1). Such a private key can be a cryptographic key (e.g., a string of bits used by a cryptographic algorithm to transform plain text into cipher text or vice versa) that may be kept secret by a party and used to sign transactions (e.g., the transfer of a token to another user, to a server, etc.) such that they may be verified using the described distributed computing environment.

The referenced signed transaction can then be broadcast across the distributed computing environment/network, where it can be verified, e.g., using the public key associated with the originating party. Such a “public key” can be a cryptographic key that is distributed to, or available to the referenced node(s) so that signed transactions associated with the public key may be verified by the nodes.

During the referenced verification process, the transaction can be accessed or selected by a consensus node (e.g., a device or ‘miner’ configured to verify transactions and add new blocks to a blockchain), verified using the public key, timestamped, and added to a “block” that includes other transaction(s). To perform the referenced verification the consensus node can, for example, solve a cryptographic puzzle, e.g., to identify a nonce value that, when used with a hash function, results in a value formatted in a specific way. Upon solving the puzzle, the consensus node creates a proof of work that is then verified and (if the solution is valid) added to the blockchain ledger.

Adding completed blocks to the blockchain ledger forms a permanent public record of various included transactions. The blockchain ledger can be replicated and distributed across multiple nodes within the distributed environment. In the event that a user tries to utilize a previously transferred digital token, the first transaction conducted using the token address may promulgate to remote nodes faster than any subsequently conducted transaction using the same token address. This allows more time for additional blocks to be added to the blockchain that include the first transaction. In this scenario, a node that receives two separate chains that include blocks with transactions originating from the same token address will choose the longest chain, which should be associated with the first conducted transaction. In such a manner, the blockchain may be used to provide verification of various operations, transactions, etc.

In most blockchain solutions all the information stored can be accessed anonymously by anyone and by itself it cannot store secrets.

Further aspects of the technologies depicted in FIG. 1 are described in detail below.

It can be appreciated that users, entities, businesses, etc. (which may be referred to herein as “contractors”) want other users, entities, or businesses, e.g., customers (which may be referred to herein as “converters”) to purchase, acquire, etc., a unit of its product (which may be referred to herein as “converting”). Using existing technologies, the business can provide a link (e.g., a hyperlink or URL) to a customer through which supplies content that describes the product and provides an option for the customer to buy a unit (“convert”). In certain implementations, the technologies described herein enable such a link to be provided to as many potential customers as possible.

As described herein, in certain implementations the referenced purchase (or related transaction(s)) can be performed using blockchain smart contracts. The business creates a contract on a blockchain (e.g. Ethereum) and a customer buys a unit by sending currency (Ether, coins, etc.) to the contract which then keeps track of the fact that the customer has bought a unit

Existing (“Web 2.0”) technologies enable businesses to disseminate link(s) to customers in various ways. For example, users such as marketing “influencers” can disseminate a link to other users. Such a link can be assigned a unique offer code which helps compensate the influencer in some way. This technique has various limitations. For example, the business may need to initially form a relationship with an influencer. Additionally, these technologies may only be able to track/compensate a single influencer per conversion. In other words, the path of influencers between the business and the customer is of size one. Additionally, a customer may visit the business site directly without the use of the offer code. Additionally, the offer code itself has to somehow be made known to converters only by the influencer that is assigned to it, otherwise it becomes meaningless. The offer code therefore cannot be placed in a public repository accessible to anyone. However, this is usually a requirement when building a blockchain solution.

As described in detail herein, the disclosed technologies enable further solutions to the referenced problem(s)/shortcomings. In certain implementations, such technologies can utilize or implemented decentralized or distributed computing technologies such as blockchain (“Web 3.0). For example, in certain implementations a contract (that is, a ‘smart contract’) can be created for each campaign being sold. The contract can implement a digital token (which may be referred to herein as an “action referral coin” or ARC). Such a token can be used to track the path between influencers up to the conversion, as described herein. However, it requires each influencer to interact with the contract at least once, this requires some fee to be payed to the blockchain system and/or may be limited by the rate at which transactions can be processed on the blockchain.

In certain implementations, the referenced technologies can be implemented using the referenced web 3.0 technologies with cryptographic signature or ‘zero knowledge’ (zk). Such an implementation can be based on or utilize web 3.0 technologies without requiring interaction of the influencers with the blockchain. In certain implementations, such implementations can utilize or incorporate various cryptographic algorithms or techniques (including but not limited to digital signature algorithms or the ‘zkSNARKs’ cryptographic algorithm).

In one example implementation, a business creates a campaign by creating a contract on the blockchain and a link to it. The contract can be publicly available/accessible while the referenced link can contain a secret/private key (similar to an offer code) known only to those who received the link. The business can attempt to pass the link to as many potential customers as possible. These customers know the secret and can use it to obtain a permission, from the contract, to buy/acquire a unit. The business wants to reach more customers, for that it motivates influencers to modify the secret in the link and pass a new link to more customers. The contract itself, however, cannot hold any of the secrets because its entire content is available to anyone.

To keep the influencers motivated to reach customers that did not receive/view the original link, the following techniques can be utilized. The referenced private key/secret information can be passed through links but information on the blockchain (which is always public) may not contain any secret. This provides the influencers an assurance that it is impossible to remove them from a link they have modified and published without having access to the original link, Instead of the original secret, the modified link contains a cryptographic signature or zero-knowledge proof that the influencer knew the original secret. In addition, the modified link contains a modified secret which can be a cryptographic hash of the original secret or it can be a completely new secret. This ensures that it is very hard to derive the original secret if you only know the modified secret. In what follows the word ‘hash’ is used to describe a cryptographic hash function.

When buying/acquiring, a customer can also generate a cryptographic signature or zero-knowledge proof that she knew the secret (otherwise it may be possible for her to remove the influencer(s)). The customer sends her proof along with the proof of the influencer(s) to be able to buy the product.

The contract verifies the proofs and that the influencer(s) and the customer each knew their respective secret along the path. It can then allow the customer to buy the product and allocates a bounty for the influencer(s).

Other influencers can use the new link and modify it again by adding to the link a proof that they know what the modified secret was. In addition, they can add the secret modified yet again allowing for customers or yet more influencers to use their link.

It can be appreciated that the described technologies can be advantageous in multiple scenarios For example, the described technologies don't necessarily require influencers to have any interaction with Ethereum until a conversion is made (and therefore no “gas”—e.g., an execution fee—is spent).

The described system/platform (e.g., as depicted in FIG. 1) can be utilized, accessed, interacted with, etc., by multiple parties, participants, users, etc. Examples of such parties include but are not limited to contractors, influencers and converters, such as are described/referenced herein. Such users can, for example, interact with an application (which can be a distributed application or ‘dApp’). In certain implementations, the referenced application can run/execute in a browser. The browser can be directed to a website (e.g., front-end 124) containing content for running the application (e.g., HTML, images, and JavaScript code). In other implementations, the referenced application can be provided as a mobile or desktop app.

In certain implementations, the referenced dApp can connect or interface with one or more Ethereum nodes 110, e.g., via an API such as a Web3 API 113, such as is shown in FIG. 1. The Ethereum nodes can form with or connected to other nodes the Ethereum network 150. In certain implementations, the Web3 API can utilize or access a wallet Such a wallet can be, for example, a MetaMask browser plugin 114 or stored locally 112 on the browser between sessions or stored on a login service such as the Ethereum node 110 (which may require the user to utilize a login interface 116 to connect to a login service 111).

The referenced dApp can optionally connect to an InterPlanetary File System (IPFS) (or another such protocol) node 120 via an API 118. Such IPFS nodes can form a peer-to-peer network for storing content 122. The dApp can use this network to store content related to a contract. As described herein, the dApp can also use the network (e.g., IPFS) to store cryptographic signatures or zero-knowledge proofs. It should be understood that IPFS is referenced herein only by way of example, and that any other centralized or decentralized storage resource or service can also be utilized.

In certain implementations, the referenced dApp can utilize a service engine 130 (which can be, for example, an application, module, service, etc.) and/or one or more other elements within platform/service 160. Such an engine can be an application, program, module, etc. that executes on/in conjunction with platform/service 160 and tracks changes on the Ethereum network and updates repositories of contracts (132), businesses (contractors) (134) and influencers (136). The engine 130 can also rank business and influencers.

In certain implementations the referenced engine can function as an administrator, e.g., to a contract's escrow mechanism. For example, a web2.0 plugin installed at business web sites can be used (e.g., as an ‘oracle’ 138 such as is depicted in FIG. 1) to detect if a conversion was finalized. When that happens, the oracle can communicate with the relevant contract and release the purchase that was held in escrow. When releasing a purchase, the oracle can determine how to distribute the bounty between influencers (e.g., based on their rank).

It should be noted that, in certain implementations, users can use a dedicated ICO contract for their transactions (e.g., instead of Ether).

State channel system—the system described herein may involve calling the buy-method of the contract by a customer who wishes to convert. This call may require validation of zero-knowledge proof which can be ‘expensive’ when done by Ethereum. Alternatively, in certain implementations a state channel can be maintained between the contract administrator (e.g., the business or the described platform) and the user(s). In such a configuration, the customer sends a buy request to the administrator instead of the contract. The administrator can perform the ‘expensive’ validation off-chain and generates a signed confirmation that a conversion was made. Such a confirmation can be sent to other user(s) involved who can use the signed confirmation, e.g., to withdraw their balance from the contract. If multiple conversions are happening in the same contract, the confirmed conversions made can be accumulated. Doing so, allows users to withdraw their balance in a single (“cheap”) Ethereum transaction.

The validation of the proof can also be performed, for example, by one or more external service providers (‘oracles’). These service providers can be listed in the contract (e.g., when it is created). To ensure that an oracle is validating legitimate proofs, the described technologies can be configured to require that each oracle sets up a contract on Ethereum that holds a deposit made by the oracle. This oracle can release the deposit to anyone who can demonstrate that the oracle has rejected a buy transaction that should have been approved.

Web 2.0 system using zero-knowledge or other such cryptographic signature techniques—the methods, techniques, etc. described herein can be used in a web 2.0 system that does not utilize contracts (e.g., in any way). In certain implementations, the referenced state-channel system can be implemented in a web 2.0 site. The proof validation can be used to withdraw a balance from the website itself (and not from the contract). The advantage of such a system (e.g., compared to a regular web 2.0 website) is enabling more than one influencer in the path from the business to the customer. Another advantage is that the influencers don't necessarily need to signup or register in advance with the business before publishing a link. Each influencer can be identified by her address and converting this address into something (e.g., an identifier) that can be used to withdraw a balance may only be needed when a withdraw operation is made for the first time.

In certain implementations, the described technologies can be configured such that the referenced influencer does not necessarily need to interact with the referenced website. For example, the referenced address itself can be utilized to perform the described bounty transfer. In such a scenario, the website can automatically send bounties to associated influencers based on their address. Such an address can be, for example, a valid address on any banking system (regular, online, or cryptocurrency system.)

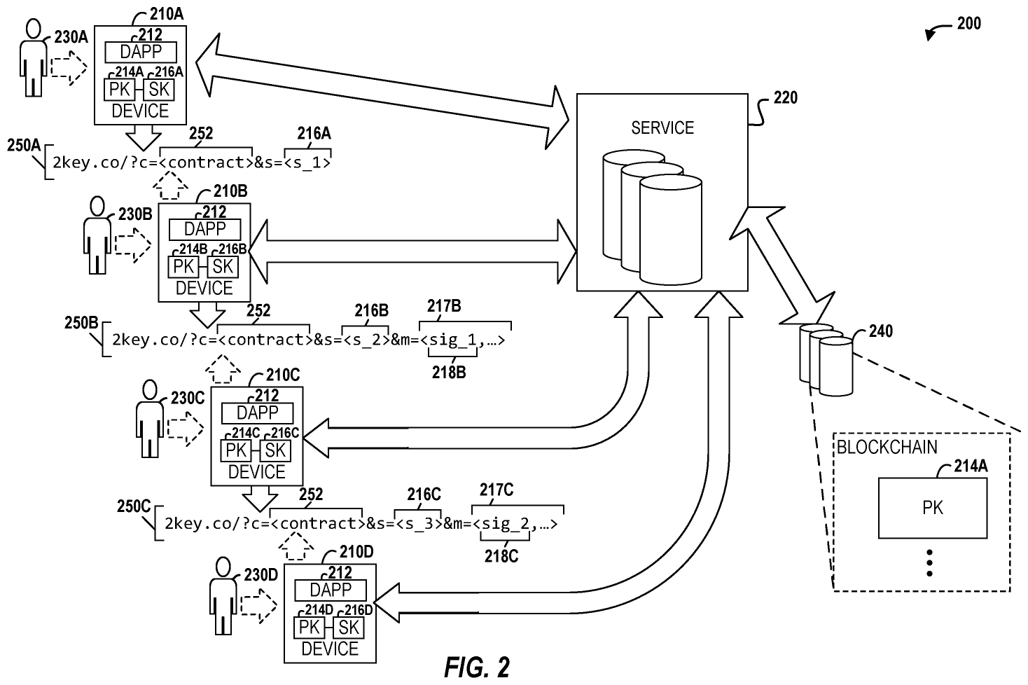

Further aspects of the described elements, operations, and lifecycle are depicted in FIG. 2 which depicts aspects of an example system 200, in accordance with some implementations. It should be understood that elements depicted with respect to system 200 are also depicted with respect to FIG. 1 and described in further detail herein.

As shown, system 200 includes components such as device(s) 210. Device 210 can include a laptop computer, a desktop computer, a terminal, a mobile phone, a tablet computer, a smart watch, a wearable device, a personal digital assistant (PDA), a digital music player, a connected device, a speaker device, a server, and the like. User(s) 230 can each be human users who interacts with respective device(s). For example, user 230A can provide various inputs (e.g., via an input device/interface such as a keyboard, mouse, touchscreen, microphone, camera, etc.) to device 210A. Such device(s) can also display, project, and/or otherwise provide content to the user (e.g., via output components such as a screen, speaker, etc.).

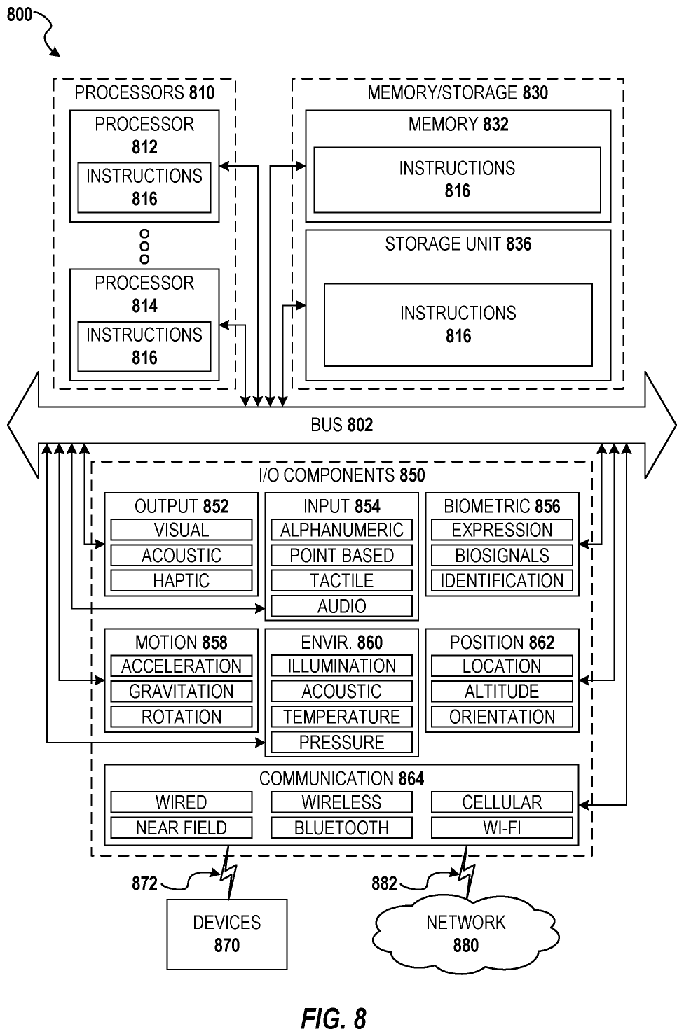

As shown in FIGS. 1 and 2, such device(s) can include one or more applications such as distributed application (‘dApp’) 212. Such an application can be a program, module, or other executable instructions that configure/enable the device to interact with, provide content to, and/or otherwise perform operations on behalf of a user, e.g., in order to initiate and/or execute various operations as described in detail herein. Such application(s) can be stored in memory of one or more device(s) (e.g. memory 830 as depicted in FIG. 8 and described below). One or more processor(s) of the device (e.g., processors 810 as depicted in FIG. 8 and described below) can execute such application(s). In doing so, one or more of the referenced device(s) can be configured to perform various operations as described herein. Additionally, in certain implementations the referenced dApp can execute in conjunction with a browser executing on the referenced device, as depicted in FIG. 1 and described in detail herein.

It should be noted that while dApp 212 is depicted and/or described as operating on a device, this is only for the sake of clarity. However, in other implementations such elements can also be implemented on other devices/machines. For example, in lieu of executing locally at a device 210, aspects of the referenced application(s) can be implemented remotely (e.g., on a server device or within a cloud service or decentralized framework).

As also shown in FIG. 2, device(s) 210 can connect to and/or otherwise communicate with service 220 (e.g., a centralized, decentralized, or distributed service, such as is depicted in FIG. 1 and described in detail herein). Connections between the various devices/machines can be initiated and/or maintained via various networks such as the Internet, a wide area network (WAN), a local area network (LAN), a virtual private network (VPN), an intranet, and the like.

Further aspects of the operations of system 200 are described in detail herein.

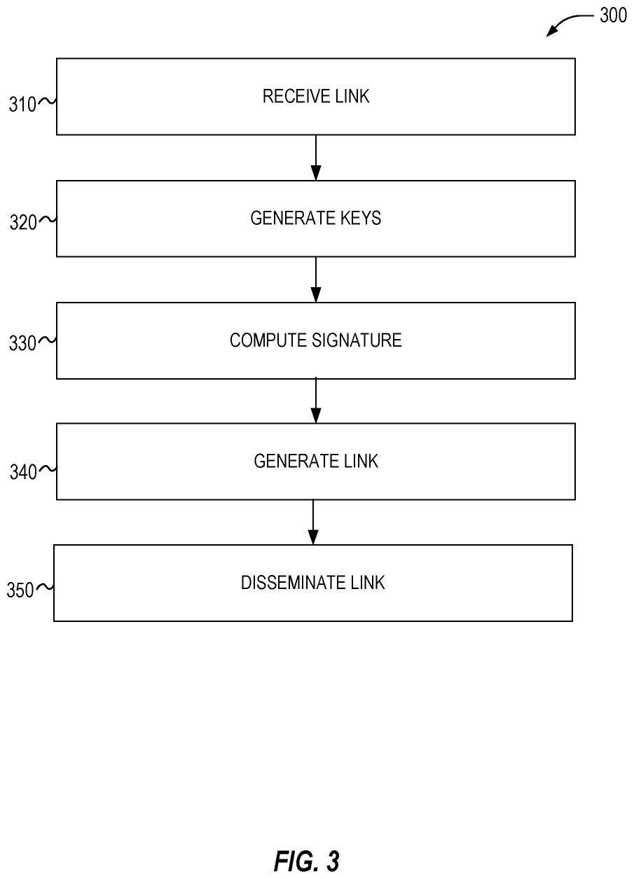

FIG. 3 is a flow chart illustrating a method 300, according to an example embodiment, for implementing a decentralized protocol for maintaining cryptographically proven multi-step referral networks. The method can be performed by processing logic that can comprise hardware (circuitry, dedicated logic, etc.), software (such as is run on a computing device such as those described herein), or a combination of both. In one implementation, the described methods can be performed by one or more elements depicted and/or described in relation to FIG. 1 and/or FIG. 2 (e.g., browser 102, which may be a web browser or other such application that executes on a device, such as a device 210 as depicted in FIG. 2 and described in detail herein, service 220, etc.), while in some other implementations, the one or more operations can be performed by another machine or machines.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

At operation 310, a first link is received. For example, as shown in FIG. 2, user 230A (here, a ‘contractor’) can initiate a contract by executing dApp 212 and accessing or otherwise communicating with service 220 (e.g., platform/service 160 as depicted in FIG. 1 and described herein). In doing so, in certain implementations a key pair can be generated and/or retrieved (e.g., from secure storage). Such a key pair can include public key (‘PK’) 214A and private key (‘SK’) 216A. Alternatively, in certain implementations, an identifying parameter (e.g., an address associated with the first user) and an existing/previously generated first secret can be utilized. For example, as shown in FIG. 2 and described herein, public key 214A (or the referenced identifying parameter) can be written to the contract and stored on a public blockchain 240 (e.g., Ethereum). In other implementations, A link 250A can be generated which includes contract address 252 (e.g., the address of the smart contract on the blockchain, an Ethereum address, and/or an address at which service 220 maintains the details, parameters, etc. of the contract, campaign, etc.) and secret/private key 216A. User 230A can then disseminate link 250A (e.g., via social media, email, etc.). Additionally, in certain implementations the referenced first link further can also include a zero knowledge cryptographic proof, as described herein.

User 230B can then receive or otherwise access such a link 250A. As noted, such a link can include or reflect a first secret/private key 216A (e.g., as generated with respect to or otherwise associated with a first user 230A). As noted, such a first private key 216A can correspond to a first public key 214A generated by the previous user in the chain (here, user 230A). Additionally, as noted, in certain implementations, such a first public key 214A can be associated with a contract (e.g., a smart contract, as described herein). Moreover, in certain implementations such a first link can also include a contract address, as described herein.

In certain implementations, the referenced first link 250A can initiate execution of a decentralized application. For example, upon accessing link 250A via a web browser, dApp 212 can execute on device 210B, as described herein.

At operation 320, a key pair can be generated and/or retrieved (e.g., from secure storage), e.g., with respect to a second user. For example, having executed dApp 212, device 210B can generate a key pair that includes, for example, a second secret/private key 216B and a second public key 214B.

At operation 330, a cryptographic signature or proof can be computed. In certain implementations, such a proof/signature can be, for example, a signature of the second public key (e.g., public key 214B as generated or retrieved at operation 320) and various parameter(s) associated with the second user (such as its address, e.g. on Ethereum, its weight, etc.). Additionally, in certain implementations such a proof/signature can be computed, for example, using the first secret/private key (e.g., secret/private key 216A, as received within link 250A at operation 310). In certain implementations, such a proof can be a zero knowledge cryptographic proof, e.g., a proof that the second user (e.g., user 230B) received, knew, or otherwise had access to the first secret/private key (e.g., secret 216A). Additionally, in certain implementations such a proof can require knowledge of an identifying parameter (e.g., an address or public key) associated with the second user, as well as other parameter(s) (e.g., those added to the second link by the second user), as described in detail herein. Moreover, in certain implementations the referenced proof can be a zero knowledge cryptographic proof that the second user knew the value of the first secret without exposing the first secret (e.g., as described herein). Additionally, in certain implementations the referenced proof can be a cryptographic signature in which the identifying parameter associated with the second user is signed with the first secret. Additionally, in certain implementations the referenced proof can be a cryptographic signature of an identifying parameter associated with the second user (the cryptographic signature being generated using the first private key).

In certain implementations, such a proof/cryptographic signature can be computed via a decentralized application, e.g., as accessed via the first link 250A, as described herein. For example, the referenced proof/cryptographic signature can sign various parameters associated with the second user, such as the second public key, an address associated with the user, parameter(s) that define aspect(s) of a subsequent dissemination of the link, a contract address, an identifier/identifying parameter associated with the second user, a weight assigned by the second user, parameter(s) provided by the first user within the first link, parameter(s) corresponding to other user(s) associated with the first link (e.g., users other than the first user and the second user), content from the first link (e.g., without the first secret/private key) etc., as described herein. Additionally, in certain implementations one or more of the described proofs/signatures can be aggregated, e.g., as described herein. For example, in certain implementations the first link can include a zero knowledge cryptographic proof and the computed zero knowledge cryptographic proof (e.g., as computed at operation 330) can be aggregated into such a zero knowledge cryptographic proof included in the first link the referenced proof, as described herein.

At operation 340, a second link is generated (e.g., link 250B, as shown in FIG. 2). In certain implementations, such a second link can include a second secret/private key (e.g., secret/private key 216B as generated at operation 320 and/or otherwise associated with the second user) and the proof/cryptographic signature (e.g., signature 218B, as computed at operation 330). In certain implementations, the second link can also include content from/originating at the first link (e.g., without the firsts secret/private key). For example, as shown in FIG. 2, link 250B can include contract address 252 which originated from link 250A, as described herein.

Additionally, in certain implementations the referenced second link can include various additional information, fields, elements, etc. In certain implementations, such elements can be stored in a ‘message’ field or segment (e.g., message 217B, as shown in FIG. 2), as described in detail herein. For example, in certain implementations the referenced second link can include identifying parameter(s) associated with the second user, such as the address (e.g. on Ethereum) of the second user, as well as other parameter(s) such as those that define aspect(s) of a subsequent dissemination of the second link (e.g., how a bounty should be divided, allocated, etc. among influencers), as described herein.

Additionally, in certain implementations the referenced second link can include a reference to a storage resource (e.g., a link to IPFS or another storage service, location, etc.) that stores the second secret/private key, the cryptographic proof/signature, and/or other parameter(s) referenced herein. Doing so can enable the link size to remain relatively small.

In certain implementations, the referenced second link can also include a proof, signature, etc. generated using another secret/private key associated with the second user (e.g., an Ethereum private key). In doing so, the user can verify his/her identity, as described in detail herein.

Additionally, in certain implementations the referenced second link can include other parameters (e.g., within the referenced ‘message’ segment 217B) such as identifying parameter(s) associated with the second user, such as the address (e.g. on Ethereum) of the second user, a weight assigned by the second user, an address associated with the first user, etc. Moreover, in certain implementations the referenced second link can include other parameters that correspond to or reflect other users associated with the first link (e.g., prior influencers in a chain), as described herein. For example, in certain implementations the referenced parameter(s) (which may be added by various ‘influencers’ as the link is passed) can be maintained in the referenced ‘message’ segment. In doing so, for example, the referenced address of each user (and other associated parameters) can be maintained in the link as it is passed, as described herein.

At operation 350, the second link (e.g., as generated at operation 340) can be disseminated (e.g., via web 2.0 services or any other such techniques). Subsequent users (e.g., user 230C) can access the link and perform comparable operations with respect to it. One or more user(s) (e.g., user 230D) may ultimately convert via such a link, as described in detail herein.

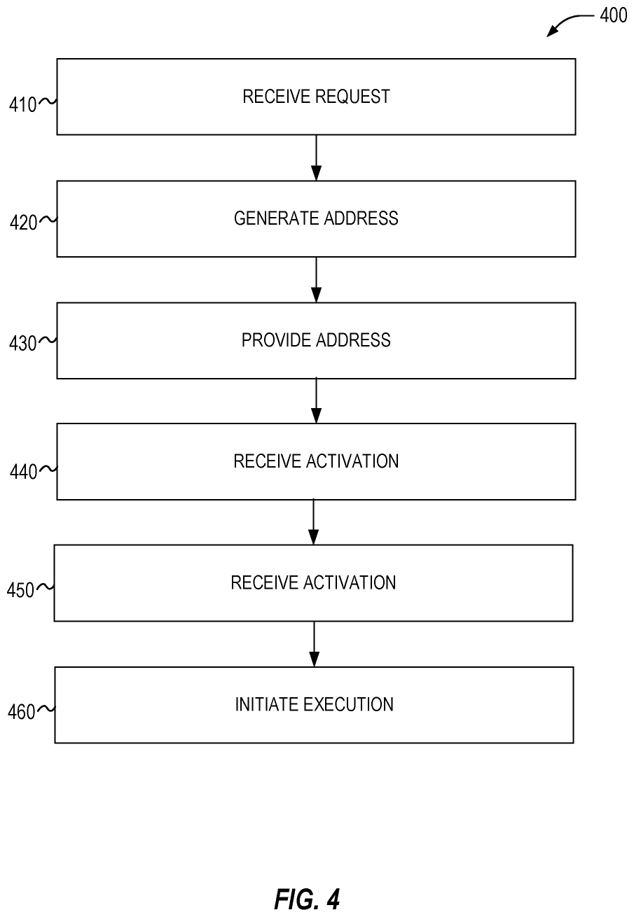

FIG. 4 is a flow chart illustrating a method 400, according to an example embodiment, for implementing a decentralized protocol for maintaining cryptographically proven multi-step referral networks. The method can be performed by processing logic that can comprise hardware (circuitry, dedicated logic, etc.), software (such as is run on a computing device such as those described herein), or a combination of both. In one implementation, the described methods can be performed by one or more elements depicted and/or described in relation to FIG. 1 and/or FIG. 2 (e.g., platform 160, service 220, device(s) 210, etc.), while in some other implementations, the one or more operations can be performed by another machine or machines.

At operation 410 a contract initiation request is received, e.g., from a first user. For example, as shown in FIG. 2, user 230A can utilize device 210A to activate dApp 212 and interface with service 220 in order to initiate a contract. Such a contract initiation request can include various parameter(s) associated with the contract (e.g., the type of contract, length of time, maximum number of influencers, bounty, etc.), as described in detail herein. Additionally, the referenced contract initiation request (e.g., as received by service 220 from device 210A) can also include identifying parameter(s) associated with the first user, such as an address (e.g. on Ethereum) of the first user and/or a public key associated with the first user (e.g., public key 214A, as described herein). Additionally, in certain implementations the referenced contract initiation request can also include a bounty provided by the first user (e.g., upon conversion).

At operation 420, a contract address is generated (e.g., by service 220), e.g., in response to the contract initiation request (e.g., received from user 230A).

At operation 430, the contract address (e.g., contract address 252 as generated at operation 420) is provided the to the first user (e.g., user 230A). As shown in FIG. 2 and described herein, such a contract address can be incorporated into link 250A and disseminated by user 230A.

At operation 440, an activation of a first link (e.g., link 250A) can be received, e.g., from/with respect to a second user (e.g., user 230B). As noted, the referenced first link (250A) can include the contract address (e.g., contract address 252, as generated at operation 420). Additionally, such a first link (250A)—which is activated by the second user 230B—can be generated by the first user 230A, as described herein.

At operation 450, an activation of a second link is received, e.g., from/with respect to a third user (e.g., user 230C). As noted, the referenced second link (250B) can include the contract address (e.g., contract address 252, as generated at operation 420). Additionally, such a second link (250B)—which is activated by the third user 230C—can be generated by the second user 230B, as descried herein.

As described in detail herein, the described operations can be repeated with respect to multiple additional users, thereby increasing the referral chain.

At operation 460, an execution of the contract can be initiated, e.g., with respect to one or more users. In doing so, one or more signatures within the link (through which the conversion occurred) can be validated, as described in detail herein.

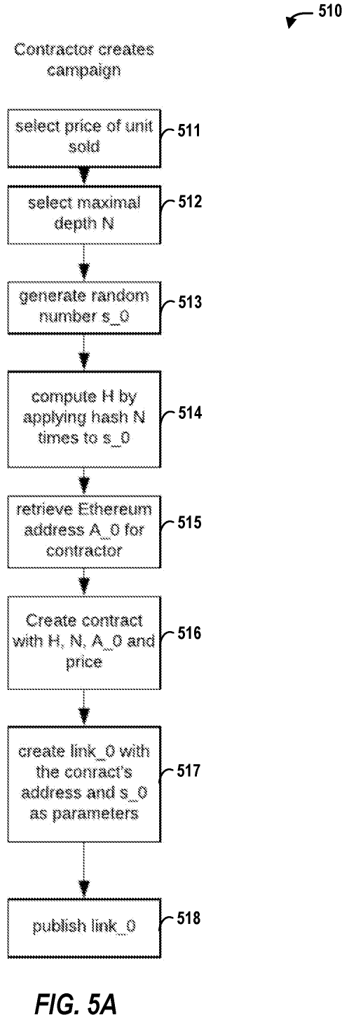

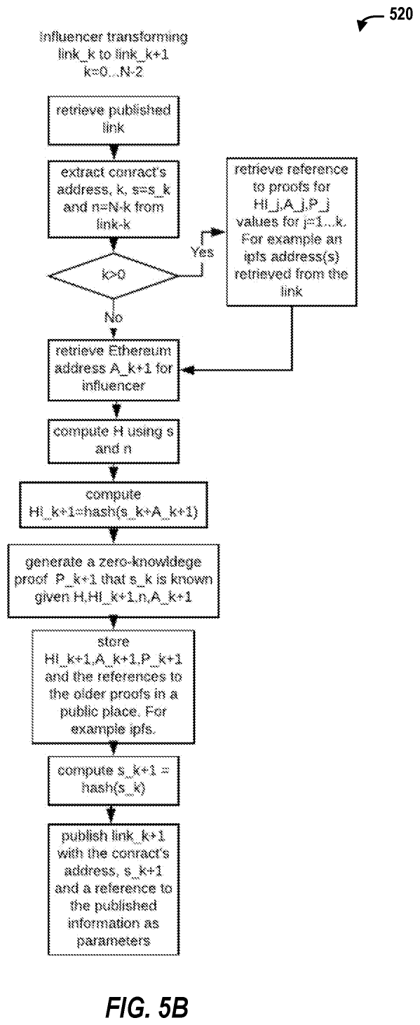

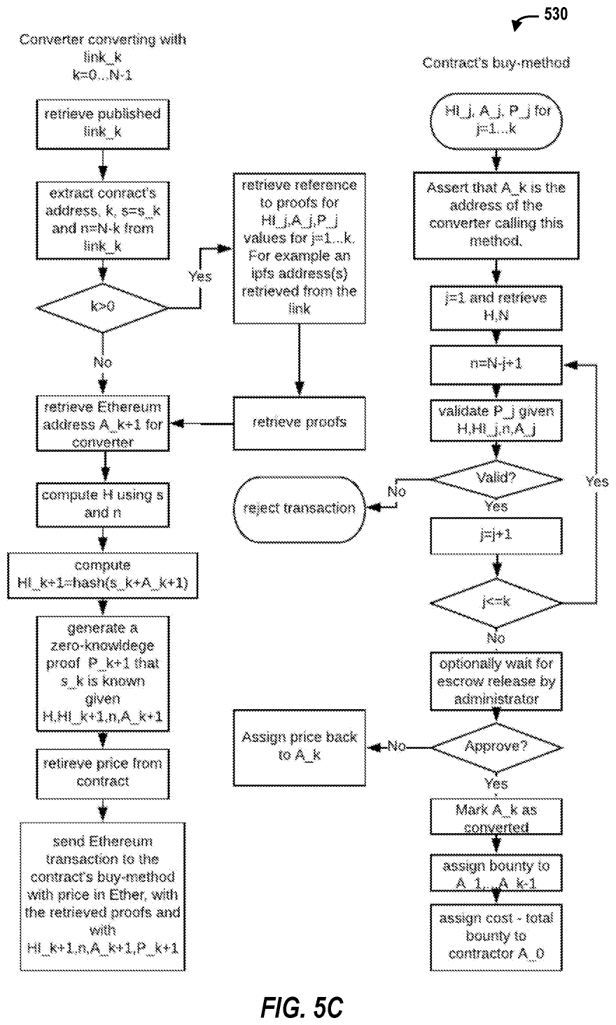

Further aspects of the described technologies are depicted and described with respect to method 510, as shown in FIG. 5A. For example, in certain implementations, the referenced business can create (e.g., with a dApp such as a web page containing JavaScript code/framework 104 running on her browser 102, which may be a web browser or other such application that executes on a device, such as a device 210 as depicted in FIG. 2 and described in detail herein), an Ethereum contract that contains information associated with a product (e.g., the price of a unit sold in the contract and optionally a reference for content describing the product being sold) (511).

The referenced business can also decide or dictate the maximal number of influencers in a path from the business to the customers (512). For example, the business can dictate at most one influencer and a customer so the maximal depth is N=2. The dApp generates a secret random number s_0 (513) and computes its hash: H=hash(hash(s_0)) the hash is applied N times (514). H and the maximal depth N=2 can also be stored in the contract (e.g., as part of its creation) (515-516).

The referenced dApp can creates a link (517) (e.g., a zk link) which contains the secret s_0 in addition to the contract address. For example: 2key.co/?c=<contract>&s=<s_0>. The business can publish the link (518) hoping it will reach as numerous influencers and customers.

It should be understood that in the described scenario, the contractor is responsible to store the public information about the link (e.g., H and N) inside the contract,

Additionally, in the various methods described (e.g., zk or signature, such as are depicted in FIGS. 5A-5C, 6A-6C, and 7A-7C and described herein) the referenced link begins with public information which is stored in the contract. The contractor can, for example, both create the first link and store the information in the contract.

However, once an information about an influencer is written in the contract (e.g., when a conversion occurs, and the influencer receives an ARC token on the contract, proving he was the influencer to the conversion) the influencer may elect to start his own link. Once such an on-chain proof occurs, the influencer can store the public part of the link it created inside the contract. It can be appreciated that, as far as such a newly created link is concerned, the influencer is acting as the contractor for that link.

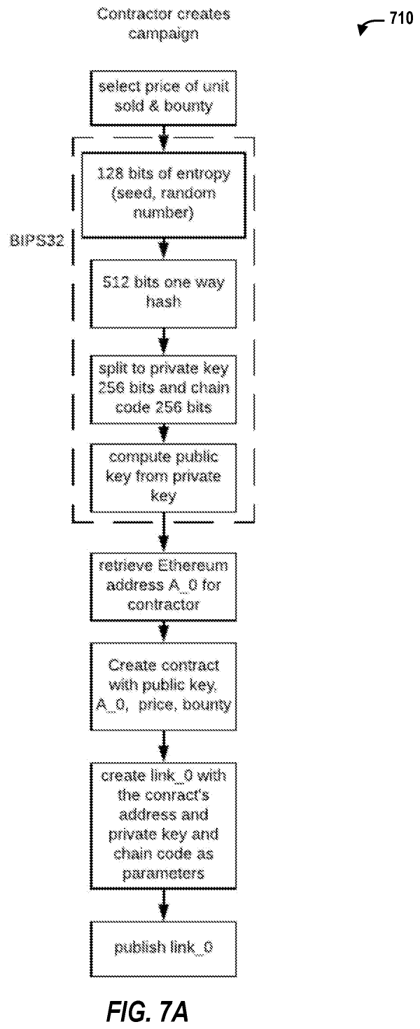

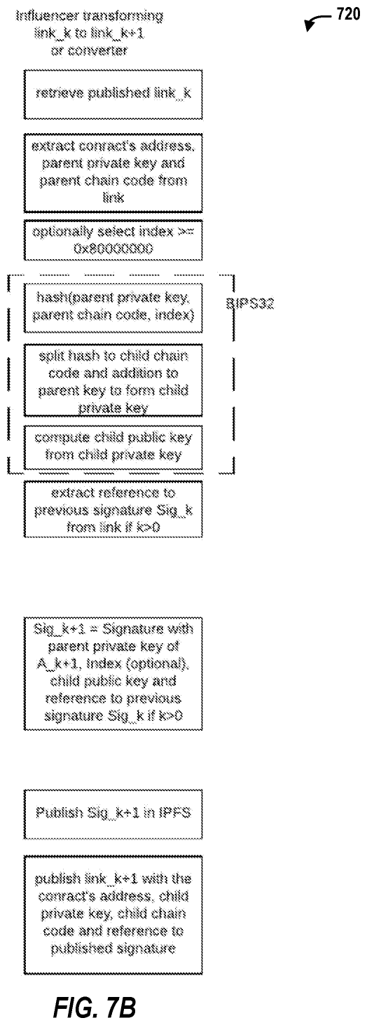

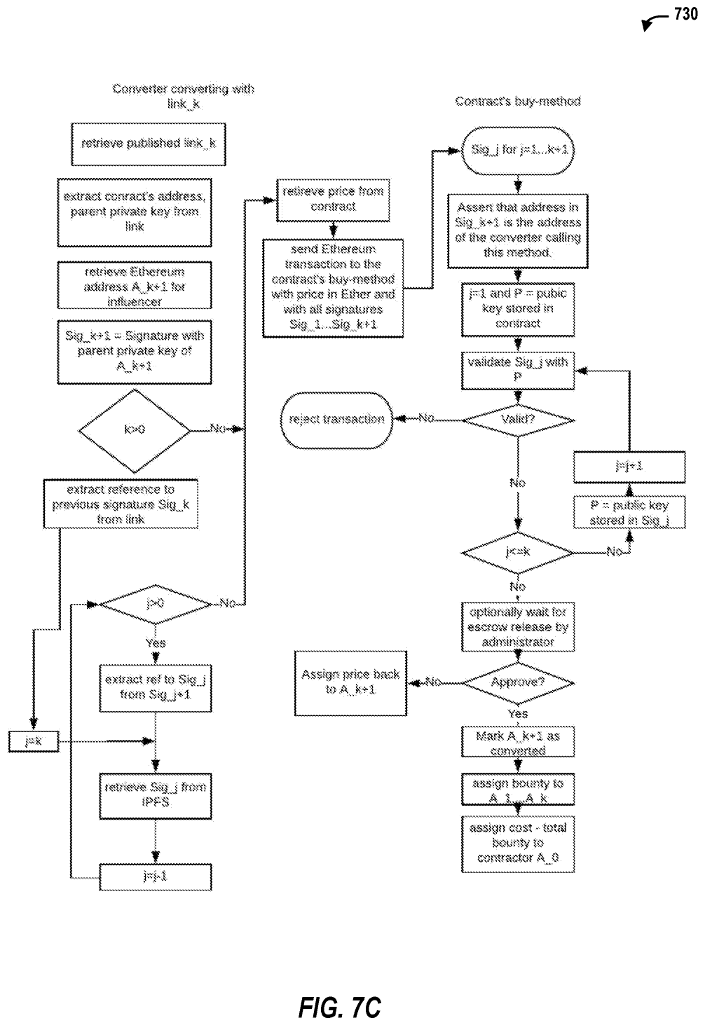

FIG. 7B depicts aspects of an example method 720 in which an influencer transforms a link (e.g., the link created in FIG. 7A), e.g., in a manner described herein. FIG. 5C depicts aspects of an example method 530 in which a converter converts (e.g., executes a transaction, etc.) via one of the described links (e.g., a link created in FIG. 5A and/or disseminated in FIG. 5B), e.g., in a manner described herein.

By way of further illustration, ‘customer 1’ can be a customer that found the link as it was published by the business. She opens the link in her browser. The browser fetches the dApp from a website and runs it. The dApp can, among other things, retrieve and display the description of the contract “c”.

In certain implementations, the dApp can include a ‘BUY’ button (or any other such selectable control). When selected, pressed, activated, etc., the secret “s” can be processed from the link. In certain implementations, a naive solution can be for the dApp to send the secret to the contract's buying method with the amount of ETH needed to buy the product sold in the contract (and ‘gas’). The contract can validate that H==hash(hash(s_0)) (hash is applied twice because in this example when the maximal depth N is 2, in general the hash will be applied N times). The customer can thus ‘prove’ or verify to the contact that she had access to the original link and the contract will allow the purchase to proceed/execute.

The contract can also maintain/keep a track of the accumulated EMI balance for each user. The ETH can be kept in escrow for a later release by a contract escrow administrator or it can be added to the business's accumulated balance. The business can later redeem the ETH accumulated balance.

Zero-knowledge proof—Being that transactions on the blockchain are publicly accessible, anyone can read the secret s_0 from them. Accordingly, in certain implementations the described technologies can be configured to enable the customer to send a zk (zero-knowledge) proof or verification that she knows the secret (without actually sending it). In certain implementations, such a proof can be generated by calling special code inside the dApp. The proof can demonstrate that dApp knew the value of a secret ‘s’ and it proves it by running the pseudocode (e.g., as shown below) with publicly known values H, n, HI and A and with a secret value s:
def verify(H,n,HI,A, s):
   assert(HI==hash(s+A)
   assert(H==hash\hat{ }n(s))//apply hash n times
   return 1

The referenced pseudocode can be used for various usages of the contract. For example, it can be compiled and converted into JavaScript code for generating proofs as part of the dApp's code. For example, operations such as ‘compute-witness’ and ‘generate-proof’ can be used (e.g., as found in ‘zokrates’). In addition, the compilation can place a library on Ethereum to verify the proof and to be used by other zk contracts. For example, using the referenced compile, setup and export-verifier steps.

The dApp can also create the proof to be used as input, along with public values, to the Ethereum verify library. It does this, for example, by running the JS code with the following parameters:

A is the Ethereum address of the person running the dApp

s is the secret (for now s_0)

H=hash(hash(s))

n=N=2

HI=hash(s+A)

The result is a proof P which is a list of values.

Customer using ZK—The customer's dApp sends P, A and HI to the contract. The contract can know or identify H, n=N and verifies that P is valid and allows the purchase to be made. The values P, A, N, HI and H are now all public but it is impossible to recreate s and the original link from them.

By way of further illustration, ‘Influencer 1’ can be an influencer that found the link as it was published by the business.

The dApp's JOIN button or control can convert the link to a new link which adds the influencer. In doing so, the dApp can remove the secret s_0 from the link. As a result, the new link cannot be used by customers anymore. However, a new secret can be computed s_1=hash(s_0) and added to the link.

The dApp can perform the operations described above to form a proof P. In various implementations, the proof can be stored itself in the link, or the dApp can store the proof in a public location (e.g., an IPFS file, along with its address A and HI). This information can become public and identified with an IPFS address ipfs_1.

An example new link can look like:
2key.co/?c=<contract>&ipfs=<ipfs_1>&s=<s_1>

The Influencer can make this new link available to “downstream” customers and influencers. Notice that Influencer did not have any interaction with Ethereum

Customer 2—‘Customer 2’ can be a user, entity, etc., that found the modified link as it was published by influencer 1. She opens the link and runs the dApp. The dApp's ‘BUY’ button/control takes s_1 from the link and reads the IPFS file content P_1,A_1,HI_1. The dApp then uses s_1, n=N-1=1 and its own address A_2 to compute HI_2 and P2. It then sends all this information (P_1,A_1,HI_1, P_2, A_2, HI_2) to the contract to complete the purchase.

Contract behavior for customer 2—the contract can call the verify library twice to check both P1 with public information A_1,HI_1,n=2,H and P_2 with public information A_2, HI_2, n=1, H.

The customer can thus prove or verify that she had access to the modified link secret s_1 and that it provided the influencer information that knew s_0. Then, the contract can allow the purchase to proceed/execute. A bounty can be allocated to the influencer (A_1.) This allocation can happen when ‘BUY’ is called or when the escrow is released.

Having a longer path—The maximal path N used above can be increased to another value to allow having paths with more influencers. For example N=3. In this case the contract will store H=hash(hash(hash(s_0))). A downstream influencer can take the modified link, create a proof that he knew the modified secret s_1 (with N-1) and stores it in ipfs_2 along with the proof of the first influencer or a reference to it using ipfs_1. And creates a new link:
2key.co/?c=contract>&ipfs=<ipfs_2>&s=<s_2>

A customer using this downstream link creates a proof P_3 showing it knows s_2 (with N-2) and send it to the contract with P_2 and P_1. The contract validates P_1,P_2,P_3 and distribute the bounty between A_1 and A_2.

Optimization—in certain implementations, the zk solution above may requires the contract to verify each influencer in the path and the customer. Given substantial ‘gas’ costs, in certain implementations recursive SNARKs can be used to use a single proof verification for the entire path.

Example pseudocode described for the proof can be:
def verify(H,n,HI,A, s):
   assert(HI==hash(s+A)
   assert(H==hash\hat{ }n(s))//apply hash n times
   return 1
def hashN(x,N):
y1=hash(x)
y2=hash(y1)
y3=hash(y2) p1 y4=hash(y3)
y=y1
y=if N==2 then y2 else y fi
y=if N==3 then y3 else y fi
y=if N==4 then y4 else y fi
return y

The code can also supply the hash function. For example, using SHA256 from libsnark, it can accept two values so instead of performing hash(s+A), hash(s,A) can be performed. Also, instead of passing H,HI,A,s as (large) integers, a list of 256 bits can be passed for each.

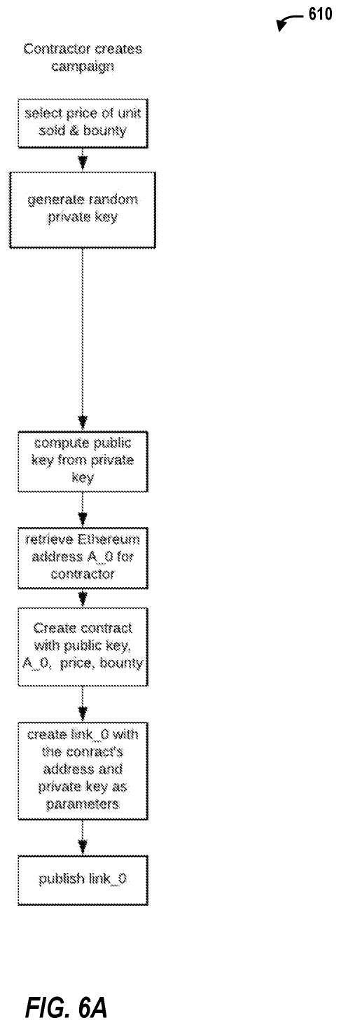

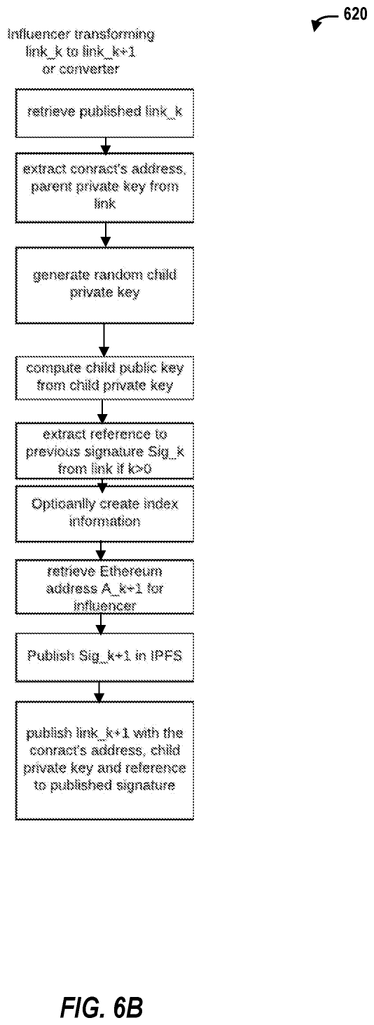

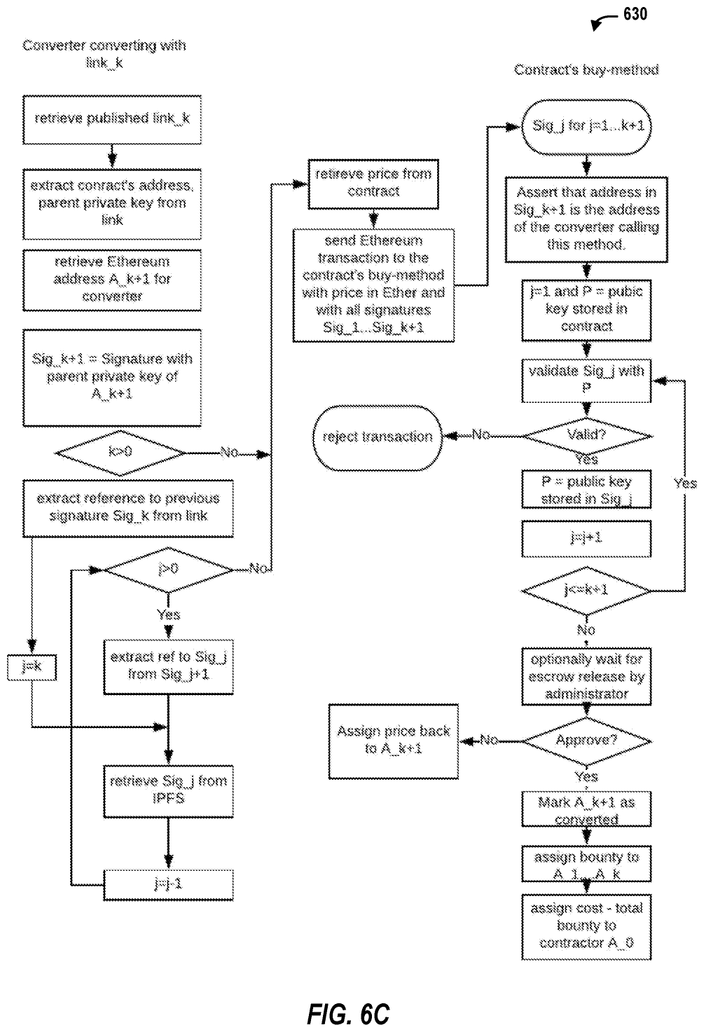

FIGS. 6A-6C depict further aspects of the described technologies, e.g., as implemented with respect to ‘Web 3.0’ technologies using Key Creation and/or Random Key Creation—In such alternative implementations, a random private-public key pair can be used along the path from contractor to converter. Private keys can be passed through the links and public keys can be managed by the contract. For example, FIG. 6A depicts aspects of an example method 610 in which a random private key is generated and used to compute a public key. In doing so, a contractor can create a campaign, e.g., in a manner described herein.

In such an implementation, an influencer receives a secret from the contractor or an upstream influencer through the link. FIG. 6B depicts aspects of an example method 620 in which an influencer transforms a link (e.g., the link created in FIG. 6A), e.g., in a manner described herein. For example, as shown in FIG. 6B and described herein, the influencer creates a new link containing a proof that he knew the secret. In addition, the new link contains a new version of the secret that can be used by downstream influencers. The link can also keep the proofs of the upstream influencers. When a converter wants to convert (buy), she generates a proof that she knew the last secret and sends the proofs to a contract on Ethereum. The contract validates the proofs, extracts the address from the proofs, and distributes bounty.

As shown in FIG. 6B, the secret in this solution is a new random private key, different from the private keys used by the users to control their accounts. When a contractor creates a campaign, he also (with the help of his dApp) creates a new random private-public key pair (e.g., as shown in FIG. 6A and described herein). The public key is stored in the contract and the private key is added to the link. An alternative to randomly creating the new private key is to apply a hash function on the private key used by the contractor in Ethereum (or to use the private Ethereum key to sign a known message).

An influencer or converter exposed to a (parent) link can prove that he received, accessed, saw, etc. the link by using the parent private key found in the link.

An influencer can create a new random child private key and replace in the link the parent private key with the child. The influencer computes the public key for the new child private key. An alternative is to derive the child's private key from hash of influencer's Ethereum private key (or to use the private Ethereum key to sign a known message).

The influencer signs his address, the new child public key and optionally any additional information (called index). The referenced ‘additional information’ can include, for example, voting weight that each influencer and converter can add to the link. When a final conversion is made all weights can be tallied (e.g., to determine an outcome of a vote).

Moreover, in certain implementations the referenced additional information can include or reflect the amount of bounty requested or required by the influencer. Various other examples provided herein may assume that that the contract computes how much each influencer will receive (e.g., the bounty is divided equally between all influencers in the link). However, in certain scenarios the influencer can provide parameter(s) to the contract. For example, the influencer can specify what percentage from the maximal bounty it wants In such a scenario, the leftover from the bounty can be passed to the influencers ‘downstream’ By using this parameter, an influencer can decide and dictate how much he wants to motivate the downstream influencers

As noted, the referenced ‘additional information’ can include a signature generated with the Ethereum private key of the influencer of the public address of the new secret and of any additional information such as the voting weight or bounty parameters. This signature proves that the influencer was indeed responsible to extend the link and to put the voting weight in it. It should be understood that such an (optional) signature is different from the signature which is done with the private key extracted from the link.

The signature can be generated with the parent private key extracted from the link. The influencer stores the signature in a public place. Alternatively, the signature can be stored directly in the link or the link can keep a short handle to a signature-file stored externally (IPFS) as described above.

FIG. 6C depicts aspects of an example method 630 in which a converter converts, executes a transaction, etc. via one of the described links (e.g., a link created in FIG. 6A and/or disseminated in FIG. 6B), e.g., in a manner described herein. As shown in FIG. 6C, in certain implementations a converter can sign his address using the parent private key.

When converting, a converter communicates to the “buy” method of a contract on Ethereum.

As shown in FIG. 6C and described herein, in certain implementations the converter supplies the signatures of influencers along the path from the contractor to her. A reference to the last influencer is available in the parent link she used. Her dApp extracts the contents of that signature (e.g., from IPFS) and from it retrieves the reference to the previous signature and so on. Alternatively, the signatures are retrieved directly from the link itself.

The contract validates the first signature in the path using the stored public key used by the contractor. The contract then extracts from the signature the public address of the next step and use it to validate the next signature and so on.

FIGS. 7A-7C depict further aspects of the described technologies, e.g., as implemented with respect to Hierarchical Deterministic Key Creation. In certain alternative implementations, Hierarchical Deterministic Key Creation (‘HD’) techniques or technologies can be utilized. An example HD solution can be implemented, for example, as follows: Instead of creating a new random private-public child key pair (e.g., as described with respect to FIGS. 6A-6C), the influencer modifies the parent private key, thereby turning it into a new child private key.

In certain implementations, in each step of the path, the modification of the parent private key into a child private key can be one directional (such that the parent private key can't be derived from the child). For example, FIG. 7A depicts aspects of an example method 710 in which a contractor creates such a campaign. FIG. 7B depicts aspects of an example method 720 in which an influencer transforms a link (e.g., the link created in FIG. 7A), e.g., in a manner described herein. FIG. 7C depicts aspects of an example method 730 in which a converter converts, executes a transaction, etc. via one of the described links (e.g., a link created in FIG. 7A and/or disseminated in FIG. 7B), e.g., in a manner described herein. In one implementation, the child private key can be a hash of the parent private key. In another implementation, the secret passed in the link can be a pair of private-key and chain-code (e.g., as is done in BIPS32). In each step the chain code can be hashed and added to the parent private key to form the child private key and a different hash of the chain code can be used to form a child chain code.

In certain implementations, it may not be advantageous to enable an influencer to be able to retrieve the parent private key from the child private key given to it in the link. It may also not be advantageous to let him know the parent chain-code (if used). As a result, in certain implementations it may not be advantageous to store the contractor's chain-code in the contract (and therefore the contract cannot re-create by itself the list of public keys used). However, in the current implementation, the chain of keys can be deterministically known the moment the campaign was created. This allows for several alternative approaches:

For example, possible public keys can be computed in advance and loaded to the contract by the contractor at the time of contract creation. When converting, the contract validates signature(s) by retrieving the stored public key. This puts a limit on the maximal path length

By way of further example, the contract keeps a conversion in an escrow. The contract releases the conversion when the contractor supplies the missing public keys needed to validate the conversion.

By way of further example (in line with the example provided above), each influencer can compute the public key for the child and sign the new public key in addition to signing his own address using the parent private key. The converter supplies the signatures and the contract validates the first signature in the path using the stored public key used by the contractor. The contract then extracts from the signature the public address of the next step and uses it In validate the next signature and so on.

In certain implementations, the path of public/private keys can be turned into a hierarchy of keys. Each parent key can branch out to many child keys, each having a different index. Influencers can decide on an index and add the index value to the child creation process. The influencer can publish what index he used, e.g., by placing the index in the signature. If the first option of loading all public keys is used then the contract can store the tree of public keys when the contract is created.

In certain implementations, the signature done in every step can be repeated using the private key used by the user (contractor, influencer or converter) to interact with Ethereum. This signature proves that the user was the person who created the first signature that is based on the secret passed in the link. The converter can pass the additional signatures to the contract and the contract can validate the additional signatures and only then allow the purchase to happen.

As noted, in various scenarios described above, the assumption was that a link is written at the time the contract in the main chain by the converter who pays for all the ‘gas’ needed. However, in certain implementations a link can be written to the contract by an influencer (not by a converter). In such a scenario, the influencer pays the gas. The influencer may be motivated to do so in order to secure his title as an influencer by receiving an ARC token on the main blockchain. As noted above, once an influencer has an ARC he can start his own link.

Additionally, in certain implementations the described technologies can be configured to collect a number of links ‘off-chain’ (e.g., in a side-chain). Such collected links can then be transferred to the contract on the main chain as single “conversion” events. In such a scenario, the entity that is doing the mass transfer (e.g. the contractor) pays for the gas. Additionally, in certain implementations the described technologies can identify overlapping segments between the different links and send such overlapping parts only once (in order to save on this gas).

By way of further illustration, it can be appreciated that various batch transfer operations may be advantageous since sending data in a transaction costs gas (e.g., 68 per non-zero byte), which can become significant when sending many messages together in one transaction (e.g., in voting). This puts a limit on data size in one transaction or the number of links that can be sent in one transaction, (because the maximal gas you can spend in a block is limited to about 8 M (8,000,029-21,000)/68=approximately 117,338 non-zero bytes)—or about 50 full URL links (corresponding to about 500 different influencers, as described in detail herein). In practice, many users may use the same link of an influencer/contractor and all these users can be grouped together so these 500 influencers may cover much more than just 50 conversions.

In another implementation, the described technologies can be further configured to transfer the address of each influencer (and additional information it sent, e.g., weight) while removing/editing out other information (e.g., which proves the influencer is part of the link and is who he is). These collected proofs can then be sent as a single zk proof to the contract (enabling the contract to accept all the information about the influencers in a single zk proof). Doing so can be advantageous, e.g., to save on gas associated with the transfer of multiple transactions corresponding to the respective influencers reflected in a link.

Additionally, in certain implementations the described technologies can be configured with respect to voting. As noted above, in such scenarios each influencer can add his own voting weight to the link. When such a link is written in the contract, the voting weight of each influencer is recorded in the contract (e.g., on the main chain).

In certain scenarios a single influencer may use different voting weights in different links. In this case the contract can be configured to decide which weight value to use (e.g., the first weight seen) or to reject influencer vote completely if such weights are inconsistent.

In certain scenarios it may be advantageous to define or limit how much weight each influencer can place in a vote. A simple example is a yes/no vote and the weight of each influencer is ‘1.’ However, in certain scenarios it may be advantageous or necessary to limit who is allowed to vote at all. For example, other voting scenarios may involve several options to choose from and configured to allow a voter to select multiple options and allocate or ascribe different weights (e.g., a number 1-100) to each option. In such a scenario it may be advantageous or necessary to limit the total weight an influencer can allocated, thereby preventing such influencers from ‘abusing’ the system. To do so, in certain implementations a special voting coin or token can be allocated or distributed to each eligible influencer (e.g., in advance). Such an influencer can then ascribe a weight to a particular voting option by spending some or all of these voting coins.

It may also be advantageous to incentivize such influencers by providing a bounty (e.g., additional voting coins) for an influencer who brings more voters. In doing so, influencers that recruit more voters can allocate more weight in the referenced vote.

As noted above, in certain implementations the described technologies can be configured such that links can be written to the contract by influencers and/or collected and written in bulk (e.g., to save on ‘gas’).

In certain implementations, the referenced voting contract can include parameter(s) that define when the contract completes/expires (e.g., at a defined cut-off date/time, at a certain number of votes reached, etc.). The contract then executes by tallying the total vote made by all influencers and completes any corresponding transfers/transactions.

It should be understood that the links referenced above and described herein can be a certificate chain in which each influencer receives the private key of the previous influencer and uses it to sign his own certificate. Such links can be defined, structured, or otherwise configured in various ways. For example, in certain implementations such a link can be a URL-path that defines where the dApp should be loaded by the browser.

In certain implementations, the referenced link can include parameters such as: (1) the address of the campaign contract (e.g., in Ethereum blockchain) (“c”), (2) the address (e.g., eth address) of the last user in the chain of influencers (“f_address”), (3) the secret of the last user (known to anyone seeing the link but not stored on the blockchain) (“f_secret”), and (4) a message containing content such as previous users in the chain of influencers, the public part of their secret, and a cryptographic proof that each influencer saw the secret of the previous influencer in the chain (“p_message”).

In certain implementations, such links can be generated and/or utilized such that each user provides a proof that he ‘saw’ or had access to the secret of the previous user in the link (e.g., the previous influencer/contractor). Each user also adds 1 byte of personal information (referred to herein as “cut”). In other implementations, the user can additionally generate/provide a proof that he actually was the user that gave the proof referenced above (e.g., that he ‘saw’ or had access to the secret of the previous user in the link).

As noted, “f_address” can be an eth address of the last user in the chain of influencers. The user can provide this information to the link in its current form. When the contract is first created first, this address will correspond to the contractor. As the link is disseminated/shared between influencers, this address will correspond to the last influencer to modify the link. In certain implementations, such an address may, for example, take up 20 bytes within the link (e.g., written as 40 hexadecimal numbers).

“f_secret” can correspond to the secret of the last user/influencer. Such a secret may, for example, take up 32 bytes within the link. This can be the secret which is known to anyone seeing the link but not stored on the blockchain. Users can compute the public part of this secret (“f_public”) internally (which may take up 20 bytes).

As noted, “p_message” can be a field or segment that contains or reflects elements such as: previous users in the chain of influencers, the public part of their secret, any of their personal parameters such as “cut” and a cryptographic proof that each influencer saw/had access to the secret of the previous influencer in the chain.

When a link is first created the “p_message” field/segment can be empty. This is because the public key for the “f_secret” of the user who created the link (e.g., the contractor) is already stored in the contract. Only the contractor or influencers that are already stored on the blockchain can create a link (so there is little need for them to prove anything). Additionally, the contractor may not need to have a “cut” or if the link is created by an influencer that is already on the blockchain then his “cut” should also be already stored on the blockchain.

In order to join the described chain, a user can receive or otherwise access a link (e.g., originating from a contractor/influencer). Such an accessing user creates his own new “f_address”, new “f_secret” and computes for it a new “f_public.” The user then creates a new “p_message.”

By way of further illustration, when a user receives a link with an empty old “p_message” field, he creates a new “p_message.” Such a new “p_message” field can be generated by first placing the “version” of the link (e.g., 1 byte which can be a 0 or 1) and the old “f_address.” If “p_message” is not empty the user, in certain implementations, adds the old “f_address.” The user also adds the old “f_public”.

The user then adds (to the referenced new “p_message”) a signature (“sign”) (which may take up, for example, 65 bytes) and his new “cut” (1 byte). In certain implementations, such a signature (“sign”) can be computed with the old “f_secret” of the SHA3 hash of the concatenation of various fields/segments, such as the new “cut”, new “f_public” and/or new “f_address.” Alternatively, in lieu of adding a new signature for each new influencer in the link, in certain implementations the described technologies can be configured to generate a single aggregated signature (e.g., which accumulates in it all the signatures across the chain), as described in detail below.

In certain implementations, the user can then add a second signature (which may take up to 65 bytes) (a new “cut_sign”). Such a signature can be computed with the new “f_address” of a SHA3 hash of concatenation of SHA3 hash of the concatenation of the strings “bytes binding to weight” and “bytes binding to public” and/or an SHA3 hash of the concatenation of “cut” and new “f_public. As noted, such a signature can serve as proof that such a user actually was the user that gave the referenced proof

As noted, in lieu of adding a new signature for each new influencer in the link (as described above), in certain implementations the described technologies can be configured to generate a single aggregated signature (e.g., which accumulates in it all the signatures across the chain) (e.g., a ‘BGLS’ (Boneh, Gentry, Lynn, Shacham) signature). In certain implementations, such a scheme can replace the “sign” (65 bytes) added to the link by each influencer, as described in detail above. For example, instead of adding a new “sign,” each influencer replaces the previous “sign” with his own new “sign” which includes, in it, all the previous “sign” contained in/reflected by the link.

By way of further illustration, to enable the described aggregated signature, each influencer creates a secret (“f_secret”) and publishes its public key (as “f_public”). The SHA3 hash of the concatenation of new “cut”, new “f_public” and new “f_address” (“h”) can then be computed, as described above. The “sign” as computed up to now (e.g., as received from the previous influencer) can be multiplied with “h\hat{ }x” to generate a new “sign” (note that the contractor/first-influencer can just assign “sign” to his “h\hat{ }x”).

The new “sign” generated in the described manner is 64 bytes long (two 256 bit integers) and may need to appear only once in the link. However, the referenced “f_public” segment may still need to appear for each influencer in the link (and may now be 33 bytes long since we need its full value, not just its hash which is 20 bytes). In other implementation each signature is 65 bytes long (compared to the address of “f_public” which is a hash of the full key). Accordingly, using the described techniques, 52 bytes can be saved (65+20−33) as compared to the techniques described above (in which a new “sign” is added for each influencer in the link). It should be understood that, in certain implementations, this scheme does not include the additional signature (“cut_sign”) referenced above.

It should be noted that when performing batch transfer operations (as described above), it can be possible to multiply signatures from different paths when combined into one transfer.

In yet other implementations, in lieu of adding a new signature for each new influencer in the link (as described above), Schnorr signatures can be used (e.g., as an alternative to the described implementation using aggregated BGLS signatures). In such an implementation, the link works as described herein and an “f_secret” (referred to as ‘x’ below) and “f_public” which is 64 bytes (referred to as ‘P’ below) which can be calculated on an elliptical curve with generator point G:P=x*G

It can be appreciated that, with respect to the above formula, determining x given P is a hard problem.

Accordingly, in the present implementation of the described link, a Schnorr signature can be utilized. To do so, a random private key ‘r’ and its public part ‘R’:R=r*G is generated.

A hash of the message to be signed is computed. In the present example, the message can be referenced as ‘P’ concatenated with the Ethereum address of the user ‘A’:
e=Hash(P∥A)

The signature (‘σ’) can be computed:

σ=r+e*x

Validation is made by receiving the signature (‘σ’) multiplying it by G and comparing to R+e*P:

σ*G=(r+e*x)*G=r*G+e*x*G=R+e*P

In certain implementations, various modifications to the referenced techniques can be made. For example, consider a scenario in which influencer number n wants to add his information to the link he received from influencer n-1. In certain implementations, the described technologies can be configured such that this new influencer randomly creates a new random x_{n,}rₙ, computes its Pₙ, Rₙ and hash eₙ=Hash(Pₙ∥Aₙ). Accordingly, the signature is now σₙ=rₙ+eₙ*xₙ₋₁ (using xₙ₋₁ received in the link from the previous influencer). Instead of concatenating Rₙ and σₙ to the link (as described elsewhere herein), they can be added to the previous values:

R⇐R+Rₙ and σ⇐σ+σₙ

As noted, the influencer needs to replace the secret of the link with his private key xₙ. As described herein, the influencer can concatenate his public key Pₙ and his address A. The contractor/link-creator starts with a secret x₀ and a public key Pₒ which is stored in the contract and R=0, σ=0.

The link can be validated by computing the eᵢ=Hash(P₀∥ . . . ∥Pᵢ∥Aᵢ) and adding Pₑ=Σᵢ₋₁ⁿ eᵢ*Pᵢ₋₁ and comparing σ*G=R+Pₑ

Each influencer can add 33 bytes for P and 20 bytes for A to the link (which is 52 bytes better than before).

Note that as before, the influencer cannot reuse the pair x, P anywhere else because x was published.

As noted above, when a user wants to use a link to enable him to take a particular action in the campaign contract (e.g., to convert), he creates a new “p_message,” e.g., in the manner described above (e.g., using the “version” of the link, the old “f_address,” and the old “f_public,” as described in detail above). Such a new “p_message” is then sent to a method in the campaign contract (e.g., “transferSig”). Such a method then validates the link and reads the information contained within it (e.g., using an Ethereum library method). It should be noted that one problem with aggregated Schnorr signatures is that the last user can insert a ‘poisonous’ public key that cancels out the public keys contributed by previous users. However, in the described scheme this is not possible because each public key is later multiplied by the next hash which is not known in advance. The converter performs the last signature computation using his Pᵢ and eᵢ however he does not have a place to use his secret xᵢ.

As noted, in certain implementations the described link can be stored directly in the URL (and not in IPFS). Doing so may limit the size of the URL (e.g., to 2,000 characters). In certain implementations, each step in a chain entails adding the “f_address,” “f_public,” “cut,” signature with “f_secret” and (optionally) signature with “f_address.” Accordingly, storing such a link directly in the URL may limit the number of influencers that can be stored in a chain (e.g., 6 influencers in a URL in which the signature with “f_address” is included, 9 influencers in a URL in which the signature with “f_address” is not included. It should be understood that the referenced estimates assume use of hexadecimal encoding, and utilizing, for example, base64 encoding can further reduce the number of URL characters for each influencer to enable 10 or more influencers in a single URL.

The “p_message” of the referenced link can be sent to the “transferSig” method in a contract using an Ethereum transaction.

It should also be noted that, in certain implementations, the described technologies can enable various access control functions. For example, a list of users that can act as influencers and/or converters can be defined in advance. By way of illustration, a contractor can dictate that only people in his mailing list can act as influencers.

It can therefore be appreciated that the described technologies are directed to and address specific technical challenges and longstanding deficiencies in multiple technical areas, including but not limited to referral tracking, artificial intelligence, and distributed computing. As described in detail herein, the disclosed technologies provide specific, technical solutions to the referenced technical challenges and unmet needs in the referenced technical fields and provide numerous advantages and improvements upon conventional approaches. Additionally, in various implementations one or more of the hardware elements, components, etc., referenced herein operate to enable, improve, and/or enhance the described technologies, such as in a manner described herein.

As used herein, the term “configured” encompasses its plain and ordinary meaning. In one example, a machine is configured to carry out a method by having software code for that method stored in a memory that is accessible to the processor(s) of the machine. The processor(s) access the memory to implement the method. In another example, the instructions for carrying out the method are hard-wired into the processor(s). In yet another example, a portion of the instructions are hard-wired, and a portion of the instructions are stored as software code in the memory.

Further aspects and implementations of the described technologies are provided below.

Existing referral-tracking technologies rely heavily on tracking pixels for marketing-attributions and conversion tracking. Such pixels require complex integrations and ongoing management by site/app owners. Additionally, such pixels often have no visibility outside the websites/apps in which they're installed. Additionally, information that is tracked using such pixels by separate competing website/app owners is often segregated (such that information tracked by one service may be unavailable to another service).

Accordingly, described herein in various implementations are technologies that enable pixel-less referral tracking and other related technologies. As described in detail herein, the disclosed technologies can migrate the Internet's tracking from siloed pixel integrations within business websites or apps into the tracking links themselves. For example, the described technologies enable the tracking itself to be performed by the links being shared. Doing so can provide a full attribution model, where multi-step referrals and conversions are tracked by the passing of web3.0 tokens between participants. This produces a closed loop blockchain-based technology which enables businesses to open conversion contracts, and have these shared seamlessly online, tracking the full referral chains, and rewarding/reimbursing those who helped effectively spread the word (i.e. market the business's offering) upon successful conversions.

As described in detail herein, a contract (e.g., a ‘smart contract’) can be generated by an interested party. Such a contract can define a desired result and the reward offered for anyone who enables the achievement of that result via sharing the contract. A decentralized or distributed (e.g., blockchain) computing infrastructure can provide a platform for such a contract to be maintained, disseminated, and/or executed.

To provide universal functionality, the referenced contract can include a link that provides a web 2.0 interface for the contract. Such a link can correspond to a web page that can be used to interface with the contract (e.g., to sign on as influencer, or fulfill the contract as converter, as described herein).

The referenced contract (and/or corresponding link) can then be disseminated to other participants, users, entities, etc., in any number of ways. Users can interface with the contract via web2.0 and/or web3.0 interfaces. Such receiving users can further disseminate the contract/link until a conversion event occurs (e.g., fulfilling the contract's required action(s), as described herein). The relays from influencer to influencer can serve as a form of rev-share transactions, with each party participating as an influencer ultimately earning money, credit, rewards, etc., as well as reputation for helping to relay the contract until the contract is fulfilled.

An example environment is depicted in FIG. 1. As shown in FIG. 1, the described technologies (including systems, methods, services, platforms, etc., such as those described/referenced herein) can be implemented in conjunction with various devices, components, elements, etc. For example, an example platform can include or otherwise interface with a decentralized or distributed lager such as a blockchain (e.g., Ethereum, as shown in FIG. 1) that can be distributed/stored across multiple connected nodes. Examples of such nodes are depicted in FIG. 1 and described herein.

The referenced nodes can be computing devices, storage device, and/or any other such connected device or component configured to generate and/or provide verification (e.g., for a transaction, operation, etc.). Various nodes can be connected to one another (directly or indirectly) via various network connections, thereby forming a distributed computing environment or network.

In an example transaction, ownership of a digital token can be transferred from one address to another. To authenticate the transaction, the transaction recording the transfer can be signed by the originating party using a private key associated with that originating party (e.g., as stored on a device or wallet, such as “wallet” as shown in FIG. 1). Such a private key can be a cryptographic key (e.g., a string of bits used by a cryptographic algorithm to transform plain text into cipher text or vice versa) that may be kept secret by a party and used to sign transactions (e.g., the transfer of a token to another user, to a server, etc.) such that they may be verified using the described distributed computing environment.

The referenced signed transaction can then be broadcast across the distributed computing environment/network, where it can be verified, e.g., using the public key associated with the originating party. Such a “public key” can be a cryptographic key that is distributed to, or available to the referenced node(s) so that signed transactions associated with the public key may be verified by the nodes.

During the referenced verification process, the transaction can be accessed or selected by a consensus node (e.g., a device or ‘miner’ configured to verify transactions and add new blocks to a blockchain), verified using the public key, timestamped, and added to a “block” that includes other transaction(s). To perform the referenced verification the consensus node can, for example, solve a cryptographic puzzle, e.g., to identify a nonce value that, when used with a hash function, results in a value formatted in a specific way. Upon solving the puzzle, the consensus node creates a proof of work that is then verified and (if the solution is valid) added to the blockchain ledger.

Adding completed blocks to the blockchain ledger forms a permanent public record of various included transactions. The blockchain ledger can be replicated and distributed across multiple nodes within the distributed environment. In the event that a user tries to utilize a previously transferred digital token, the first transaction conducted using the token address may promulgate to remote nodes faster than any subsequently conducted transaction using the same token address. This allows more time for additional blocks to be added to the blockchain that include the first transaction. In this scenario, a node that receives two separate chains that include blocks with transactions originating from the same token address will choose the longest chain, which should be associated with the first conducted transaction. In such a manner, the blockchain may be used to provide verification of various operations, transactions, etc.

Further aspects of the technologies depicted in FIG. 1 are described in detail below.

Sharing links online (e.g., hyperlinks) to products services and content, creates economic value. When we share online and people follow our links, we create gains for the sellers of the products, services or content we help to distribute. Yet the existing linking/referral technical infrastructure does not appropriately credit or reward users/parties who fuel growth/dissemination.

As described herein, the disclosed technologies enable users/entities to be seamlessly rewarded as part of their native online experience. In certain implementations, such rewards can be computed in relation to the economic value generated by various acts of sharing.

Among the disclosed technologies are various links referred to herein as “Action Referral Coin(s)” (ARC). As described herein, such links can enable benefits to both sides of the share. Doing so can enable a seamless sharing economy, so that the act of sharing links anywhere online can generate credits, rewards, etc. for those who share.

Also included in the disclosed technologies is a platform or technical infrastructure. Such platform/infrastructure may be referred to herein as a Global Referral Network (“GRN” or “RefNet”). In certain implementations, such a platform can be a peer-to-peer platform that enables businesses, freelancers, publishers and others to seamlessly mobilize the human web to produce results of value (e.g., bringing in new customers). The described technologies can, for example, enable one participant to define a required result and incentivize others/the web to efficiently pursue the result. Contractors (that is, participants, users, etc., that define or initiate the contracts described below) can, for example, set a reward/price and pay only per result. Additionally, as described herein, rewards for spreading the word and fulfilling the contracts can be offered via dynamic reputation and performance driven incentive models. In doing so, referral chains can be optimized to target an audience which can effectively produce the result.

The described technologies can also enable ‘Social-Sourcing’—e.g., incentivized activation of result-driven organic virality.

For example, the described technologies can enable an interested party to offer credits/rewards to the masses for helping to produce a defined result (thus utilizing the power of targeted organic virality). In certain implementations, such an offer can be defined in a contract (e.g., a ‘smart contract’) within the referenced platform. Such a contract can, for example, offer or define various incentive(s) for helping distribute the contract and/or fulfilling its terms. In doing so, the public can be rewarded for helping to produce a result valued by the contractor. The public's contribution in this regard can be leveraging individual contacts, social networks, etc. to organically distribute/disseminate the contract (e.g., towards an audience that is willing and able to convert the contract). Further aspects of the referenced contract(s) are described herein.

In certain implementations, the described technologies can distribute digital tokens (e.g., influence tokens), e.g., as currency, compensation, rewards, etc. for referral(s). In certain implementations, such tokens can also be used to purchase goods and services (e.g., those offered via the referenced contracts). Such tokens can be liquid and tradable, yet can also be engineered/configured to be governed by an economy Al which may be optimized for market cap and flow (as described herein). Doing so can create a synergistic effect where network/platform participants can be incentivized to activate new contracts and tokens, and then to keep the tokens flowing within the platform/economy (since they're in effect receiving rewards embedded into a savings account which can be most useful when used back to purchase goods and services within predefined timeframes).

In the described platform (one example implementation of which is depicted in FIG. 1), the contractor can determine the value of the action requested from the public to produce. Additionally, in the described platform the contractor pays for the work, and the public performs it.

In certain implementations, the described technologies (including the referenced Global Referral Network) can operate as a general distributed social contracting platform for the web.

The described technologies further incorporate referral solutions/techniques that implement various distributed/decentralized computing technologies (e.g., blockchain) and artificial intelligence (“AI”) techniques (which may incorporate game theory and other techniques). The described solutions can be usable by anyone and do not require users to implement any special software or code.

Existing referral marketing technologies can be effective for large enterprises but are often out of reach for small businesses/individuals. By integrating technologies such as blockchain, smart contracts, etc., the described technologies can provide a new global platform/economy based on link sharing. As described herein, the disclosed technologies enable a mass-scale decentralized link-sharing economy via an incentive model for online sharing.

As noted, the described technologies enable Social-Sourcing, the incentivized activation of result-driven organic virality. Doing so can, for example, enable the optimized search for a target audience that is able and interested in producing a desired result.

Using the described technologies, a user/participant can, for example, define a required result and incentivize a network/web of participants to pursue the target audience needed to obtain that result. Example users of this incentivized organic distribution can include freelancers seeking new clients, small businesses looking to expand their client bases, police stations searching for suspects, schools recruiting new students, publishers looking to expand their core audience, and pharmaceutical companies gathering data on drug side effects from patients. The described technologies provide solutions when crowdsourcing the organic web is needed to obtain a desired result.

In certain implementations, the described technologies can operate as an economic marketplace for crowdsourcing referrals and creating desired results. In certain implementations the described solution can integrate blockchain infrastructure technology through which deep layered referral-graphs can be created/maintained based on link sharing. Additionally, in certain implementations dynamic reputation-based incentive models can be integrated (which can be developed using machine learning, algorithmic game theory, and/or other techniques). Such models can function to optimize online participant reputations and contractor result fulfillment.

As noted, the described technologies can include a link (referred to as an activation referral coin or ARC). Such a link can be configured to benefit both sides of/parties to a share. In certain implementations, such benefit can be respective of the value generated by the act of sharing the link (as computed based on various criteria). The ARC can be further utilized as a building block for the described platform (referred to herein as ‘GRN’ or ‘RefNet’). Such a platform can enable a peer-to-peer social-economic network, as described herein. Such a platform can enable businesses, freelancers, and publishers to seamlessly activate a human network to produce results of value, such as capturing new customers.

While ARCs act as the self-monitoring token-links tracking referral chains (which may be referred to herein as “RefChains”) to conversion, other digital token(s) can be actual currency coins awarded for successful referrals. Such token(s) can also be usable for purchasing products and services within the described network. As described herein, such tokens can be liquid and tradable, and engineered to optimally facilitate the referral economy. Accordingly, user can be incentivized to keep such tokens rather than exchanging them.

In certain implementations, the described economy can be managed via a GRN foundation smart contract that utilizes AI to ensure optimization of the RefNet's economic viability key performance indicators (KPIs). Such KPIs can include weight (market cap X users) and flow (daily transactions X average transaction size). The referenced AI can control tuning parameters that adjust or manipulate the rates and usage channels of a marketing pool of tokens (e.g. specification and release of economy-wide reputation rewards, of self-marketing contracts etc.). Periodic selective reputation-based rewards can act to promote users actually contributing to the economic function of the network, thereby incentivizing the agents empowering the network's viability.

Use of the referenced tokens as both referral/reputation rewards and a conversion currency to purchase services and products on the RefNet can create a synergistic effect to uphold the economy. Doing so can optimize both the appeal of the token for actual use within the economy, and the appeal for keeping of such tokens as preferable to other savings instruments. Moreover, since the RefNet is engineered to optimize for reputation, the economic network can be designed to surge in value the more reputation is amassed by all participating parties.

For Web 2.0 users who wish to purchase the referenced tokens or earn tokens, various web and mobile apps act as a managed wallet holding their balances (with private keys stored on the user's side). Web3.0 users can be joined onto refchains and receive their rewards directly to their Web3.0 account (e.g., utilizing an ERC20-compliant client).

The basic entity in the RefNet is a contract which can be generated by an interested party. Such a contract can define a desired result and the reward offered for anyone who enables the achievement of that result via sharing the contract. As noted, such a contract can be a smart contract (e.g., conformant to standards such as ERC-20 and extending its interface to allow new functionality). These contracts can also have Web2 interfaces, e.g., via the GRN and other domains (e.g., for users who participate in the network without their own Web3.0 interfaces).

In certain scenarios, the described RefNet can include or involve participants, entities, etc. such as:

Contractors—e.g., the interested party issuing the contract who offers a reward for each required result obtained.

Influencers—e.g., the ones sharing the contract and being rewarded if their sharing resulted in its fulfillment.

Converters—The ones ultimately acting out the desired result of the contract (signing up for a service, paying for a product, consuming content, providing information, etc.).

The described platform, which acts as the trustee in the contract. In such a role, the platform can, for example, ensure transactions, uphold dispute resolutions and abuse prevention, monitor and persist reputation of the various players and enable reputation-based dynamic incentive models for optimized network activation. Infrastructure-wise, the described platform can moderate the contract transaction fees for web3.0 users, or enables them altogether for web2.0 interfaces. The described platform can also maintain a web application and mobile apps that enable contract generation and advanced contract analytics amongst other functionality, as well as Web2.0 interfaces for the contracts and players in the network.

The described platform can further include or utilize tracking technologies integrated into the described ARC. Such technologies can include a decentralized or distributed (e.g., blockchain) computing infrastructure allowing for links that play out smart-contracts and perform self-tracking and management as they are distributed online. ARCs allow complex, multi-step, multi-party, state syncing and conversion events, as well as continuous real-time access to a blockchain-synced state, thereby enabling continuous dynamic monitoring, moderation and analytics of the smart contract network of operation, available per user-role permissions in the contract.

The described technologies also include a multi-party state-network solution for scalable decentralized multi-step referral tracking for a Web2.0 experience using Web2.0 links and users' browsers, while still being synced to the Ethereum blockchain to govern the underlying smart contract and to ensure security, fairness, fraud-prevention, and contract-adherence.

As noted, the described technologies can integrate various predictive models that employ game theory and machine learning to dynamically optimize incentive models based on the a-priori and intra-contract reputations of the various players. For example, the described reputation-based algo-bidding and AI-based dynamic incentive models can optimize the return on investment for participants in the network.

Additionally, the described token economy is governed by a token-economics AI which utilizes levers such as deflation, inflation, interest rates, and positive/negative taxation to optimize the economy's viability KPIs such as market weight and flow.

In one example scenario, an interested party, e.g., a business, generates/initiates a contract (e.g., via a web app or mobile app) that offers the network rewards for spreading the word (i.e., referring) towards fulfillment of some desired result, e.g., attracting new clients for this interested party. Sharing and fulfillment of such a contract can happen anywhere online, both in Web2.0 and in Web3.0. Spreading the contract is done by sending ARCs from one person to another, thereby drawing a referral graph comprised of many referral chains (“refchains”). In web2.0, an ARC between parties can be created by sharing a link. In web3.0 an ARC between parties can be created by sending a coin/token. Once the refchain reaches a converter, the conversion itself can also be triggered via the link—as in web2.0 the linked html interface can be used to convert (e.g. buy the product), while in web3.0 the ARC is in itself a smart-contract facilitating fulfillment of the contract via a client supporting the necessary protocols.

The described platform can further enable tracking functionality. The contractor can control the price and may pay only per result (e.g., acquisition/lead/content view). The product enables customers or potential influencers to create personal links to products, services, and content, which they can then share by any means available (social network/email/SMS etc.), receiving rewards when their links lead to conversion events. The described technologies utilize AI and other technologies to monitor and analyze the reputations of the various players and create a dynamic incentive feedback loop to maintain the high quality of results.

In certain implementations, the described technologies can be configured to charge a fee for a successful conversion reward. The fee amount may be determined via algo-bidding AI that optimizes the network utilizing dynamic incentive models. Factors that may be accounted for include the type of contract, size of reward, reputation of players involved in the contract, and the projected gain to the contract's success served by the platform (e.g., auto-contract-discovery for matching contracts to influencers, auto-prospect-discovery matching prospects to influencers, algo-bidding, trustee services etc.).

The following example use cases illustrate scenarios in which parties of interest can generate a contract to incentivize the network to produce desired results:

Small Business wants to attract new customers→opens/generates a contract to offer their current customers an incentive for bringing in new customers.

Publisher wants to drive more traffic to view some content→opens/generates a contract offering rewards for anyone consuming the content to bring new people to consume the content.

Government wishes to conduct a national survey→opens/generates a contract offering rewards for each citizen who answers a few questions in the contract.

Drug company wishes to conduct mass scale clinical trials→opens/generates a contract defining a reward for each customer who is willing to report side effects.

Police wishes to find a wanted fugitive→opens/generates a contract offering a reward for anyone providing proof of location for the wanted criminal.

One of the main strong points of the advertising giants is the pixel—a piece of their code which can be integrated into websites of businesses and used to track user behavior and purchases occurring on the site. The pixel enables to correlate between an ad served to a specific user on the ad-platform and a subsequent business result which occurred on the business site of the advertiser. The big problem is that currently only mid-sized businesses and up can afford to assimilate a pixel into their site; the integration requires constant technical and operational support on the business side, and requires there to be a business website to begin with—not always the case for solopreneurs and small businesses. Moreover, the pixel is siloed inside the business site and doesn't provide tracking of the user on his journey outside the site, missing out the ability to accurately attribute marketing influences to the final conversion. Furthermore, the robotic advertising platforms are very complicated for layman manual operation, and only mid-size companies and above stand to have big enough marketing budgets to employ experts or purchase B2B solutions or agency services which enable effective marketing via the big platforms. Lastly, since the duopoly control the prices within their self-created attention markets, businesses have been seeing price baselines steadily on the rise.

The described technologies encompass an online, referral marketing network, where anyone can easily join, be it a business or customer, and produce either business results, or get paid for producing such. Doing so can enable a future where anyone sharing products, services or information online can seamlessly earn money for being proactive online and driving the small businesses economy.

As noted above, the described contract can be implemented as an ERC20 token, defining a contract where a party of interest may define a required result, as well as the incentives it is willing to reward for anyone helping to bring about such result.

The contractor/origin can be the interested party issuing the contract—offering a reward for each required result obtained. Generally, the origin can be any human individual, user, organization or robotic entity (API, IOT node, another smart contract, etc.) which can define a required result, state its worth and offer the network a reward for producing it.

An influencer/relay can be any web3.0 addressable entity (i.e. bearing valid blockchain-id/address, or web2.0 entity masked as a valid web3.0 addressable entity, e.g. via managed keys), human or robot, that receives the contract and passes it to another such web3.0 addressable entity.

The desired/required result—can be anything definable and verifiable, which can be achieved by an online action.

Examples of certain implementations include:

Acquisitions of product or service. verifiable by the allocation of funds or agreed upon assets as payment.

Leads—contact details of a prospective customer, put forth by the prospective customers themselves as proof of intent to being approached by a representative of the business.

Information—some piece of information requested by the interested party. The information can be verifiable either by acceptable proof/validation or by mass consent.

Content View—validated ingestion of a piece of online content.

A required result can be anything that bears value to the interested party. It can be an acquisition (of a product or service), a customer lead (contact details left by a prospective customer as proof of intent to be contacted by the business), information lead (some information bits that bear value to the contractor), content view (consumption of content, textual, audial and/or visual), information ack, etc. It can be anything that bears value to the contractor, and in which the contractor can quantify to put a price tag on the value of the result

Prospect/converter—can be a final node, a web3.0 addressable entity, which inserts currency and/or information into the contract which constitutes the required result of the contract.

Converter conditions—the business can state conditions on the identity and reputation of eligible converters. Such converter conditions can be, but not limited to: Age, Gender, Geography of residence, Geography of work, Marital status, Work experience, Social reputation, Professional reputation, etc.

Converter verification—If conditions are present, the contract can be required to verify the converter before accepting results, e.g. by cross-referencing the uPort profile of the converting address. In case these conditions have been stated by the contractor, but cannot be automatically verified by the contract, the converter will not be able to sign the result into the contract. In some cases the platform as trustee can perform the function of verifying the converters.

RefChain—referral chain—the chain of identifiable relays leading to a single converter.

RefMap—referral map—the directional graph of influencers stemming from the contractor at the root to converters at the leaves.

Link—for keeping the described interface with web2, each contract is also represented by a link, leading t o a URL within the domain of the described platform. The web page served from this URL is hosted by the described platform and can be used to interface with the contract, either to sign on as influencer, or fulfill the contract as converter. Any user signing on as influencer, receives a personal link, which maintains their place in the refmap. This link can be then used anywhere online to continue and distribute the contract. Anyone receiving this link can either go to it and sign onto the refchain, to get their own link and continue referring, or use it to fulfill the contract (enter personal info to become a lead, insert money to acquire the offered good or services, insert the required info etc.).

ARC—action referral coin—an ARC can be an ERC20 token, held in balance by influencers in a contract. The ARC can be implemented as a link in web2, and as an ERC20 token in web3. By passing ARCs from one influencer to another, the referral chain is created, and monitored from within each such token. The ARC is also used to convert, as any required result which requires payment of some sort can be made utilizing the web2 interface for the ARC hosted by the described platform and/or any web3 ERC20 compliant client. The balance of ARCs is dynamic, giving rise the programmable and optimizable refmaps. Each influencer can have their ARCs balance change dynamically to reflect their reputation and results. The more ARCs an influencer has, the bigger the referral map he can produce stemming from him.

Sharability—each influencer signing into a contract can be dynamically assigned a personally tailored shareability profile, encompassing two parameters: the balance of ARCs allocated to the influencer within the contract, and the gas price for sending an ARC to someone else. These two parameters control the topology of the refmap which an influencer can extend from herself onwards. It is dynamic in the sense that it may change throughout the term of the contract. The main agent of change here is usually the disclosed algorithms, e.g., game theory Al models, provided to the contract via API (either centrally served or served via a distributed production environment e.g. via Enigma), all in case the contractor has approved the disclosed platform as the trustee in the contract. Changing the two parameters of ARCs balance and gas price per share, enable an influencer to share more or less freely. When ARCs are limitless and sharing is free, nothing stops the user from sharing anywhere. If sharing via web2 interfaces, any number of people following the links may sign onto the contract's refmap as influencers, while in ref3 this means that the influencers has practically unbounded ARCs balance in this contract to allocate to other web3 accounts. The more the ARCs balance is reduced and raise the share price, the more we incentivize the influencer to think carefully before sharing, as it becomes a semi-odds game, where the influencer has to make sure she's confident her sharing will lead to a conversion, since she's not allowed to join many people into the contract, and each such share costs her money. The Sharability acts as a form of public proof of vested stake, a share which costs the sharer money is not the same as a share which cost the influencer nothing, and a share which was awarded from a limitless contract isn't the same as a share awarded from a limited sharing quota. The way the sharing is perceived is one of the factors which affect the results of sharing, and how it's perceived by the receiver.

Bid—each influencer is offered, alongside the dynamic share quota and the share price, a bid representing the projected reward (in money and reputation) he is expected to receive for referring the contract to fulfillment. The bid itself, like sharability, is dynamic, and may change per influencer, and during the life-cycle of the contract. It may be statically dictated by the contractor, or controlled algorithmically by the contract moderator/trustee. The referenced game theory AI models which optimize for reputation and all-around returns in the contract, utilize the 3 levers of share quota, share price and bid to optimize the contract outcomes for all players involved. The bid displayed to each influencer is a function of the influencer's a priori reputation in the contract category, the point in the refmap in which the influencer first joins, the contractor's initial maximum reward setting, and the projected possible referral steps to conversion. For each bid displayed, the bid is projected per varying steps to conversion, since these aren't known in advance, prior to the conversion event. Part of the game theory AI is to minimize steps to conversion, so in this regard, in moderated contracts each influencer might also face restrictions to maximal steps to conversion beyond which no reward will be disbursed, even if originating from a converting refchain in which the influencer was active.

Incentive Model—The algorithmic or machine teaming model tasked with reflecting sharability and bid for each influencer dynamically throughout the contract lifecycle, to optimize reputation and returns for all players in the contract, is termed the contract's incentive model. This model is tasked with the general task of providing positive feedback to “good” influencers, and negative feedback to “bad” influencers. When such models work properly, they optimize for minimal steps to conversion, maximal category-specific a priori and intra-contract reputation accrued by all participating influencers, minimal cost per conversion for contractor, and maximal reward per referral for influencer. The incentive model is served by default by the contract moderator, offering trained game theory AI models which are served into the contract dynamically via either centralized or distributed API. One of the main tasks of the incentive model is to facilitate reputation based algo-bidding, so that influencers which receive negative feedback, or are caught by the moderator's abuse detection models, are immediately given negative incentive in the form of reduced bids and sharability, as well as reputational penalties, to incentivize them to stop their fraudulent or abusive actions in the scope of the contract.

Unlimited advertising—When the contract's sharability is set to default at a very high ARCs quota per influencer and a very low price to share (down to zero), we call this limitless advertising. This results in a refmap topology which is unlimited, since by default every influencer joining the contract has unlimited potential to add new influencers to spread the contract further. Valid use cases for this type of advertising may be Content Contracts in which publishers wish to distributed content online, and are willing to pay per page view. In these kinds of contracts, the result validation can be automatically performed by a moderator, operating servers to showcase the content and track page views. This type of result validation doesn't cost the contractor time, and is billed with marginally low costs within a moderator fee from each conversion event. Furthermore, in such cases, the publisher wishes as many people as possible to view the content, since there is limitless supply of the content for everyone to view, and the overhead of serving the content is static, and drops marginally the more viewers consume the content. In such cases, it makes sense to hold limitless advertising contracts, so not to limit the distribution potential of influencers. As with any contract type, abuse prevention methodologies should lead to severe reputational punishments as well as negative incentive in the form of lowered bids and sharability, to drive “bad” influencers out of the contract, and limit their ability to lower the contracts performance.

Limited Advertising—In other types of contracts, where validation of results may be costly to the contractor (e.g. lead contracts where the contractor validates each lead), or in cases where the service or product offered is in limited supply, e.g. an upcoming Yoga course with 20 seats available, it is more fitting to limit the sharability for each influencer, to make sure there's a higher probability for each result in the contract to translate to an actual conversion. Reduced sharabilty requires each influencer to pay more careful attention to who they refer the contract to, and subsequently limits the refmap topology to one with more limited branch out factors at each influencer node. In this case, the initial, default amount of ARCs and share price should be optimized dynamically per contract and per influencer, via the referenced game theory AI models trained to optimize contract returns.

Moderated content promotion, advertising, etc.—The optimization goal of the referenced game theory AI models utilized to moderate the contract lifecycle also lead these to dictate varying degrees of initial/default influencer sharability and bid, so that most contracts played out will start in some point on the spectrum between unlimited and limited advertising, and shift through this spectrum as the contract is played out, dynamically tailored per influencer and through time.

Initial Sharability—The initial balance of ARCs and share price the influencer receives when joined into the contract. These can be determined based both on the contract type (limitless/limited distribution), as explained herein, and the a priori reputation of the influencer in the category of the contract. As a rule of thumb: the more limitless/trustfull the contract, the higher initial shareability bestowed by default on each influencer. The higher the a priori reputation of the influencer in the contract category, the higher the initial shareability.

Intra-Contract Dynamic Shareability—As the contract progresses, shareability may be altered by the contract's reputation-keeper, providing by means of API a game theory AI algo-bidder which can make adjustments to the shareability per influencer to account for intra-contract changes in the reputation standing and/or result quality of the influencer. An influencer which is determined to be a spammer or which receives negative feedback from contract participants or which performs poorly, may be lowered in shareability, so that they are incentivized against sharing widely and indiscriminately, and vice versa, an influencer performing well, which receives positive results and/or feedback while performing in the context of the contract, may be raised in shareability, so that they may have more potential to find converters for the contract.

Sourcing Seed—The sourcing seed is the first group of influencers which the contract is sent to, joining them into the contract as influencers seamlessly. The sourcing seed is one of the factors which determines the eventual topology of the refmap, and the success of the contract. It is one of the factors which the described platform as trustee is paid to optimize on the contractor's behalf.

Public Sourcing Seed: The contractor may choose to have the contract as public, where it may be joined by influencers via either search (in the described web/mobile apps) or via discovery (via reputation matching and recommendation graph matching within registered users). This is more fitting for publishers who wish to distribute their content

Private Sourcing Seed: The contractor may also elect to define the sourcing seed to be a closed group of people, e.g. his current customer base. This is more fitting for small businesses and solopreneurs trying to expand their customer base.

Result Verification—For various contracts, the result verification can work differently. Each result can be verified before being considered as obtained. In each case disputes may arise, and each type of contract can employ different dispute resolution layers.

Lead Contract: the result is personal contact info. In most cases here the validator will be the contractor themselves.

Acquisition Contract: the result is purchase of a product or service. The verification is inherent since money can be transferred into the contract for the result to be considered achieved.

Information Contract: Publicly verifiable information=once consensus arises from multiple converters, the information may be deemed valid. Publicly unverifiable information=contractor is charged with verification.

Content Contract: opening the web2.0 or web3.0 link for viewing the content (which is found within the contract), will constitute a viewing. The opening process for the content link, as well as uPort conditions for identity will be validated automatically by the contract (in certain implementations, via calls to an admin contract or an offchain/sidechain API).

For example, one such method is if the condition for converting is that the viewer is human, is that an API masks the html page for the content with re-captcha etc. so that accessing it may only be possible after proof-of-humanity.

Another possible condition is that the converter must hold an address which possesses money.

Dispute Resolution—As in any distributed peer-to-peer system, disputes can arise between stakeholders and participants. The RefNet enables dispute resolution in varied cases, depending on contract type and participating parties' preferences. In certain implementations, the contract trustee can act as resolving authority on most types of dispute. The disputing parties standing and reputation plays a major role in dispute resolution. Reputation plays a role here both in settling the dispute and incurring penalties on future participation in contracts.

Lead Contract—If the contractor rejects a lead, the lead prospect and the refchain get notified, and each of them can raise a dispute. The trustee (e.g., of the contract/platform) can act as intermediary, and depending on the aggregated reputation of the contractor, the refchain and the prospect, a ruling will be obtained to either:

Approve rejecting the lead→lowering reputation score for the entire refchain members (proportionate to their chain-proximity to the converter).

Disapprove rejecting the lead→lowering the reputation score for the contractor, and releasing the reward for the refchain

Balance out→lower by a smaller amount the reputation of all parties involved (contractor, relays and converter), while keeping the result as rejected, but still rewarding the refchain for their efforts (in such case the admin contract can dispense the reward from into the disputed contract, and disperse it to the refchain).

Acquisition Contract—In an acquisition contract, the converter can often deposit funds into the contract in order to fulfill it. Also, in such contracts, the contractor can enable transferring ownership of the offered services or products on the blockchain registry to the converters, a transaction facilitated by the platform as moderator. Once a converter transfers the funds, so long as the contract was open for conversion, the ownership of the offered product/service can be transferred to the converter, legally binding (on a public ledger) the contractor to supply said service/product to the converter. One use case for dispute, thus, will be in cases where the converter disputes not having been provided the service/product for which they paid. In such cases the following outcomes may come about:

The contractor admitting failure to supply, the trustee in the contract will reimburse the converter, and charge the contractor a debt for the required amount, lowering the reputation score of the contractor by a certain amount.

A high standing converter contesting such claim, and the contractor denying, the trustee will most often reimburse the converter, but mark the dispute (frequent such opening of disputes by the converter will lead to downgrade in reputation). The trustee will strive to examine the truth of the matter, to further penalize either converter or contractor in lowered reputation or debt markup.

A low standing/unknown converter contesting such claim, and the contractor denying, the trustee will strive to obtain proof of the facts, and might lower both sides reputation accordingly.

Ultimately, this is an area of risk assessment which can be further optimized via machine teaming models. In doing so, the described platform can be optimized financially in deciding, in the usual circumstance of costly path to fact discovery, to predict for each case the probable optimal outcome.

Information Contract—In information contracts, the validation of information should be a major part of pre-emptive dispute resolution. In some types of info. contracts, e.g. police looking for a wanted person, the mere statistics of information creates a mass voting scheme which enables the correct information to validate itself, and thus pre-avoid disputes between converters and contractors. In other cases, such as drug companies offering incentives for sharing personal information, the information given should either be validated through critical mass statistics, or be self-validated e.g. via a doctor signed transcript. In other cases, the same risk assessment models can be used by the described platform as moderator to carry out the dispute resolution management.

Content Contract—In content contracts, most often, the referenced trustee can host the content and track page views, so that results can be validated and govern the ground truth regarding both conversions' validations and compensation disbursement.

Identification—The described technologies can interface with sovereign ID providers e.g. the uPort and civic web3.0 services for id management and reputation persistence. The describe technologies can also interface with federated ID providers (e.g., social networks or other services) for allowing current web2.0 users a familiar and seamless sign-in experience.

Reputation Taxonomy—The described technologies use a general taxonomy to categorize reputation and contracts. Each category in the taxonomy can resembles an ontological domain which can be assigned to the contract.

Reputation—Each contractor, influencer and prospect using the described contracts can be assigned a reputation score, value, etc. Reputation is monitored and persisted via the administrator contract through the described contracts, and is persisted into the uPort identities of the various parties. Each uPort/civic id may be assigned a reputation in each of the categories of the taxonomy, and this reputation can be aggregated towards higher level overall reputation scores per more abstract categories. The referenced reputation scoring system optimizes for reputation, since it is the social currency at the heart of social sourcing, and the more market cap in reputation that is amassed in the network, the more efficient it will become. Reputation on the taxonomy can be amassed both as contractor in this category and as influencer/prospect in this category.

Contract Category—Each contract is automatically assigned a category (editable by the contractor) from a fixed taxonomy, describing a general ontological reference for the content domain relevant to the contract. This taxonomy is used to aggregate reputation for businesses, influencers and prospects.

Attribution Rules—The rules by which the referral rewards are distributed between the refchain members upon successful conversion in their chain. For each member in the refchain, several factors affect the rewards attributed to them, among them, A priori Reputation, Intra-Contract Reputation, Proximity to Converter.

A priori reputation—Influencers in the ref chain can obtain different initial bids depending on their outstanding reputation in the contract category (i.e. the reputation prior to execution of the current contract). The a priori reputation can be, for example, a number starting at 10, and can be as low as −10 (blocked from uninvited participation in contracts in the ontological category downwards), but is not upper bounded.

Intra-Contract (Near-Real Time) Reputation—As the contract plays out, each player, be it the Contractor, Influencer or Converter, amasses reputation in the contract itself This reputation depends on several factors, and may change throughout the contract lifecycle, including but not limited to: Conversion rate in contract, Average, Median, Min, Max proximity factor to converters, Average, Median, Min, Maxbranchout factor, Average, Median, Min, Max value of generated results, Negative Feedback amassed, Spam filtering activated, Disputes which arose.

Proximity to Converter—Number of referral steps to converter in current refchain conversion.

‘RefPay’—Referral Payment—The payment, credit, compensation rendered to a refchain for helping relay the contract to a converter. The max ‘refpay’ is defined by the contractor, while the actual refpay is a product of the combined bids offered to the influencers at the time their actual referrals were made. The Incentive model projects bids to each influencer, which may change through time, but are enforced into effect for each referral made, as of the time the referral takes place. One of the incentive model objectives is to make sure the overall refpay for a converting chain doesn't surpass the maximal refpay per conversion defined by the contractor, and, where possible, to optimize the refpay so that minimal refpay is distributed while maximizing the likelihood of overall number of conversions, in respect to the maximum required to fulfill the overall contract product/service quota.

Lead Contract—contractor allocates money into the contract a priori, by defining total budget per the contract and maximums reward per lead generation. Once prospect converts to lead, the contract dispenses the refpay to the refchain per the attribution rules defined in the contract, or as determined by the dynamic incentive model.

Acquisition Contract—converter allocates money into the contract post-priori, upon conversion, while contract allocates rights to product or service a priori, and once conversion payment is made, part of it is distributed as referral rewards to the influencers in the converting refchain, per the incentive model governing the contract, (dynamic incentive models by default).

Content Contract—publisher allocates budget into the contract a priori, or provides some credit line (future), which is used to distribute rewards to influencers each time a new user consumes the content (e.g., produces page views).

Installs Contract—in certain implementations, these can act as Lead contracts, where the conversion event is the converter linking to the app store to install the app. A final validation is made either through CRM access between the contract moderator and the contractor services, or by way of manual validation by the contractor, in which case the trustee role plays a more significant part in dispute resolution. Once an install has been triggered from within the contract, a refpay request is sent to the contractor by the contract moderator on the converter's behalf. Then it's up to the contractor to either approve the payment or reject it. In such cases, dispute resolution is simple, since the converter can easily prove installation of an app, and if the converter is using the mobile app, or webapp on mobile, this can be also verified on the fly upon conversion event itself. In any such case as an install is verified, the moderator then releases the bid amount for the refchain members from the budget allocated in the contract.

Information Contract—Acts as a Lead contract, where the validation is done either by conversion statistics or by contractor validation or by self-validation of the information via official certificates. Once the result is validated, the rewards are distributed to the relevant influencers following the incentive model.

Seamless Relay/Influencer Sign In—When the contract is relayed from address to address in web3.0, each address can automatically be registered into the contract, unless such address becomes a prospect or converter by fulfilling the contract.

Masking & Privacy—Not all info and parameters specified by the contractor are necessarily publicly available to view. Some can be masked and kept upstream in administrative contracts, or persisted off-chain with id-dependent locking or encrypted in the contract so that just their generator (the contractor) can retrieve them

State Channels—The life of a contract can be conducted off-chain, utilizing state channels. In certain implementations, a star-shaped architecture with the described platform as moderator in the middle can be used to facilitate a 1×1 channel between the platform and each contract player. The main chain can act as jury, such that prior to contract launch and after contract termination, the main chain is updated with relevant contractual information to safeguard the rights and assets attributed to the various players as result of the contract being played out.

In certain implementations, the described technologies can be implemented or deployed via a web2 webapp (e.g., to allow mass adoption with no entrance barriers).

In one example scenario, a business or entity can generate the referenced contract. By way of illustration, consider a Yoga instructor named Amy. Amy is opening a new summer Yoga course in her home town and wants to generate sign ups from new prospective students. She opens her mobile or web app (in web2.0) and generates a new contract (as described herein). In the contract Amy defines that she's willing to pay 50$ for each new sign-up she receives, and 10$ for each new prospective lead generated—someone not yet ready to pay for the course, but willing to leave their personal contact info to be contacted by Amy for further details. This means that Amy defined two types or required results in the contract, and a reward per each. So, Amy then specifies both types of desired results and their respective rewards into the contract, as well as the duration of the contract (her course starts in one month so prospective students are to sign up beforehand). She also specifies the inventory—how many places are available for the course. She can also choose to link the contract to her web2.0 sites or pages explaining about her service, so that the contract can be queried for html pages reflecting her and her offered service.

Amy can then send this contract to her current customers, via a newsletter/Facebook post/SMS or any other method. The contract is simply sharable: in web3.0 it's as easy as transferring the contract via sharing the textual Ethereum code representing it (similar to the way that sharing links can be achieved by passing a string of textual characters from one to another, a string which can be decoded by any client or browser supporting the current web2.0 protocols, to display the content). In web3.0, the textual string which Amy shares represents not just an HTML page with content, but an entire contract which responds and updates itself as it gets referred across the web, all the way to a point where someone uses the contract to convert—i.e. leave their details to become a prospective lead or put in money to purchase a sit in the upcoming Yoga course.

The referenced contract can be interfaced with both via a dedicated web2.0 website, as with via any web3.0 client supporting the ERC20 protocol (or another smart contract protocol). This means that when the contract is shared, it can be shared with a web2.0 compliant link (e.g., in domain associated with the described platform), which enables anyone to interface with it via an http compliant client. And, it can also be shared within web3.0, so that anyone having a web3.0 account (address) can receive, share it onwards and fulfill the contract using any erc20 compliant client.

Amy can now share her contract with her current students, offering to reward them for spreading the word and helping her attract new students. Each existing student can share the contract, and whoever receives it can pass it along, or fulfill it by either putting in their personal contact info to become a lead for Amy, or by putting in money to purchase a seat in the course.

Sharing the contract is the heart of the referral network, since it's all about generating economic value by sharing interests online. At first Amy can choose and proactively send the contract to the referral seed group—her current customer base, but the described technologies further allow contracts to be stated as public. Doing so can, for example, enable auto-discovery (e.g., via dedicated feeds in the webapp and mobile apps). These feeds can enable relevant users (e.g., those with reputation in the contract content domain) to be prompted to sign up to contracts relevant to them.

Those receiving the contract can share the contract code with others, in any means, and each one receiving the contract can be registered as influencer (in web3.0 this is seamless, in web2.0 an additional touch point may be required, e.g., via the contract domain link, pressing the link and inserting an email).

Existing customers, by receiving the contract (or proactively registering to it, e.g., if public), can be auto-registered into the contract as an influencer. From there on, influencers can send the contract onwards to one or more addresses on web3.0, and these can relay the contract further, in a branching out tree-like manner (e.g., a one-directional graph), until a relevant party/entity receives the contract and produces a conversion event—to fulfill the contract's required action(s). The contract can contain all required info or links to information associated with the product or service, as well as other information required to make the conversion decision (in this case, acquisition of product/service). The relays from influencer to influencer can serve as a form of rev-share transactions, since each party participating as an influencer ultimately earns money, credit, rewards, etc., as well as reputation for helping to relay the contract until it reaches a party of interest which desires to fulfill the contract.

In the referenced example, Amy's students can start spreading the word, and once a hopeful next student has been reached, they can insert their info or pay for a seat at the course. When sharing the web2.0 link for the contract or the web3.0 code of the contract, the influencers (those propagating the message), can also add their own recommendation into the contract, either as a side message, or slated into the contract received by their target.

New Customers—Fulfill the Contract→Release Influencer Rewards: Once the contract is fulfilled, the branch of the relay tree which helped reach that conversion is rewarded in back propagation. Each influencer can receive their share, and they can all share the bounty. The web3.0 accounts registered in the referral chain leading to conversion are used as addresses to send or attribute the rewards to. If the web2.0 mask was used to sign the influencers into the chain, their balances are kept (e.g., by the described platform) and can be retrieved/cashed out by signing into the referenced web or mobile app using the confirmed email signed into the contract via the web2. 0 interface. The incentive model by which influencers share the referral reward is discussed in greater detail below. In certain implementations, if a single influencer shared the contract with the prospect who converted, then that single influencer can received/be awarded the entire bounty for themselves. The sharing between multiple influencers in a converting chain is done respectively to each influencers location in the chain (first to refer vs last to refer), their influence score for the campaign (how many conversions did their relay(s) end up producing) and their global outstanding reputation in the relevant reputation category (aggregation of their influence in the category relevant to the campaign).

Once a prospect inserts money or information into the contract to fulfill the contract, a verification step can be triggered, e.g., to make sure the required result has indeed been met, and thereafter the rewards are released to the referral chain leading to the converter. In different types of contract, the verification of results, and flow of money, rewards, etc., can act differently. For example:

Acquisition Contracts—If the contract is offering money as reward for any referral chain leading to new acquisitions, then once a prospect uses the contract to insert money and make the acquisition of the product/service, the proceeds from the acquisition are used to back propagate the rewards to the referral chain, and lastly reaching the business minus the rewards. The inventory offered in such contracts is kept in escrow, and once money is deposited into the contract, there is a transfer of ownership of one instance of the inventory to the converter, in return for the funds being placed into the contract. In the case of an acquisition contract, the transfer of sufficient funds into the contract suffice as verification of the result. In such contracts, the contractor puts an inventory in escrow upon contract generation, and blockchain based cross-transfer of ownership is performed, from escrow to converter, of an instance from the inventory, when such converter fulfills the contract to purchase one unit from the contract's inventory. No a priori funds have to be put into the contract by the contractor, but ownership over the proposed inventory for sale, has to be inserted into the contract and kept in escrow, as proof of availability for the offered services/products for sell.

Lead Contracts—Contracts rewarding referrals ending with a lead generation event, are triggered by a user inputting their personal info, thereby signing an intent to be approached by the contractor. In such cases, the lead can be verified by the contractor prior to rewards being released. In such contracts, a budget can be required to be inserted by the contractor upon contract generation This budget is disbursed, based both on the declared offer per lead stated by the contractor upon generation, and the dynamic reputation-based algo-bidding and eventual incentive model outcome when a refchain is fulfilled. Once a lead is confirmed, a single reward is freed from the contract and disbursed among the refchain, and if a discount or other reward was also offered to the converter, it is sign on at that time of reward disbursal as well. In the future, a converter's reputation score or other criteria might be a valid condition for result verification in such contracts, pending on contractor setting this option when generating the contract

Content Contracts—These contracts offer rewards for referring users to receive/digest content, visual, audio, or textual, or a combination of such. A reward can also be indicated for the actual consumer of the content. In such cases, and pending on the definition of the contract conditions, some proof of the following can to be provided:

Consumption—the content can be positioned offchain, and using a pixel generated by the described technologies, the consumption is carried out seamlessly in the view of the contractor.

Humanity of the converter—e.g., via cross-correlating a sovereign ID provider, e.g. uPort.

Once the conversion has been validated, the budget held in the contract (inserted by the contractor upon generation), is used to reward the chain and the consumer of content, pending specific contract conditions.

Information Contracts—These contracts offer rewards for referring the contract to a valid converters) and typically also to the converter themselves for inserting information of a specific nature. In most cases, verification of information as valid result, can be obtained by mass-pooling aggregated potential conversions, as some information can be publicly validated. In scenarios in which the information cannot be publicly validated, a third party, and perhaps a fourth and a fifth, who can validate the information, can be specified either in advance by the contractor, or post-priori by the converter. In each such case, the identity of the verifying third parties can be mutually acceptable by contractor and converter. In some other cases, no verification of the information is required, and information produced by the converter can be rewarded (e.g., with a lower bounty). In yet other cases, typically where robotic entities (e.g. IOT nodes) are rewarded for information sharing, the automatic signature of the thing releasing the info, is enough to act as verification of result. In these cases as well, the budget for rewards is required to be pre-loaded into the contract by the contractor, before disbursing the contract to the first influencer seed audience.

Installs Contracts—These contracts reward referrals to converters who install an app. The app install itself can be verifiable via the end node used as hardware (e.g. mobile phone), using an API. Bounties can be preloaded.

Sign-Ins and Wallets—The described interfaces can require users to be registered within the disclosed platform as well as to have a viable web3 account to properly attribute and serve their participation in the referral network For registration (sign-up/sign-in) various user experiences can be supported to support maximum seamlessness—explicit sign-up/in, and implicit sign-up/in. In terms of web3 accounts, the described platform can either manage a web3 wallet for the user (i.e. hold on to the private keys and let the user access balances via their platform sign-in), or enable the user to hold on to the private keys themselves (while still having the platform to facilitate the interface to the wallet itself), or enable the user to work with their own wallet (e.g., MetaMask, or any other web3 ERC20 compliant client). The disclosed architecture mixes and matches between the sign-up/in and wallet interface options to achieve optimal seamlessness for any point in time, to optimize for mass-scale usability.

Registration, Sign-ins and Seamlessness—“Registration” as used herein can refer to the act of signing-into have a user_id in the registrie(s) utilized by the disclosed technologies. This user_id may be connected to one or more web3 accounts, and to one or more federated or sovereign id providers (e.g., social networking accounts, etc.).

There can be various types of sign ins into the disclosed web/mobile app, including but not limited to:

Explicit sign in: This is when a user explicitly provides some sort of confirmed online identity key when signing in—either from a federated ID provider (e.g., a social networking profile), or from a decentralized sovereign ID provider such as civic or uPort, or by providing a confirmed email address.

Implicit Sign in: In order to support seamlessness in user experience, in some cases a user can create an account implicitly. Such Implicit web2 sign-in can be implemented, for example, as follows:

Influencer—a prospective influencer receives a link (associated with the disclosed platform). To join the contract, they select the link to arrive at a hosted web2 contract interface, e.g., within a browser on desktop/mobile. The interface allows the user to become an influencer with one click, resulting with a generated username and password (if they're not already users), as well as a personal link. The generated account can be used to register the user into the refmap of the contract, and provide the new personal link which the user can now use to continue distributing the contract. The user can use the username and password later on when they wish to view their results and statistics, obtained rewards and reputation, and cash out. In the second visit where the user wishes to consume platform information or cashier services, they can be prompted to perform an explicit sign in.

Converter—in cases where contract fulfilment may require cash insertion/deposit into the contract, and the converter is not a registered user, a user account for the converter can be implicitly created, so that the transaction can be registered into the refmap.

Implicit web3 sign-in can be implemented, for example, as follows:

Influencer—an influencer which receives the contract by direct ARC transfers into their ERC20 wallet client of choice, can be auto-registered by the ARC into the contract's refmap, and their web3 account will be back propagated to the web/mobile apps to perform an implicit registration, so that they can use their web3 account later to sign in. Since in this funnel there's isn't necessarily direct interaction between the influencer and the apps, no password is shared back to the influencer, but in such time where the influencer desires to log into the app to view stats or utilize a cash out procedure, the user can be prompted to prove ownership over the account (to confirm the account—much like converting a mail, by ping-ponging a confirmation ARC token), and will then be able to access the implicit pre-registered account and activate it as user facing, by performing an explicit sign in.

Converter—A converter which receives the contract by direct ARC transfer into their ERC20 wallet client of choice, may utilize such client to convert into the contract, i.e. to fulfill it. In such case, there's not necessarily direct interaction between the converter and the apps, but the conversion does trigger an implicit sign in by means of back propagation of the converter's web3 account to the servers of the described platform, which can implicitly register the account into the platform and maintain the converter's account for validation purposes within its role as contract trustee. When such converter signs in to the apps explicitly, they can be prompted to prove ownership of their accounts and thereby be able to view their conversion histories, and any connected functionality.

Hosted Wallets, Managed Wallets and Private Wallets—Users interfacing with the system, whether contractors, influencers or prospects, can opt whether to use their own web3 crypto-wallets or to have the platform manage a wallet for them, fully (keeping the private keys within the platform) or partially (the user keeps the private keys but the platform enables interface with the wallet):

Such functionality can be implemented as a Web2 experience as follows:

The described platform can manage a wallet+private keys. For a web user which doesn't have any web3 client and also doesn't want responsibility for keeping track of their private keys, the platform can create and manage the wallet for them, enabling seamless conversion between currencies, tokens, etc. used within the network. Access to the wallet can be provided via the referenced webapp/mobile-app, using the explicit sign-in for that user, with MFA.

The described platform can manage a wallet, while the user keeps private keys: The described platform enables an option that allows users to have their wallets managed by the platform, but without the platform holding or knowing their private keys. This can be done by keeping the private keys stored in the local storage of the user's browser. Such a semi-managed wallet solution can be achieved via the web2 interface on any HI IP browser (e.g., without dependency on browser extensions, plugin installation, etc.).

Web2 with MetaMask: for a web2 user interfacing with the contracts via the referenced links, the page hosting the interface can recognize whether the user has MetaMask or not, and in such case as the user has MetaMask, the contract interface can integrate with the MetaMask wallet rather than create a new managed wallet for the user, of course, pending the user's approval.

Pure Web3: for a user interfacing with the system via an ERC20 compliant client, the referenced contracts can interface with these clients directly, and seamlessly, since an ERC20 compliant client can also provide the basic functionality of the ARC20 tokens, to join influencers into refchains, and to fulfill contracts.

RefMap Topology—Social Sourcing Modalities—The disclosed RefNet is designed to support various social sourcing modalities. Multiple factors can determine how the referral map of a contract will play out, and these factors can be controlled dynamically through the influencer and time spaces. The disclosed game theory AI can be engineered to optimism returns for multiple players in the network, maximizing amassed reputation, conversion rates, rewards, minimal time-path to conversion etc. Among the levers which the disclosed machine learning models may control are the following parameters, which can change dynamically per influencer as the contract is played out:

Share Quota: An influencer can receive, upon joining a contract, a balance of ARCs, which determine a quota for number of new influencers (1 per ARC) which may join the contract downchain from the influencer. The share quota is personal, and allocated dynamically to each influencer, determined by such factors as a priori reputation in the contract category, intra-contract reputation amassed as the contract is played out, feedback received from other contract parties while contract is being played out, quality of conversions, etc. The higher the share quota, the less strict the referral map becomes, giving more influencers the opportunity to join in more influencers on the refchains of the contract. On the other hand, the smaller the share quota, the more attention each influencer may pay to their sharing, as they only have a limited ability to share the contract onwards. The share quota can be used as a feedback loop transfer function parameter, that may provide either positive feedback—to allow an influencer more potential to share the contract, or negative feedback, to restrict the influencer front sharing the contract. In some cases, the type of contract will dictate a specific refmap topology, and thus a specific use case (see examples in the next section)

Share Cost—Alongside the share quota, an influencer can be assigned a share cost,—a price (e.g., in local currency or ETH or Tokens) which it will cost the influencer to share the contract onwards per each new influencer joining directly under him. This share cost may also impact the refmap topology, and is a lever controllable by the incentive model for optimizing the contract outcomes.

Bid—The projected reward shown to each influencer for helping reach a conversion, as a function of the number of steps to conversions (influencers downchain between this influencer and a converter).

While the described technologies run the backend on blockchain, they also enable web2 interfaces so that anyone can always utilize the platform, regardless of whether or not they have integrated with web3 clients. It can be appreciated that are various types of screenplays currently at work in the refnet, one for a pure web2 experience, where anyone can play so long they have some web2 client and internet, another for a web2+MetaMask experience, for those web2 users who have installed MetaMask or some other web3 wallet which is seamlessly integratable with code running on the front end of web2 pages, and the third is a pure web3 experience for those running a dedicated web3 client compliant with the ERC20 protocol.

Web2 Pure Play—A contractor signs in to the referenced webapp/mobile app, creates a contract.

Contractor receives a link which she publishes to an existing customer base, or to any other sourcing seed. The contract is also indexed and may be discovered or searched by prospective influencers.

Wherever the link is shared, per the sharing quotas, and influencer conditions, influencers who select or access the link arrive at the web2 contract interface, where they may join the refmap or fulfill the contract.

Users who haven't gone through KYC, don't have to when they join as influencers or converters, but for accessing funds and seeing analytics, explicit sign in may be required. An influencer who simply wants to join the contract and spread it onwards, presses a button, receives a new URL and can then continue to share the contract. If this user isn't an existing webapp user, they can be issued a username and password, and given the opportunity to either signup via a federated or sovereign ID provider, or at least give an email to enable notifications. The username, password and URL can enable the user to continue on the chain in web2 experience. Any explicit sign in to the referenced webapp or mobile app may only be required afterwards, e.g., to view an influencer's refchain or to cash out.

In this case, the web3 wallet is holding the referenced tokens, and managing the ARCs balances for the contracts, is managed for the user by the platform, and may be accessed via the username and password (+MFA) in case the user elects to have the platform manage his private keys, or via username, password+MFA+private keys, in case the user elects to have the private keys stored locally on their browser/device.

Web2+MetaMask—Similar to web2, though the web3 account can be registered into refchains, and to which ARCs flow and from which ARCs flow, and to which tokens are sent as compensation, is MetaMask. The webapp/mobile app may be required to interface with to play the game.

Web3 Absolute Experience—In web3 experience, the referenced webapp/mobile app may be required to generate contracts, but sharing and fulfilling contracts is possible front any web3 client supporting the ERC20 protocol.

In certain implementations, anyone interested in some result (i.e. the contractor), e.g. a business interested in new customers, can issue a smart contract in which they state: Their desired result (what they'd like the contract to produce, e.g. purchases of a certain size inventory of a certain type product), and The “refpay” (referral payment—what they're offering as reward per result—e.g., what they're offering to pay as referral reward for the chain of one or more people in the word-of-mouth referral chain (refchain) that led to each desired result).

This contract, which can “sit” behind a text-string, can be shared from one to another online (e.g., like an internet site in web2.0 “sits” behind a textual link which can be shared via app, browser or platform supporting the protocols of web2.0). Each internet user that receives the contract link can either continue to share with others (acting as influencer in the scope of the contract) or use it to actually fulfill the contract (acting as prospect in the scope of the contract, producing the desired result i.e. generating a conversion—e.g. by leaving their details depicting interest in the product, pay for ordering the service/product, give information etc. depending on the contract type).

When a contract is fulfilled, the refpay for each result is distributed back to the chain of influencers which led to the successful prospect. Each contract may cite an inventory of desired results, so it can be open for as long as its inventory of rewardable conversions has not been exhausted. Interactions between the contractor, influencers and prospects can be done via the contract, which automatically updates its state as it's being referred across the network and as it's ultimately used to produce the conversion event.

The contract's “refnet” (referral network) is the tree-like map (e.g., a uni-directional graph) of the sharing starting from the contractor, and then branching out to influencers and from them to other influencers and ultimately ending, in some of the branches, with the fruit of prospects fulfilling the contract, and releasing the rewards for that conversion.

The influencer's refnet is the sub-tree (e g., a sub-uni-directional-graph) starting from them and branching out to their word-of-mouth net spanned from their initial sharing. Each refnet can carry its own attributes: (a) generated conversions, (b) generated value, (c) average branching-out-factor, (d) weighted net level (weighing over the branching out, seeing where most of the energy in the branching out is located), (e) average conversion rate per level (f) average reputation of the ref net (g) conversion contribution strength—projected contribution of the influencer to conversions that arose in the refnet. The global referral network (GRN) can be a map of contracts' refnets, including the way in which various contracts may interact with or connect to one another.

As noted above, an admin contract can enable the described platform to provide various services to all multiple contracts, including but not limited to:

Serving as trustee in the contract—facilitating dispute resolution and abuse prevention, as well as insure transactions in case of abuse or fraud—e.g., to make sure influencers, prospects and leads are covered for reimbursement in case of fraud or abuse by other parties in the contract

Monitoring and persisting reputation of the various players—as amassed from peer feedback and actual results metrics, i.e. allow the network to learn a dynamic representation of each player's reputation per each category in the GRN taxonomy of result categories, so that abusive or fraudulent parties can be identified and mitigated

Monitoring network stability and providing enhancements that percolate to future contracts (and possibly be accepted by parties of interest in existing contracts).

Funding sharing transactions, allowing sharing of the contract in web3.0 to be free for influencers (such that influencers don't have to pay for passing the link from one to another).

Enabling reputation-based algo-bidding of referral rewards—allowing potential influencers to query the contract and receive a personal reward offer per their reputation in the contract's domain. Since this information may be private, it may not be exposed in the individual contracts, which is why such contracts can query the platform admin contract as an API to receive this, and other personal/private info, on a permission/role basis. Dynamically bidding different influencers different rewards can ensure quality results for contractors, since it can negatively or positively reinforce influencers to be less or more proactive, per their past reputation in the contract's domain and amassed current reputation in ongoing contracts

Monitoring, aggregating, and persisting data and analytics as they arise from the global referral network, and from sub-trees in the ontology (i.e. sub-sets of contracts per category)—and provide dashboards and interfaces in which influencers, contractors and prospects may use these insights and analytics to better their positions and advance their interests.

In certain implementations, the disclosed game-theory AI can fuse game theory and machine learning. Such technologies can include dynamic, real-time, personalized, action-type-tailored incentive-compensation models to ensure all players maximize their reputation and returns. The disclosed RefNet can produce, for example, both the framework and the datasets to enable further development of models for online sharing. Doing so can enable the implementation of generic action-referral-reputation dynamic-incentive models to optimize returns for all players and efficiency of the system at large. The system can, for example, optimize for minimal time/steps to conversion, maximal number of conversions, maximum amassed reputation by all participating players, minimal abuse, and optimal price point (reputation-money mix) between contractor and influencers (e.g., helping the contractor frame the initial reward price point).

Token-Economics AI—Strategically, the economy can be managed via a GRN foundation smart contract that utilizes novel Economics-AI to ensure optimization of the RefNet's economic viability KPIs, namely weight (market cap X users) and flow (daily transactions X average transaction size). The Economics AI can control tuning parameters manipulating the rates and usage channels of a pool of tokens (e.g. specification and release of economy-wide reputation rewards, of self-marketing contracts etc.). Periodic selective reputation-based rewards can promote the users actually contributing to the economic function of the network, thereby incentivizing the agents empowering the network's viability. By gradually allowing more levels of control on a network-wide scope, such AI can optimize for global network KP Is to keep the interests of the economy.

Referral-Recommendation-Graph—The described technologies can implement a referral-recommendation graph to facilitate match-making between recommendation seekers and valid recommendation givers. This can empower the refnet by feeding influencers with potential high-quality referral targets from within their networks, thereby lowering friction and removing barriers, empowering the building of more efficient referral maps. Such technologies can incorporate techniques including but not limited to: Natural Language Processing, Natural Language Understanding, Unsupervised machine learning, Graph Theory and Social Sciences.

Pixel-less Tracking—Among the advantages of the described technologies is to enable purely online pixeless-tracking. Doing so can migrate the internees tracking from siloed pixel integrations within business websites or apps into the links themselves. Currently, there's an internet-wide reliance on pixels for marketing-attributions and conversion tracking. Pixels require complex integrations and ongoing management by site/app owners, they have no visibility outside the websites/apps in which they're installed and there's effectively no inter-net tracking (i.e. the tracked info is segregated and owned by separate competing website/app owners). With the described technologies, there's no technical overhead on business sites and zero integration requirements—since the tracking itself is performed by the links being shared, and not by the endpoint site/app the links are pointing to, as are the conversion events, which can be produced via the smart contracts activating the links. This enables the described technologies to offer a fully SaaS CPA model with multi-step-multi-chain referral reimbursement support triggered by actual conversions/acquisitions (enabled via the smart-contract tokens/links themselves). Doing so can provide a full attribution model, where multi-step referrals are inherently charted, e.g., by the passing of web3.0 tokens between consumers, and these coins are can also be used for producing the conversion events. This produces a closed loop blockchain-based technology which enables businesses to open conversion contracts, and have these shared seamlessly online, tracking the full referral chains, and rewarding/reimbursing those who helped effectively spread the word (i.e. market the business's offering) upon successful conversions.

Web3.0 Infrastructure—elements of the referenced web3.0 infrastructure include but are not limited to:

ARCs—action referral coin—On the blockchain infrastructure front, various tracking technologies can be integrated into the ARC, a new kind of blockchain infrastructure allowing for links that play out smart-contracts and perform self-tracking and management as they are distributed online. ARCs allow complex, multi-step, multi-party, state syncing and conversion events, as well as continuous real-time access to a blockchain-synced state, enabling continuous dynamic monitoring, moderation and analytics of the smart contract network of operation, available per user-role permissions in the contract.

The Game-Theory AI-determined balance of ARCs can shape the topology of the referral maps for each contract. Beyond their algorithmic role, they can be engineered to allow them to act as web3.0 coins on one hand, while facilitating their function of charting referral chains, showcasing the offered services or the required contract result, and enabling the fulfillment of the contract via a conversion event (leaving details, giving info, paying for products or services, viewing content etc.). Each contract holds a balance of ARCs, which are the tokens being distributed by influencers. The infrastructure for their interplay with each other and with the contract they are linked to is at the heart of the disclosed technologies.

Multi-Party State Channels—To facilitate a decentralized platform, while enabling scale, configurable transaction costs and permission-based access to contracts, the disclosed technologies include multi-party state channels. In certain implementations, a decentralized application (“DApp”) requiring asymmetric user roles in smart contracts can utilize these technologies. In such cases where user roles and permissions to determine consensus in the contract are asymmetric, the harder consensus problem can be mitigated in general purpose multi-party state channels, while still providing a solution which enables multi-party state channels with no star-formed architecture holding a central server as the middleman. Among the advantages of this solution is to use pseudo-symmetric roles between state channel players, giving an originator (e.g. a contractor), the ability to mime a single player as consensus moderator (e.g., the disclosed platform), thereby empowering a single-hot connection between an end-user and a web2 interface for a contract, or the ARC token being sent to an influencer's wallet in the pure web3 approach, as minimally sufficing events to link these influencers into the multi-party state channel hosting the contract. Whether it be a cookie or other browser code playing out in web2, or the ARC contract code playing out as it passes through an account's wallet in web3, being still linked to its parent contract facilitating the channel, the described technologies provide a solution which is seamless for any user.

Multi-Party State Networks—For scalability purposes, the described technologies can be deployed on an Ethereum mirror blockchain, facilitated by an Ethereum node cluster, so that full price per share control can be offered by the incentive models. The syncing between the mirror net will allow transfer tokens arid reputations earned to become real tokens and reputation on the master node. This can be an extension to the multi-part state channel approach offering a state network which stamps itself onto the main net for updating state changes, and mirrors the current state between the main and mirror blockchains, so that the advanced state can prevail, whether it originates from the main or mirror chains. Playing out a contract can thus occur on the mirror chain, with no scalability, privacy of gas constraints, and the products (reputation+token) are synced (“pushed”) to the main net allowing the GRN users to enjoy the financial and reputation security aspects of the main net, together with the privacy and scalability aspects of the mirror net.

Decentralized Web2.0 Multi-Step Referral Tracking—in certain implementations, the described technologies provide a fully decentralized, web2.0 pure multi-party state-network solution for scalable yet fully decentralized multi-step referral tracking using nothing but web2.0 links and users' browsers, while still being synced to the Ethereum blockchain for governing the underlying smart contract and ensuring security, fairness, fraud-prevention and contract-adherence.

This described blockchain infrastructure layer allows decentralized integration of web3.0 (the Ethereum Blockchain) into web2.0. First, it allows smart contracts to play out off-chain, in a completely decentralized manner, while keeping the contract's state and users synced and reliable utilizing the Ethereum network, and secure to hacking attacks e.g. Sybil attacks or fraud in referral chain malicious modifications utilizing state of the art cryptographic methodologies.

The Contractor may only pay ‘gas’ (e.g., an execution fee) for generating a contract, and a Converter nay only pay ‘gas’ for converting a contract, which themselves can also be mitigated utilizing a gas station associated with the described platform. The referral graph can be charted utilizing links which are used to pull and run source code from static serving in a public repository managed in conjunction with the described platform, the code allows all interfacing with the contract, and when joining a contract, influencers which don't have a web3 account are associated an account managed by the platform, but the private keys themselves are stored in the private storage of their browser, as described herein.

The described technologies can ensure that the contract plays out via influencers who were valid and authorized to share the contract, and allows influencers to join downchain after proving their referring chain was legitimately obtained. Once a conversion occurs, the funds for rewards and conversion funds themselves can be kept in escrow, and then the contract deciphers/validates the refchain legitimacy, to ensure only valid influencers are rewarded for each conversion.

This model may not necessarily allow for dynamic incentive models to modify ARCs balance and price to share dynamically per influencer and throughout the contract lifecycle, but they do allow for dynamic attribution models to be played out upon conversion and lookback on the refchain In other words, these types of contracts do not hold ARCs and do not utilize ARCs, so there's no real-time forward-looking tracking of refchains—meaning influencers and the contractor may not be able to look forward on the refmap stemming from them, until a conversion takes place. At that point the contract itself can be on Ethereum be contacted to activate the conversion validation and reward distribution. In ARCs-based contracts, the ARCs travel from influencer to influencer, and allow each influencer direct contact with the contract on each touch point. In this mode, the thin code originally downloaded to the browser from the link's primary domain is played out, and allows influencers to generate downchain referral links to create deep layered referral chains, but the contract itself in Ethereum may only be interfaced at the start and the end points (conversion events) of the contract.

Web3.0-2.0 Integration—To enable seamless web3 integration for web2 users, the described technologies include integrations such as:

Web2 smart-contract interfaces—The referenced web2 apps (mobile+desktop) can allow contractors to generate contracts (after explicit sign in), while the contract itself, once generated, can receive a dedicated web2 interface URL, whereby any user can utilize any web2 browser to seamlessly interface with the smart contract (no explicit sign-in required)—to join a referral chain or to fulfill the contract.

Web2-client-agnostic hosted web3-wallets—The disclosed web2 interface for the contracts can also support generating hosted wallets for any users signing into a contract as influencers or converters. In certain implementations, no extension needs be added, no plugin must be installed. Rather, the web2 interface itself can implicitly generate a wallet for a user trying to interface the referenced contracts without a valid web3 account. Users can be given the option to have their private keys stored on their machine or let the disclosed platform conduct it. Once influencers opt to query their status via the referenced service apps, an explicit sign-in can be prompted to make sure the funds stay secure.

Web2.0 Serverless Infrastructure—The disclosed web2 infrastructures can employ serverless/docker-swarm architectures, while moving as much of the code as possible to the front-end, to march towards decentralized hosting of the referenced apps.

The Incentive Model—As noted, the disclosed algorithmic game theory-based incentive models can synthesize the state of the art and act as a baseline for a heuristic model algorithm which can be iteratively advanced. This framework can also serve to collect machine learning ready datasets from our production environment, towards development of Reinforcement Learning Based Deep Neural Network Models which stem from the baseline of the scientific models to train dynamic influencer activation-incentive models.

Influence Graph and Referral Graph—The referenced influence graph describes the population of individuals V, and the social influence of one individual u on another individual v, as a weighted directed graph G=(V, E, ƒ), where the population can be the set of nodes V, the influence of an individual v on another individual u can be the directed edge e=(v, u), with the degree of influence specified as a weight function f from edges to real numbers. Influence can be broken down with respect to a taxonomy such as a 4-level-deep taxonomy of ˜1.5K categories. Hence, the weight function ƒ maps an edge e and a category ω to a real number. The influence function preserves the ontological structure of the taxonomy, such that the value for the category can be the sum of the values for its sub categories. The influence reputation of a node v for a category ω, can be the sum of its degrees of influence for that category over all outgoing edges in the influence graph. Thus, rep(v, ω)=Σ_{e=(v, u)εE}ƒ(e, ω), in certain implementations the influence graph can be initialized from social networks and identity providers.

A campaign can be started by a contractor that spreads actionable information to a sourcing seed set of nodes. These nodes can subsequently act as influencers to perform referrals. A referral chain can be generated by a sequence of referrals which may reach a node that actually performs the desired action to fulfill the contract's required result, such as purchase of a product, or the consumption of content. That node can be called a converter, and the action can be called a conversion. The spread of information within a campaign C can be a directed acyclic graph (DAG) called the referral graph, R_{C}=(V_{C}, E_{C}, ƒ_{C}). The referral graph includes the degree of influence within the campaign, ƒ_{C} and the corresponding reputation, called the local reputation. In certain implementations the referral graph can be a sub-graph differential component of the global influence graph, and can be superimposed onto the global graph after the campaign can be finished.

In certain implementations the described technologies can be configured to build a community or network where nodes accumulate reputation. This community can grow with each new campaign as new contractors, influencer, and converters, become part of the network as a by-product of creating new campaigns, doing referrals, and doing conversions

The reputation model that can be continuously updated by running campaigns serves as the memory of the community. This memory can be valuable as it can provide projection to contractors, influencers, and other converters how valuable it might be to engage an influencer.

To incentivize users to grow their reputation, the described technologies can reward its users for the increase in reputation over a period of time. For this purpose, a fixed fraction of every campaign reward budget can be deducted in favor of a global reward budget. Once a month, the described technologies can reward all users whose global reputation has increased in that period, by an amount proportional to the increase. Additionally, the global reputation can be further increased for each node for an increase in reputation during that period, that can be above a threshold. The extra reputation given can be proportion to the reputation increase during the period. This extra increase incentivizes the node, catapulting active nodes, and especially, newcomers to the described technologies.

The local reputation can be initialized with the global reputation, and can be subsequently a weighted some of the initial global reputation, and updates to the local reputation. However, the weight of the initial global reputations decays gradually as a function of elapsed time.

Technically, the described technologies compose the local reputation as a weighted sum of two elements:
Continuously updated local reputation, rep′, that can be changed due to actions during the campaign
A decaying snapshot of the global reputation at the start of the campaign.

Formally, the local reputation of a node v, at time t+1, in a campaign C, for a category ω, denoted repC (v, ω, t+1) is:

μ(t)rep(v, ω, t₀)+υ(t)rep′(v, ω, t)

Where the weights μ(t) and v(t) can be continuously decaying and increasing, respectively. Any local reputation update can be done into the rep′ component. A snapshot of the global reputation was taken at time t₀, the start of the campaign.

A campaign policy specifies the reward π assigned for each conversion, and the discount α assigned to the converter. The reward and discount are defined as a function of its time within the lifetime of the campaign based on the parameters such as the remaining reward budget and the current conversion rate. The policy of the campaign can be a function, τ(t, T) computing the reward π at time t and the discount at time t in campaign of maximum lifetime T, for a conversion. τ(t, T) can be a pair (π, α):

τ(t, T)=γ(ϕ(t, T)−ϑ(T, T)+δ(θ(t, T)−φ(t, T))

Such that:
ϕ(t, T)—the desirable allocation of accumulated reward from the start of the campaign, e.g. uniform, monotonically increasing, accelerating at start and then uniform, etc.
θ(t, T)—the desirable conversion rate as a function of time, e.g. the well-known hype cycle function
ϑ(t, T)—the actual allocation of accumulated reward from the start of the campaign, e.g. uniform, monotonically increasing, accelerating at start and then uniform, etc.
φ(t, T)—the actual conversion rate as a function of time, e.g. the well-known hype cycle function

Note that as we represent the actual and desirable behavior as functions of time, we clearly distinguish the case of 80% conversion in 20% of the time vs the case of 80% conversion in 40% of the time.

And the functions γ and δ measure the deviations of the actual reward and conversion behavior from the desirable behavior.

The emergent behavior of the referral graph can be due to the behavior of the influencers. Hence, we define the KPIs relative to a single influencer, and the described incentive model can be built to cause the KPI to reach particular targets:

1. Targeted Referral—The influencer can carefully spread the word such that a large proportion of the referrals lead to conversions.

2. Short Time to Conversion—The influencer can cause a conversion as soon as possible.

3. Anti-Spam—An influencer becomes a spammer when it does referrals regardless of any capability to influence. Namely, referral disregards the local reputation of the influencer.

As the influencer brings into the game other influencers, bringing another node that starts to spam, shows lack of distinction of the influencers.

4. Increasing Reach—An influencer enhances the campaign, by bringing into the game new participants.

5. Active participation—An influencer enhances the community by continuous active participation in campaigns.

The reward model operates within a campaign—rewarding influencers and converters after conversions. Assuming the campaign policy assigned a reward π after a conversion to be split among influencers and the converter. The reward π can be spread among influencers.

Upon conversion, we define the conversion DAG, cdag for short, a DAG rooted at the converter, whose edges are the inverse of edges in the referral graph. We split the reward π across the influencers in the conversion graph.

Let us introduce these notations:
The cardinality of a set S can be denoted |S|
The latest referral chain, lrc, can be defined by going in cdag from the converter to one of the nodes of the source seeding, taking in each step the edge with the most recent timestamp.

Influencer Reward—To distribute the reward π among influencers, the described technologies compute a score for influencers in the cdag, and split π in accordance to the score.

The reward mechanism can perform a Breadth First Search (BFS) from the root of cdag, which can be the converter cv. At each distance d from the root, we split a score s_{d}, among the set of nodes in cdag at distance d from the root. That set can be denoted by D.

The score s_{d} for the set of nodes at distance d, decreases geometrically with the distance from the converter, s_{d}=1/2^{d} for d≥0

The score split among the nodes in D can be increased for those influencers on the latest referral chain. It can be decreased for those influencers with many outgoing edges to incentivize targeted referrals. The score assignment for nodes in D can be performed in stages:

A. Assign an equal score to all nodes in D,

$$\frac{{s}_{d}}{\vert D \vert}$$

B. Increase the score of those nodes in D that are on the latest referral chain while reducing the score of the rest in a corresponding amount,

$${coeff}_{lrc} \times \frac{{s}_{d}}{\vert D \vert \vert lrc \vert}$$

where coeff_{lrc}<1; and can be initialized to equal 0.3.

C. Increase the score of nodes in D with a number of outgoing edges smaller than the average number of outgoing edges among the nodes in D, while reducing the score of the rest in a corresponding amount, this fan-out reward change for a node vεD is

$${coeff}_{fo} \times \frac{{s}_{d}}{\vert D \vert} \times \frac{\vert outgoing edges from v \vert}{\vert \text{?} ( \vert outgoing edges \vert ) \vert}$$

$$\text{?} \text{indicates text missing or illegible when filed}$$

where coeff_{ƒ0}<1 and can be initialized to 0.1

D. The described technologies increase the score of each node in the cdag for each outgoing edge to a node which can be new to the described technologies, and hence it did not have any local reputation before.

b|(v, u) ε cdag and ƒ_{C}(u)=0:u|

E. The described technologies increase the score of each node in the cdag relative to its local reputation. Denoting the local reputation of a node v in category ω by repC (v, ω), we define the reputation score increment by:

$$a \frac{{rep}_{C} ( v , ω )}{\text{?} {rep}_{C} ( u , ω )}$$

$$\text{?} \text{indicates text missing or illegible when filed}$$

where the summation can be over the conversion graph.

The score assigned to a node can be the assignments in (A-D) above.

Converter Reward—Usually, campaigns using referrals give a reward to the converter in the form of a discount.

The fraction a of the reward assigned to the converter can be proportional to the number of nodes in cdag that were already known. Thus, if the converter can be new, α can be bigger. This can incentivize bringing in new nodes.

The described incentive model satisfies desirable properties on incentive models and can be Sybil attack-proof.

The described reward model can contribute to some KPI achieving desirable target value. For example:
The geometric assignment of rewards in the conversion DAG, incentivizes short paths from influencer to converter, thereby encouraging short time to conversion.
Decreasing the reward for nodes with relatively many outgoing edges contributes to the targeted referral KPI.
Increasing the reward to nodes with larger reputation contributes to the no spam target.
Assigning a discount relative to whether the whole conversion process added new nodes to the described technologies, incentivizes the increasing reach KPI.

The reward model works for small referrals graphs, and can be not trivial for those referral graphs. These are simple formulas that are practical even for small graphs, and can be measured with the described KPIs even for small graphs. It can be evident by examining the graphs describing the described KPIs that they are applicable in such cases.

The Bid—Each influencer when joining the campaign and upon each referral can be provided with participation conditions, that vary across the lifetime of the campaign, so to prompt the influencer to act in a purposeful manner:

1. Referral quota—how much an influencer can share—computed based on the local reputation of the influencer v as an influencer for the category of the campaign:

a rep_{C}(v, ω)

where repC can be the global reputation function for a node in a category. The quota can be Unbounded. The referral quota can directly control the eventual topology of the referral graph, and can be used as a lever to produce positive and negative feedback for influencers, depending on their positive or negative reputation accumulated during the contract life-cycle.

2. Cost of referral—how much an influencer may have to pay in order to share a referral, a lever to further prevent careless sharing—inversely proportional to the normalized local reputation of the influencer v for the category ω of the campaign,

$$a \frac{rep ( v , ω )}{{\sum }_{v ɛ V} rep ( v , ω )}$$

where repC can be the local reputation function for a node v in a category w in campaign C.

3. Reward projection—the projected reward estimated using the techniques described/referenced herein.

The bid varies across the lifetime of the campaign due to events within the campaign, such as conversions and abuse reports, as these are reflected in the local reputation of the influencer, and hence change the elements of the bid.

Pumping Reputation Attack-Proof—As the reputation model can be a significant component of the described technologies it can be prone to an attack intended on inflating reputation. Thereby distorting future operation of the described with the decaying of the global reputation role within a campaign, protects the described technologies against an attack intended to pump the reputation of nodes through collusion of contractor, influencers, and converters. While the local reputation in future campaigns can be initialized from the pumped up global reputation, the weight of this distorted global reputation can decay through the campaign. Moreover, the cost of referral causes friction to any progress by the fake influencers that got in.

On top of that, the described technologies can employ referral graph analytics to detect such isolated collusion graphs. It can consider the referral graph history, and the degree to which a campaign includes nodes whose identity was verified through identity providers.

Updating Reputation Scores—The global reputation defined over the influence graph, after being initialized from external sources, can be continuously updated after each campaign, by persisting the local reputation graph into the global reputation graph. Such that the global reputation for an edge e at time t+1, ƒₜ, for a particular role r and category ω can be derived from the update Δ(e, r, ω) for this edge, role, and category, and the corresponding reputation at time t, fₜ (e, r, ω), as:

ƒₜ₊₁(e, r, ω)=aƒₜ(e, r, ω)+bΔ(e, r, ω)

such that the coefficient a can be significantly larger than b. This can achieve smooth operation, and to prevent wild swings. It also dampens short-term and singular effects, and protects against malicious collusion.

The coefficients are initially, a=0.9, b=0.1. After the described technologies amasses data on a significant number of campaigns the described technologies can dynamically vary them using machine learning techniques.

The Campaign User Interface—The incentive model can be built from several layers of algorithms and computation, yet to the contractor it provides a simple user interface with a few knobs. Essentially, the contractor can select the form of several trajectories from which the campaign policy and the bid can be derived throughout the lifetime of the campaign.

For the campaign policy:
The form of the conversion rate trajectory
The form of the reward trajectory

For the bid:
The referral quota trajectory as a function of influencer reputation
   The cost of referral trajectory as a function of normalized influencer reputation

System Architecture (e.g., as depicted in FIG. 1 and described herein)—In certain implementations the system backbone runs as a decentralized application (Dapp) running on top of Ethereum blockchain, offloading as much as possible into decentralized off-chain components which can sync with the main chain.

The browser can be a major player in the disclosed architecture, and as much as we can we form dedicated state networks between user browsers, utilizing Interplanetary File System (IPFS) (or another such protocol) and other technologies to enable as much of the smart contracts transactions as possible to play out off chain, utilizing link sharing for contract transactions in a decentralized manner.

In certain implementations, the users' browser (e.g., as executing on a computing device such as a mobile device, personal computer, etc.) interfaces directly with the Ethereum main-net mostly for persisting a new generated contract to the chain, and to process conversion events. Other contract interfaces can be utilized via a decentralized multi-party state network or via interfaces with a hosted Ethereum cluster assisting with event streaming and analytics, as well as managed wallets, dynamic incentive model API, content hosting, and other trustee services backend.

In the Ethereum main chain, the GRN utilizes various contracts. The described architecture of smart contracts can facilitate the economic and managerial functions of the network. A single economy contract can be in charge of minting the tokens (e.g., at launch) and thereafter keeping track of token holdings by users or contracts/entities and the holdings of reputation points by users. The admin contract can hold managerial authority over the network, and is operated by admin, and petitionable by the public of users, via delegates per user pool and via direct polling petition contracts which may be called by the public via the GRN webapp. The admin contract spawns campaign contracts, which in turn spawn unique ARCs balances per contract. These smart tokens (ARCs) travel between wallets as they are shared online, and they can also interface with Uport smart contracts for ID management and reputation persistence. The economy contract also interfaces with dedicated escrow contracts to allow vesting and timelocks for tokens. In addition, there are exchange contracts allowing to conduct fixed rate and conditioned presell of tokens, and ongoing exchange of tokens for the continuous work of the network.

Each contract referenced herein can be generated from the Admin Contract and can generate its own ARCs and manage the micro-economy network dynamically created from the sharing and fulfillment of the contract as it is shared online. In general, the referenced contracts, once generated, are largely played out off-chain, either via a minor-chain on a hosted Ethereum node cluster, or via a decentralized browser based state network created ad hoc between the people sharing the links for this contract. The main chain is only synced with on a periodic basis (daily/per conversion), to persist the contract's state to the public ledger.

FIG. 2 depicts further aspects of the described contracts according to certain implementations.

Economy Contract—this contract holds the described tokens/coins. Coin holders can be users or other contracts. Other contracts can utilize the same economy contract for transferring tokens and retrieving who the admin is. The same contract can be used repeatedly. Therefore, in certain implementations the referenced contracts may not need a method to upgrade their economy contract.

In certain implementations, the described technologies can be initialized by an admin that mints coins. This can be used by an admin contract to mint the first tokens (e.g., after setting itself as the admin contract). Other contracts and users can receive their tokens from the admin contract.

In certain implementations, only the admin contract can replace itself with a new admin contract. This allows new governance decisions in the admin contract to be implemented for moving to a new admin contract. Tokens owned by the old admin can be moved to the new admin. Contracts can be referred to the new admin when they retrieve who the current admin is.

A user holding tokens can also transfer them directly to another user by contacting the economy contract directly or by using an external exchange web site to buy/sell tokens (e.g., because the tokens adhere to the ERC20 protocol).

Contracts can also hold tokens, for example, an exchange contract can automatically exchange between tokens and Ether.

Another example are escrow contracts that hold ownership of tokens for a fixed user and for fixed time.

Another example are campaign contracts that receive tokens from the contractor that created it.

Escrow Contract—The task of this contract is to hold coins in escrow. There can be many contracts of this class or sub-classes of this class.

Usage example: the admin contract wants to give tokens in escrow to a user:

An escrow contract with the user as the receiver. An event is generated which informs the receiver about the escrow.

Another user (usually the Admin contract) transfer tokens from his account in the economy contract to the address of the escrow contract.

When the expiration date arrives, the receiver can redeem the tokens and transfer them to his account.

Vesting Vs. Time lock Vs. Variable Condition Lock:

For vesting options, the admin contract can cancel the escrow contract at any point in time. The escrow contract validates the admin by calling the economy contract.

Transfer the tokens to someone else, for example to the admin contract's token account (because of breach of contract of the receiver).

Transfer tokens to a new instance of an escrow contract (e.g., with different conditions).

For time-locked programs, there is no cancelling by the admin once the contract has been issued.

Using inheritance a subclass contract can utilize custom conditions for unlocking (releasing) escrowed tokens.

A new escrow contract can be created for every user and for every new allocation of escrow tokens to the same user.

Vesting=1 escrow contract per vested amount per person (for example, an user getting X tokens each quarter for 16 quarters, will required 16 escrow contracts).

Exchange contract—This contract can hold multiple coins (e.g., a lot of coins). it can also receive, store and send ETH. Its task is to exchange between ETH and coins.

After being created, it receives its tokens and ETH from another user or contract: from the admin contract or from an older exchange contract.

It receives tokens from users selling their tokens and sends them eth.

It sends its tokens to users buying the tokens and receives eth.

Over time an exchange contract can change. Each instance is an instance of a different sub-class. In certain implementations, there may be only one managed exchange contract active at any given time (with a balance of tokens and eth):

The described platform can set a different exchange contract for different offerings such as presell/public sell offering, etc. Each pre-sell contract has an expiration date and a fixed exchange rate between eth and tokens. In a pre-sell contract you can only buy tokens. For pre-sell exchange contracts, the exchange rate is hard coded into the contract and cannot be changed.

Pre-sell are designed to raise eth for various operation tasks. When a pre-sell is terminated the eth collected is transferred to the Admin contract, from which it can be distributed to voted destinations.

Once all pre-sell contracts are finished we can move to an economy public free exchange contract (“council”) in which you can sell tokens. A user/contract (e.g. the admin) can transfer amounts of tokens or eth if needed at this point or at any future point in time if needed (e.g., to manage liquidity on both sides).

Campaign contract life-cycle:

The described webapp calls Ethereum on behalf of the user, e.g., via metamask account or the managed lightwallet account.

Contractor without balance→

Cash in ETH: the webapp calls on his behalf to the exchange contract→inserts new ETH→Tokens are transferred to the contractor's account→now contractor has balance.

Contractor with balance→uses webapp to generate new contract→transfer tokens to contract for budget (if this is e.g. LeadCampaign)—using the transfer method on the economy contract (webapp calls on his behalf using his account).

Once contract finishes, if any remaining budget from contractor remains, this budget will be transferred back to contractor account.

Referrals→no tokens transferred at this stage

Convertor→either puts in Tokens to the contract (same process as above for contractor) or not, depending on the contract type.

Converter makes conversion event (e.g. presses Buy)

Webapp issues on behalf of the converter an approve call to the economy contract to allow the contract to send predefined number of tokens from the converter's account to campaign account—

This will allow the contract to distribute the acquisition funds to the influencers and the contractor.

The contract itself, after either self-validating the conversion OR getting approval from the contract trustee, can distribute the reward tokens and conversion tokens if applicable.

Send event (propagate to all interested parties—contract, influencers in this conversion chain etc.)—this propagates and shows up per user permissions on the webapp.

PresellAcquisitionCampaign—Can be used by any company (contractor) that is selling an ICO (erc20) using standard ERC20 contract.

The contract inherits both from the campaign contract and the presell contract.

The flow can be as follows:

Contractor creates its own ERC20 contract (contractor economy contract.

Contractor uses the described dApp to create his own PresellAcquisitionCampaign contract initialized with the address of his erc20 economy contract, an expiration date and with a fixed exchange rate in which his tokens will be sold in the presell.

Also can define:

Converter bonus: in contractor's tokens:

The described contract facilitates

Influencer bounty:

ETH:

Taken from acquisition amount of converter

2key Tokens:

Contract's Tokens

Contractor transfers a fixed amount of his tokens to the campaign:

The campaign contract now becomes owner of contractor's tokens

The campaign is then used by influencers until it reaches a converter

A converter calls the buy method of the contract and sends it eth.

The contract removes a fee from the sent eth and then calls the buy method of the presell super-class. This method computes how many tokens are bought using the exchange rate and transfer these tokens from the contract to the convener ownership in the erc20 contracts

The described contract distributes the eth fee to the influencers buy calling the buy method of the presell super-class to each of the influencers

Flow:

Contractor initiates their own economy with an erc20 contract—mints his own tokens—assigns their tokens to themselves (standard economy launch process).

Comes to the described platform/web interface→open business page→creates presellacquisitioncampaign—contract—transfers to the 2key contract address their own tokens as budget for the campaign→their tokens are locked and can either be redeemed by the contractor, or exchanged for eth and the eth can then be redeemed (minus fees and rewards)→contractor sets rewards and bounties→

uses their economy contract to send contractor tokens to the campaign contract.

EthAcquisitionCampaign

Can be used by any company (contractor) that is selling something using their contract. For example standard ERC20 contract with an additional method that allows tokens to be bought directly from the contract using eth.

The flow can be as follows:

Contractor creates its own contract. This contract has a “buy” method using eth.

Contractor uses the described dApp to create his own EthAcquisitionCampaign contract initialized with the address of his contract

The campaign is then used by influencers until it reaches a converter

A converter calls the buyETH method in our EthAcquisitionCampaign contract sending it eth

Our EthAcquisitionCampaign removes a fee from the sent eth and sends the rest to the contractor's contract.

If the contractor's contract was ERC20 it can assign his tokens to our contract

In that case, our contract calls the transfer method of the erc20 to re-assign the external tokens to the converter

Our contract distributes the eth fee to the influencers. Or use it to convert to the described tokens and then distribute the tokens.

Influence Graph and Referral Graph—The referenced influence graph describes the population of individuals V, and the social influence of one individual u on another individual v, as a weighted directed graph G=(V, E, ƒ), where the population can be the set of nodes V, the influence of an individual v on another individual u can be the directed edge e=(v, u), with the degree of influence specified as a weight function f from edges to real numbers. Influence can be broken down with respect to a taxonomy such as a 4-level-deep taxonomy of ˜1.5K categories. Hence, the weight function ƒ maps an edge e and a category ω to a real number. The influence function preserves the ontological structure of the taxonomy, such that the value for the category can be the sum of the values for its sub categories. The influence reputation of a node v for a category ω, can be the sum of its degrees of influence for that category over all outgoing edges in the influence graph. Thus, rep(v, ω)=Σ_{e=(v, u)εE}ƒ(e, ω). in certain implementations the influence graph can be initialized from social networks and identity providers.

A campaign can be started by a contractor that spreads actionable information to a sourcing seed set of nodes. These nodes can subsequently act as influencers to perform referrals. A referral chain can be generated by a sequence of referrals which may reach a node that actually performs the desired action to fulfill the contract's required result, such as purchase of a product, or the consumption of content. That node can be called a converter, and the action can be called a conversion. The spread of information within a campaign C can be a directed acyclic graph (DAG) called the referral graph, R_{C}=(V_{C}, E_{C}, ƒ_{C}). The referral graph includes the degree of influence within the campaign, ƒ_{C} and the corresponding reputation, called the local reputation. In certain implementations the referral graph can be a sub-graph differential component of the global influence graph, and can be superimposed onto the global graph after the campaign can be finished.

In certain implementations the described technologies can be configured to build a community or network where nodes accumulate reputation. This community can grow with each new campaign as new contractors, influencer, and converters, become part of the network as a by-product of creating new campaigns, doing referrals, and doing conversions.

The reputation model that can be continuously updated by running campaigns serves as the memory of the community. This memory can be valuable as it can provide projection to contractors, influencers, and other converters how valuable it might be to engage an influencer.

To incentivize users to grow their reputation, the described technologies can reward its users for the increase in reputation over a period of time. For this purpose, a fixed fraction of every campaign reward budget can be deducted in favor of a global reward budget. Once a month, the described technologies can reward all users whose global reputation has increased in that period, by an amount proportional to the increase. Additionally, the global reputation can be further increased for each node for an increase in reputation during that period, that can be above a threshold. The extra reputation given can be proportion to the reputation increase during the period. This extra increase incentivizes the node, catapulting active nodes, and especially, newcomers to the described technologies.

The local reputation can be initialized with the global reputation, and can be subsequently a weighted some of the initial global reputation, and updates to the local reputation. However, the weight of the initial global reputations decays gradually as a function of elapsed time.

Technically, the described technologies compose the local reputation as a weighted sum of two elements:
Continuously updated local reputation, rep, that can be changed due to actions during the campaign
A decaying snapshot of the global reputation at the start of the campaign.

Formally, the local reputation of a node v, at time t+1, in a campaign C, for a category ω, denoted repC (v, ω, t+1) is:

μ(t)rep(v, ω, t₀)+υ(t)rep′(v, ω, t)

Where the weights μ(t) and v(t) can be continuously decaying and increasing, respectively. Any local reputation update can be done into the rep′ component. A snapshot of the global reputation was taken at time t₀, the start of the campaign.

A campaign policy specifies the reward π assigned for each conversion, and the discount α assigned to the converter. The reward and discount are defined as a function of its time within the lifetime of the campaign based on the parameters such as the remaining reward budget and the current conversion rate. The policy of the campaign can be a function, τ(t, T) computing the reward π at time t and the discount at time tin campaign of maximum lifetime T, for a conversion τ(t, T) can be a pair (π, α):

τ(t, T)=γ(ϕ(t, T)−ϑ(t, T))+δ(θ(t, T)−φ(t, T))

Such that:
ϕ(t, T)—the desirable allocation of accumulated reward from the start of the campaign, e.g. uniform, monotonically increasing, accelerating at start and then uniform, etc.
θ(t, T)—the desirable conversion rate as a function of time, e.g. the well-known hype cycle function
ϑ(t, T)—the actual allocation of accumulated reward from the start of the campaign, e.g. uniform, monotonically increasing, accelerating at start and then uniform, etc.
φ(t, T)—the actual conversion rate as a function of time, e.g. the well-known hype cycle function

Note that as we represent the actual and desirable behavior as functions of time, we clearly distinguish the case of 80% conversion in 20% of the time vs the case of 80% conversion in 40% of the time.

And the functions γ and δ measure the deviations of the actual reward and conversion behavior from the desirable behavior.

The emergent behavior of the referral graph can be due to the behavior of the influencers. Hence, we define the KPIs relative to a single influencer, and the described incentive model can be built to cause the KPI to reach particular targets:

1. Targeted Referral—The influencer can carefully spread the word such that a large proportion of the referrals lead to conversions.

2. Short Time to Conversion—The influencer can cause a conversion as soon as possible.

3. Anti-Spam—An influencer becomes a spammer when it does referrals regardless of any capability to influence. Namely, referral disregards the local reputation of the influencer.

As the influencer brings into the game other influencers, bringing another node that starts to spam, shows lack of distinction of the influencers.

4. Increasing Reach—An influencer enhances the campaign, by bringing into the game new participants.

5. Active participation—An influencer enhances the community by continuous active participation in campaigns.

The reward model operates within a campaign—rewarding influencers and converters after conversions. Assuming the campaign policy assigned a reward π after a conversion to be split among influencers and the converter. The reward π can be spread among influencers.

Upon conversion, we define the conversion DAG, cdag for short, a DAG rooted at the converter, whose edges are the inverse of edges in the referral graph. We split the reward π across the influencers in the conversion graph.

Let us introduce these notations:
The cardinality of a set S can be denoted |S|
The latest referral chain, lrc, can be defined by going in cdag from the converter to one of the nodes of the source seeding, taking in each step the edge with the most recent timestamp.

Influencer Reward —To distribute the reward it among influencers, the described technologies compute a score for influencers in the cdag, and split π in accordance to the score.

The reward mechanism can perform a Breadth First Search (BFS) from the root of cdag, which can be the converter cv. At each distance d from the root, we split a score s_{d}, among the set of nodes in cdag at distance d from the root. That set can be denoted by D.

The score s_{d} for the set of nodes at distance d, decreases geometrically with the distance from the converter, s_{d}1/2^{d} for d≥0

The score split among the nodes in D can be increased for those influencers on the latest referral chain. It can be decreased for those influencers with many outgoing edges to incentivize targeted referrals. The score assignment for nodes in D can be performed in stages:

A. Assign an equal score to all nodes in D,

$$\frac{{s}_{d}}{\vert D \vert}$$

B. Increase the score of those nodes in D that are on the latest referral chain while reducing the score of the rest in a corresponding amount,

$${coeff}_{Irc} \times \frac{{s}_{d}}{\vert D \vert \vert Irc \vert}$$

where coeff_{lrc}<1; and can be initialized to equal 0.3.

C. Increase the score of nodes in D with a number of outgoing edges smaller than the average number of outgoing edges among the nodes in D, while reducing the score of the rest in a corresponding amount, this fan-out reward change for a node vεD is

$${coeff}_{fo} \times \frac{{s}_{d}}{\vert D \vert} \times \frac{\vert outgoing edges from v \vert}{\vert \text{?} ( \vert outgoing edges \vert ) \vert}$$

$$\text{?} \text{indicates text missing or illegible when filed}$$

where coeff_{ƒo}<1 and can be initialized to 0.1

D. The described technologies increase the score of each node in the cdag for each outgoing edge to a node which can be new to the described technologies, and hence it did not have any local reputation before.

b|(v, u) ε cdag and ƒ_{C}(u)=0:u|

E. The described technologies increase the score of each node in the cdag relative to its local reputation. Denoting the local reputation of a node v in category ω by repC (v, ω), we define the reputation score increment by:

$$a \frac{{rep}_{C} ( v , ω )}{\text{?} {rep}_{C} ( u , ω )}$$

$$\text{?} \text{indicates text missing or illegible when filed}$$

where the summation can be over the conversion graph.

The score assigned to a node can be the assignments in (A-D) above.

Converter Reward—Usually, campaigns using referrals give a reward to the converter in the form of a discount.

The fraction a of the reward assigned to the converter can be proportional to the number of nodes in cdag that were already known. Thus, if the converter can be new, α can be bigger. This can incentivize bringing in new nodes.

The described incentive model satisfies desirable properties on incentive models and can be Sybil attack-proof.

The described reward model can contribute to some KPI achieving desirable target value. For example:
The geometric assignment of rewards in the conversion DAG, incentivizes short paths from influencer to converter, thereby encouraging short time to conversion.
Decreasing the reward for nodes with relatively many outgoing edges contributes to the targeted referral KPI.
Increasing the reward to nodes with larger reputation contributes to the no spam target.
Assigning a discount relative to whether the whole conversion process added new nodes to the described technologies, incentivizes the increasing reach KPI.

The reward model works for small referrals graphs, and can be not trivial for those referral graphs. These are simple formulas that are practical even for small graphs, and can be measured with the described KPIs even for small graphs. It can be evident by examining the graphs describing the described KPIs that they are applicable in such cases.

The Bid—Each influencer when joining the campaign and upon each referral can be provided with participation conditions, that vary across the lifetime of the campaign, so to prompt the influencer to act in a purposeful manner:

1. Referral quota—how much an influencer can share—computed based on the local reputation of the influencer v as an influencer for the category of the campaign:

a rep_{C} (v, ω)

where repC can be the global reputation function for a node in a category. The quota can be Unbounded. The referral quota can directly control the eventual topology of the referral graph, and can be used as a lever to produce positive and negative feedback for influencers, depending on their positive or negative reputation accumulated during the contract life-cycle.

2. Cost of referral—how much an influencer may have to pay in order to share a referral, a lever to further prevent careless sharing—inversely proportional to the normalized local reputation of the influencer v for the category as of the campaign,

$$a \frac{rep ( v , ω )}{{\sum }_{v ɛ V} rep ( v , ω )}$$

where repC can be the local reputation function for a node v in a category w in campaign C.

3. Reward projection—the projected reward estimated using the techniques described/referenced herein.

The bid varies across the lifetime of the campaign due to events within the campaign, such as conversions and abuse reports, as these are reflected in the local reputation of the influencer, and hence change the elements of the bid.

Pumping Reputation Attack-Proof—As the reputation model can be a significant component of the described technologies it can be prone to an attack intended on inflating reputation. Thereby distorting future operation of the described with the decaying of the global reputation role within a campaign, protects the described technologies against an attack intended to pump the reputation of nodes through collusion of contractor, influencers, and converters. While the local reputation in future campaigns can be initialized from the pumped up global reputation, the weight of this distorted global reputation can decay through the campaign. Moreover, the cost of referral causes friction to any progress by the fake influencers that got in.

On top of that, the described technologies can employ referral graph analytics to detect such isolated collusion graphs. It can consider the referral graph history, and the degree to which a campaign includes nodes whose identity was verified through identity providers.

Updating Reputation Scores—The global reputation defined over the influence graph, after being initialized from external sources, can be continuously updated after each campaign, by persisting the local reputation graph into the global reputation graph. Such that the global reputation for an edge eat time t+1, ƒₜ, for a particular role r and category ω can be derived from the update Δ(e, r, ω) for this edge, role, and category, and the corresponding reputation at time t, fₜ (e, r, ω), as:

ƒₜ+1(e, r, ω)=a ƒₜ(e, r, ω)+bΔ(e, r, ω)

such that the coefficient a can be significantly larger than b. This can achieve smooth operation, and to prevent wild swings. It also dampens short-term and singular effects, and protects against malicious collusion.

The coefficients are initially, a=0.9, b=0.1. After the described technologies amasses data on a significant number of campaigns the described technologies can dynamically vary them using machine learning techniques.

The Campaign User Interface—The incentive model can be built from several layers of algorithms and computation, yet to the contractor it provides a simple user interface with a few knobs. Essentially, the contractor can select the form of several trajectories from which the campaign policy and the bid can be derived throughout the lifetime of the campaign.

For the campaign policy:
The form of the conversion rate trajectory
The form of the reward trajectory

For the bid:
The referral quota trajectory as a function of influencer reputation
The cost of referral trajectory as a function of normalized influencer reputation

Influence Graph—We introduce the following notation. The population can be denoted by a weighted directed graph, to be called the influence graph, G=(V, E, ƒ), where the set of nodes V can be the collection of individuals, and the set of edges E are the possible influence capability of individuals on other individuals. (The third component, the weight function, ƒ, is described below). Such a graph can be derived via social networks, from communication platforms such as email, and from identity providers. In practice, knowledge of parts of the influence graph can evolve as our information sources evolve, e.g. an individual has a new friend in a social network.

This influence capability can be weighted, such that each edge eεE from node u to node v, can be assigned a real number ƒ(e) denoting the degree of influence of individual u on individual v. Thus, the function ƒ acts as a weight function for the graph. The accumulated ability of an individual to influence other individuals in the population, along the social graph, can be called the individual reputation. The reputation of a node u can be defined as the sum of the degree of influence of that node through edges outgoing from the node. We denote the reputation of a node v, by rep(v):

rep(v)=Σ_{e=(v, u)εE}ƒ(e)

This reputation function can be initialized with information from external information sources, as listed above, and can be further updated when new information from such sources can be obtained. The influence function and the derived reputation function of the influence graph are called global reputation as it does not relate to a particular campaign.

The degree of influence of a node on its neighbors differs according to the category of influence, such as being able to influence their purchases in different product and service categories, or the ability to influence consumption of content. In accordance, we refine the weight function as mapping an edge e and a category ω to a real number, ƒ:E×Ξ→ [symbol] where Ξ can be the set of categories in a taxonomy of categories. That taxonomy can be hierarchical. Let us denote the containment relationship such that category ω̅ being contained in category ω can be denoted by as ω̅<ω.

Hence, the influence with respect to a category can be the sum of influence in its sub categories.

ƒ(e, ω)=Σ_{ω̅<ω}ƒ(e, ω̅)

Correspondingly, we define the reputation of a node v for a category ω, can be the sum of its degrees of influence for that category over all outgoing edges in the influence graph. Thus,

rep(v, ω)=Σ_{e=(v, u)εE}ƒ(e, ω)

And

rep(v, w)=Σ_{ω̅<ω}rep(v, ω̅)

As the described technologies can be a platform for referral, we further distinguish degree of influence according to according to the role of an individual in any organized effort to disperse a product, service, content, or idea Such an effort can be henceforth to be called a campaign. Within a campaign, an individual can be the originator of the campaign, henceforth to be called a contractor, an individual propagating the dispersal, henceforth to be called an influencer, or an individual executing some desirable action, such as participating in a public demonstration, or purchasing a product, henceforth to be called a converter.

Consequently, reputation f can be a triple of functions, (ƒ_{inf}, ƒ_{conv}, ƒ_{tract}) defining an influence as an influencer, converter, and contractor, respectively. Each of these functions can be an assignment of a real number to each category.

A campaign initiated by a Contractor starts from a source seeding, selecting a collection of sources A⊆V which are given an actionable item to spread through their social network. The actionable item can be a product or service to be sold, content to be shared, or a desirable action, such as registering in a mailing list.

The source seeding may be initiated via search or discovery over the population graph. Such search or discovery may be based on thy external reputation of the nodes.

When an individual in the population executes the actions associated with the item, we call that execution a conversion. The node executing the conversion can be called a Converter. The act of spreading the actionable item can be called referral. A direct referral follows an edge of the population graph. A node which performs a referral can be called an influencer. An indirect referral follows a path in the population graph, from one influencer to the next, through referrals. A referral chain can be a direct or indirect referral. Hence, it can be a path in the population graph starting from a source, such that all subsequent nodes on the path are influencers. A node which received a referral may execute a conversion at any time afterwards. Such a node may also act as an influencer and do a referral to adjacent nodes in the population graph.

Referral Graph—The subgraph of G which can be induced by the referral chains of a particular campaign C, can be called the referral graph of the campaign, to be denoted by R_{C}=(V_{C}, E_{C}, ƒ_{C}). Each referral edge e can be assigned a timestamp ts(e). However, the reputation of a node within a campaign can be defined by the actual acts of influence within the campaign. Thus, ƒ_{C} can be measured by an actual referral from a node. This reputation within a campaign can be called local reputation.

Referral chains are paths in the referral graph that start from source nodes. A conversion chain can be a path in the referral graph that starts from a source node, such that each node can be an influencer, and ends at a converter node. A conversion chain can be a partial subset of a referral chain that starts from one of the sources and ends in a converter. The referral graph can be a direct acyclic graph (DAG).

In a single campaign, each node can play both the role of an influencer or the role of a converter. These two roles may be taken at different times during the lifetime of a campaign.

For the benefit of generality, we assume a campaign C starts at a node to be called a contractor, denoted c, which performs source seeding to the set of sources.

Such a contractor of a campaign C, may play the role of an influencer or a converter in other campaigns. But, cannot have the role of a converter or influencer in C. So if we consider the population graph G, and a set of campaigns {C}, each node can play the role of a contractor, influencer or convertor across the set of campaigns.

In some campaigns, a converter may execute the conversion multiple times during the lifetime of a campaign.

The lifetime of a campaign may be finite or infinite.

Within a campaign, an influencer receives a reward for the act of referral under conditions to be determined by the incentive model. The reward can be a quantity in some denomination, allocated by the campaign to the influencer. This quantity may be assigned in parts, along the lifetime of the campaign as determined by the incentive model.

So, considering an open-ended set of campaigns, where multiple campaigns exist concurrently, these campaigns generate a corresponding set of referral graphs overlaid on the population graph.

Local Reputation—As the campaigns can be executed, one can measure the degree of success of different contractors, influencer, and converter has within the campaign with respect to the goals of the campaign. Such as did an influencer perform useful referrals? Did a converter convert and with what quantity? Did a contractor had a success with a campaign and to what degree?

The degree of influence within a campaign of one individual on another individual can be broken down with respect to the role of the individual as a contractor, influencer, and converter. This local reputation ƒ_{C} can be refined to a triple of functions, (ƒ_{inf}, ƒ_{conv}, ƒ_{tract}), defining an influence as an influencer, converter, and contractor, respectively. Each of these functions can be an assignment of a real number to each category.

The reputation of a node, can be similarly defined as a triple of numbers, corresponding to the role of a node as an influencer, converter, or contractor, and derive from the corresponding components of the local reputation. The local reputation of a node v can be denoted repC (v).

The local reputation can be initialized at the start of the campaign from the global reputation, and it can be incrementally updated during the lifetime of the campaign, according to the actions of referral and conversion within the campaign. As time passes in the campaign, the contribution of the global reputation to the local reputation can be decreased automatically.

Persisting Local Reputation to the Global Reputation—As many campaigns can occur concurrently, we consider the global reputation, as accumulated continuously, from all campaigns.

The global reputation can be initialized by the external reputation, and can be updated when the external reputation changes to reflect changes in the world outside of the described technology ecosystem.

This global reputation represents our knowledge of the past performance of nodes. At the end of a campaign, we persist the local reputation of that campaign into the global reputation, so as to accumulate the information on degree of influence of individual as observed within the campaign. The algorithm for update can be described below.

The global reputation can be used by the contractor of a campaign in selecting the sources of each campaign. A better reputation for an influencer improves the participation conditions, to be called a bid, that an influencer can get from a campaign. A better reputation for another influencer or a converter can be used by influencers to tilt their referrals within a campaign. A better reputation for a contractor can tend to persuade influencers to participate in a campaign initiated by that contractor.

Time Evolution—To represent the dynamic creation of campaigns, the lifetime of a campaign, and the dynamic nature of reputation, we generalize our notation, as follows:
The influence graph at time t can be denoted by Gₜ=(Vₜ, Eₜ, ƒₜ) such that ƒₜ can be the global reputation function at time t
The referral graph of a campaign C at time t denoted R_{C, t}=(V_{Ct}, E_{Ct}, ƒ_{Ct}), such that ƒ_{C,t} can be the local reputation

The influence graph at time t+1, Gₜ₊₁, can be derived from Gₜ and the set of referral graphs of all campaigns conning at time t, {C|R_{Ct}}. The new influence graph may include new nodes and edges, and an updated global reputation.

The referral graph of a campaign C, at time t+1, R_{C, t+1}, can be derived from the referral graph at time t, R_{C, t}, according to new referrals, new conversions, and the changes in local reputation.

The Community Effect

The aim of the described technologies can be to build a community where nodes accumulate reputation. This community can grow with each new campaign as new contractors, influencers, and converters, become part of the described technologies as a by-product of creating new campaigns, doing referrals, and doing conversions.

The reputation model that can be continuously updated by running campaigns serves as the memory of the community. This memory can be valuable as it can provide projection to contractors, influencers, and other converters how valuable it might be to engage an influencer.

Moreover, in terms of miming the campaign and its reward model, the global reputation enables to scale the importance of actions such as referrals and conversions. As a campaign starts, we have little data on which to base decisions, such as the bid, the campaign policy, and the reward mode. The global reputation provides us with the rich initial data Reputation scores are the sovereign property of users, which the user can choose to publish. It can be published to their account, and published on the described technologies.

In order to incentivize users to grow their reputation, the described technologies can reward its users for the increase in reputation over a period of time. For this purpose, a fixed fraction of every campaign reward budget can be deducted in favor of a global reward budget. Once in a period (say, a month or quarter), the described technologies can reward users whose global reputation has increased, by an amount proportional to the increase. Being proportional to the increase in reputation, the reward can incentivize users to remain active in the community.

Additionally, the global reputation can be further increased for each node for an increase in reputation during that period, that can be above a threshold. The extra reputation given can be proportion to the reputation increase during the period. This extra increase incentivizes the node, catapulting active nodes, and especially, newcomers to the described technologies.

The Contractor's Choice—the described technologies can make available to contractors the global reputation of nodes so they can wisely select the sourcing seed of the campaign. The described technologies can expose the global reputation of a node, not its degree of influence on other nodes.

The Influencer's Choice—Influencers may use the published the described technologies global reputation of nodes, if available, to make decisions about referrals.

The KPIs and the Targets

We define two types of KPIs:

1. Referral graph KPIs—the desirable behavior of an individual campaign. The emergent behavior of the referral graph can be due to the behavior of the influencers. Hence, we define the KPIs relative to a single influencer, and the described incentive model can be configured cause the KPI to reach particular targets

2. Influence graph KPIs—the desirable properties of the community. How we describe the ongoing activity of a healthy community. The emergent behavior of the community can be due to the global reputation model.

Referral Graph KPIs

Targeted Referral—The influencer can carefully spread the word such that a large proportion of the referrals lead to conversions.

Technically, taking the subgraph R′ of the referral graph rooted at the influencer, the KPI can be defined as the ratio of the number of conversions in the subgraph to the edges in the subgraph:

$$\frac{\vert conversions in {R}^{′} \vert}{\vert edges in {R}^{′} \vert}$$

The optimal target value of this KPI can be to be as close to 1 from below as possible.

Short Time to Conversion—The influencer can cause a conversion as soon as possible.

Technically, taking the subgraph R′ of the referral graph rooted at the influencer, the KPI can be defined as the average distance of the influencer to converters. We take the average because it can captures the overall distribution of the behavior of the influencers across the campaign.

Formally,

Average_{converters ε R′}|path from influencer to converter|

The optimal target value can be as close to 1 from above as possible.

Increasing Reach—A campaign can enable an influencer to spread the word to new users, because if all referrals were already in the influence graph, and had a reputation, the contractor could select them by itself as a source seeding.

Technically, taking the subgraph R′ of the referral graph rooted at the influencer, the KPI can be defined as the ratio of the number of new nodes in the subgraph to the total nodes in the subgraph.

Formally,

$$\frac{\vert u ɛ {R}^{′} \text{:} u is new \vert}{\vert u ɛ {R}^{′} \vert}$$

The optimal value of the KPI can be as close to 1.

The optimal target value can be as close to 1 from below.

Influence Graph KPIs

Validity of Reputation Model—In certain implementations, the reputation model can predict future referral success, Hence, the total global reputation across the referral graph, can project the number of conversions in the referral graph.

Technically, taking a set of referral graphs {R}, and drawing a graph relating size of referral graph (the horizontal axis) and the number of conversions (the vertical axis), the KPI can be defined as the slope of the best fitting function for the graph.

The target value of the KPI can be as close to 1 as possible.

Retention of Influencers in the described technologies—An active influencer continuously makes referrals. Hence, it reputation can be continuously updated. The described technologies can be configured to measure for a given time period, the total sum of changes to reputation. Because more campaigns can naturally lead to more reputation changes, the described technologies can be configured to normalize the sum to the number of campaigns within that period.

Technically, we take the sum of absolute values of changes in a time period.

Formally, denoting the global reputation in time t of a node v in the influence graph as ƒ(v, t), the change in a time period Δt, and the change in reputation within that time period as Δƒ, the KPI is:

(ΣA_{vεV}|Δƒ|)/(number of campaigns in Δt)

The optimal target value can be as large as possible.

Machine Learning—Once data on campaigns is accumulated, the described technologies can optimize these KPIs. In particular, functions like average or sum used in defining KPIs, may be further refined.

Smart Contracts—The technical vehicle through which we implement a campaign can be a smart contract. A smart contract selects the source seeding to start the campaign. The selection can be performed by the contractor of the campaign and may use the global reputation of nodes. The smart contract rewards the influencers according to the incentive model of the smart contract. This incentive model can cause the referral graph of the contract to have a particular topology as it impacts which referrals the influencer can consider within the contract. The smart contract can update the local reputation of the contract.

The Incentive Model—The campaign can provide reward to nodes for doing actions. The mathematical model for providing rewards along the lifetime of a campaign can be called the incentive model.

The foremost action to be rewarded can be a referral. But not all referrals are equal. A referral leading to a conversion down the referral chain can be clearly more valuable. Yet, we may want sometimes to reward a referral even if it was not part of a conversion chain.

There are several motivations for that:
A campaign may wish to reward an effort, even if unsuccessful, as at the moment of referral, an influencer cannot project with certainty whether it his/her referral can lead to a conversion
A campaign goal might be brand awareness—and not necessarily just direct action

To briefly describe desirable properties of an incentive model, let us introduce the following terms. A contribution of a participant can be either a referral or a conversion within a campaign. A Sybil attack can be an individual creating a fake replica of itself so as to reap additional rewards.

Properties of a good incentive model:

Basic Properties
Continuing Contribution Incentive (CCI): A reward mechanism satisfies CCI if it provides a participant u with increasing reward in response to an increase of u's contribution.

This encourages participants to continue contributing to the system (e.g., to do more referrals).
Continuing Solicitation Incentive (CSI): A reward mechanism satisfies CSI if every participant always has an incentive to refer new participants. This encourages ongoing referrals and ensures continuing growth of the system.
Reward Proportional to Contribution (φ-RPC): This property suggests that a reward mechanism can maintain some basic notion of fairness among the participants.

Namely, the reward can be proportional to the contribution of the participant.
Unbounded Reward Opportunity (URO): This property demands that there should be no limit to the reward a participant can potentially receive, even when his own contribution can be fixed by constant.
Profitable Opportunity (PO): The PO property can be a weaker version of URO. It suggests that a converter with any positive contribution has the opportunity to get positive profit (reward minus cost of conversion).
Subtree Locality (SL): This property demands that the reward paid to a participant can be determined uniquely the subgraph of the referral tree rooted at the participant. The property ensures that each user can be credited only for actions (conversions and referrals) performed by itself, or its descendants. Violation of this property can have undesirable consequences. For example, the reward of a user could increase or decrease without him having taken any action (no new purchases or newly referrals in his subtree).

Sybil-Attack Resilience Properties
Unprofitable Sybil Attack (USA): A mechanism satisfies USA if a participant with a given contribution cannot increase his reward by joining the system as a set of Sybil nodes instead of joining as a single node. In other words, a participant who makes a certain contribution to the system should not have a benefit of “splitting” himself and its contribution up and making these contributions as two or more identities, even if these “Sybil identities” join the tree as if referring themselves.
Unprofitable Generalized Sybil Attack (UGSA): This property can be strictly stronger than USA. The property demands that a participant cannot increase his profit by joining the tree as multiple identities, even if by doing so, he increases his contributions, i.e., purchases additional goods.

Impossibility Result

There can be no incentive tree mechanism that can simultaneously achieve SL, PO and UGSA.

In the described context, as can be seen below, PO and URO are less important, as campaigns runs usually with a budget of rewards. So we can consider incentive mechanisms that have all basic and properties and Sybil-Attack Resilience Properties, except for PO and URO.

Good Incentive Models

A geometric incentive model assigns a reward to a reference chain such the reward to a node decreases by a constant factor as we move along the chain from the source node. Such a mechanism may suffer from Sybil attacks. A modification of the geometric mechanism can be suggested in order to make it Sybil-proof. The following modifications are introduced:

1. Putting an upper bound on the reward a node can get from each child in the referral tree, such that the bound can be relative to the cost of the conversion to the contractor.

2. The described technologies redistribute what the node gets from its ancestors in the referral graph to the descendants of the node in the referral graph.

Estimation of Propagation

Using continuous-time diffusion networks, provide an algorithm for estimating the reach of a referral graph over a known influence graph within a given time window. This approach may be inapplicable in certain implementations because we may not know influence graph a priori. Their approach uses randomized estimation and can be based on the notion of marginal gain.

The described reward mechanism can operate dynamically based on the ongoing behavior of nodes.

In certain implementations, a reward model can provide incentives only to roots. Using percolation theory, it can be shown how to maximize the reach of a campaign per a given total reward. budget. Subsequently, a function can be defined, projecting a reach for a given cost. Despite the limitations of this model, the referenced results can be used in defining the described algorithms defining the various options to be available to a contractor for a campaign policy. Namely, the reward to be allocated at each conversion according to its time in the lifetime of the campaign.

The Campaign Policy

On the start of a campaign, we need the setup of its budget and targets. Thus, the following are to be specified by the contractor:

1. Total reward budget

2. The target number of conversions—may be unbounded

3. The lifetime of the campaign—may be unbounded

As the campaign evolves the described reward models assigns rewards per conversion to influencers for contributing towards the conversion, and a discount (reward) to converters. Such assignment can change over time according to the policy of the campaign.

A campaign policy specifies the reward assigned for each conversion as a function of its time within the lifetime of the campaign based on the parameters such as the remaining reward budget and the current conversion rate. The policy of the campaign can be a function, τ(t, T) computing the reward π at time t in campaign of maximum lifetime T, for a conversion to be split among influencers, and the discount α for the converter, (which may be zero).

The policy of the campaign can be specified based on two functions on the time from the start of the campaign:
The desirable accumulated reward from the start of the campaign, e.g. uniform, monotonically increasing, accelerating at start and then uniform, etc.
The desirable progress of conversion rate across the lifetime of the campaign, e.g. the well-known hype cycle function.

These functions are specified by the contractor in the user interface.

Technically, This first function can be denoted ϕ(t, T) and takes as arguments the time t from the start of the campaign, the total lifetime of the campaign T. The second function can be θ(t, T), where t can be the time from the start of the campaign, T can be the lifetime of the campaign.

These functions are compared to actual allocation of rewards and the actual conversion rate over time, denoted by ϑ(t, T) and φ(t, T), respectively, with the same arguments.

Note that as we represent the actual and desirable behavior as functions of time, we clearly distinguish the case of 80% conversion in 20% of the time vs. the case of 80% conversion in 40% of the time.

The campaign policy can be based on computing the deviation between the corresponding functions, planned reward allocation vs. actual reward allocation, and planned conversion rate progress vs actual conversion rate progress.

Technically, the policy can be a function, τ(t, T) computing a pair: (a) the reward π at time t in campaign of maximum lifetime T, for a conversion to be split among influencers, (b) and the discount for the converter, if any, α:

τ(t, T)=γ(ϕ(t, T)−ϑ(t, T))+δ(θ(t, T)−φ(t, T))

where the functions γ and δ measure the deviations of the actual reward and conversion behavior from the desirable behavior.

When choosing a campaign policy, the contractor can factor in the cost of validating a conversion, such as a lead into the amount of the reward.

The Bid—The bid defines the influencer participation conditions. These determine the influencers' behavior. They are intended to make that behavior be beneficial to the campaign and to the whole the described technologies ecosystem.

An influencer can be encouraged to initiate, create, etc. referrals. However, to be beneficial to the campaign, an influencer can be selective in his/her referrals. We are interested in referrals that lead to conversions. Of course, the influencer node has the best knowledge on the vicinity of the its referral graph.

Technically, to make the influencer act in a discriminant way, we bound the number of referrals an influencer can do within a campaign. The bound can be called the referral quota. This bound can be influencer-specific according to its global and local reputation. The bound may be infinite in a particular campaign for specific influencers or for all influencers.

An influencer exerts some effort when doing a referral—be it a phone call or a transmission record on the blockchain. To describe that cost, we assign an influencer, once the campaign reaches that influencer, a cost for referral.

An influencer can be incentivized, so an influencer should know at each moment, what can be the estimated reward for the influencer actions. That reward can motivate referrals that lead to conversions. But, some campaigns may wish to reward even for a referral that did not lead to a conversion, as such referrals increase the brand awareness. This reward projection can be reflected to the influencer so that the influencer node can operate in a way beneficial to itself.

As the reward computation for a conversion may vary along the lifetime of a campaign, the estimated reward can be a projection function that may change along the lifetime of a campaign. The estimated reward can be computed based on the described reward algorithm. In accordance it considers the following elements:

1. Anyone along a referral chain leading to a conversion can be rewarded—we reward for the effort and the brand awareness an influencer created.

2. The closer an influencer can be to a converter, the influencer can be rewarded more—an influencer can be encouraged to take direct effective referrals.

3. The last referral leading to a conversion, can be rewarded more than earlier referrals—an influencer can be encouraged to make direct immediate referrals causing conversion.

4. The influencer local reputation and global reputation as an influencer increase the reward—the past global performance within the described technologies and the past performance within a campaign impact the reward.

5. If you make more referrals than the other nodes at the same distance from the converter, you are rewarded less—we discourage rampant referrals.

The described technologies maintain a reputation model for influencers as the historical memory of past performance of influencers. A better reputation can provide the influencer in the future with a better bid. The reverse can be also true. A deteriorating performance of an influencer can lower the influencer's reputation, resulting can be less favorable future bids.

So, to be transparent towards participants, the described technologies can be configured to inform the influencer as part of the bid about its performance impact on reputation. However, as the reputation update for an influencer due to any conversion during the lifetime of the campaign can be directly proportional to the reward assigned to the influencer, no additional transparency can be needed. A similar argument holds for the reputation update at the end of the campaign It follows a similar pattern but looks globally at all outgoing referrals from an influencer, and their proportion that contributed to a conversion.

As a reputation can be manually updated by the contractor, other influencers, and the converter, this may cause a concern to the influencer. However, as the reputation update due to manual intervention can be dampened by the described technologies using similar considerations.

Thus, in certain implementations there may be no need to specify in detail to the influencer the reputation update. But, the influencer can be informed that the quality and contribution of the influencer's actions within a campaign can impact future bids across future campaigns.

Technically, the influencer operates according to the following time-dependent parameters, that may vary across the lifetime of the campaign,
Referral quota—how much an influencer can share—computed based on the local reputation of the influencer v as an influencer for the category of the campaign:

a rep_{C} (v, ω)

where repC can be the global reputation function for a node in a category. The quota can be unbounded.
Cost of referral—how much an influencer has to pay in order to share a referral, a lever to further prevent careless sharing. We scale the influencer reputation relative the the total reputation already in the campaign. To give proper weight to how much reputation the influencer can be bringing into the campaign. Hence the cost can be inversely proportional to the normalized local reputation of the influencer v for the category co of the campaign,

$$b \frac{{rep}_{C} ( v , ω )}{{\sum }_{v ɛ {R}_{C}} {rep}_{C} ( v , ω )}$$

where repC can be the local reputation function for a node v in a category w in campaign C.
Reward projection—what can be the projected reward as a table assigning a projected reward per conversion, according to distance from the converter of the influencer, assuming all influencers has the same referral quota as this influencer. The reward projection can be estimated using various techniques such as those described herein.

The bid varies across the lifetime of the campaign, due to events within the campaign such as referrals, conversions and abuse reports, as these are reflected in the local reputation of the influencer that can be considered in computing the bid.

The Reward Mechanism

Once a conversion occurs during the lifetime of a campaign, the described technologies can be configured to reward the influencers that are located on referral chains leading from sources to the conversion. The referral graph, being a DAG may have multiple such chains. Each such chain contributed towards the conversion but the last one can be considered more powerful. The described technologies can reward based on results, that can be conversion, but we also want to factor in accumulated reputation.

Technically, consider a converter cv, the referral graph at the time of conversion, R_{C, t}, and the influence graph at that moment, G_{C, t}. The described reward mechanism operates on a DAG, denoted dag(cv), which can be a subgraph of the referral graph, including the converter, and all nodes and edges in the referral graph on any referral chain from some source node to the converter. It can be easier to work in terms of the inverse of dag(cv), denoted cdag(cv) obtained by invert the direction of the edges in dag(cv). This can be a DAG with root cv, to be called henceforth the conversion DAG.

Define the latest referral chain, denoted lrc(cv) as the path in the conversion DAG from the root, such that each step, the described technologies take the edge with the latest timestamp.

The reward per conversion may change over the lifetime of a campaign. Such time dependent behavior and the total reward budget can be part of the of the campaign policy described elsewhere. So from now that the reward to be given was determined as it.

The described technologies can spread the reward π for a conversion, over the conversion DAG, taking the following factors into account:

Conversion-Specific Factors

1. The latest referral chain can be considered a more powerful influence effect

2. The distance from the converter—the farther the influencer can be—the influencer had less influence on the actual conversion

Campaign-Wide Factors
The local influencer reputation
The number of edges from the referral graph outgoing from the influencer—a larger number indicates a less discriminating referral approach. If you cast a wide net, you are bound to catch something. But for the campaign such a wide net can cost more in terms of rewards but with a smaller ROI.
Boost the reward for bringing new people into the game.

Anti Attack Measures

1. The reward mechanism can defend against Sybil attacks

The Reward Algorithm

The reward model operates within a campaign—rewarding influencers and converters after each conversion. Assuming the campaign policy assigned a reward π after a conversion to be split among influencers and the converter, such that the influencers receive rest and the converter receives 1-απ.

The reward mechanism first computes α, and then splits 1-απ among influencers.

Let us introduce these notations:
The cardinality of a set S can be denoted |S|
The latest referral chain, lrc, can be defined by going in cdag from the converter to one of the nodes of the source seeding, taking in each step the edge with the most recent timestamp.

The described reward algorithm can include numerous conversion-specific factors. The reward algorithm assigns for each node in the conversion DAG a reward score which can be a real number. The reward for the conversion out can be split among the nodes in the conversion graph, such that each node can be assigned a part of the reward proportional to its reward score divided to the suns of all reward scores.

The reward algorithm operates from the root of the conversion DAG in phases. The initial score for all nodes can be zero. Each phase adds or subtracts from the score of each node.

Phase A—Reward for Actions

Do a Breadth First Search (BFS) from the root of the conversion DAG.

The BFS proceeds from the mot at increasing distance from the root starting at distance l.

At distance d from the root, the described technologies split a score of s_{d} among all nodes at distance d from the root. Denote the set of such nodes by D.

The score to be split at distance d, s_{d} can be defined as, sd=1/2d for d>0.

The score assignment for nodes in D can be performed in stages:

A. Assign an equal score to all nodes in D,

$$\frac{{s}_{d}}{\vert D \vert}$$

B. Increase the score of those nodes in D that are on the latest referral chain while reducing the score of the rest in a corresponding amount,

$${coeff}_{Irc} \times \frac{{s}_{d}}{\vert D \vert \vert Irc \vert}$$

where coeff_{lrc}<1 and can be initialized to equal 0.3

C. Increase the score of nodes in D with a number of outgoing edges smaller than the than the average number of outgoing edges among the nodes in D while reducing the score of the rest in a corresponding amount, this fan-out reward change for a node vεD can be

$${coeff}_{fo} \times \frac{{s}_{d}}{\vert D \vert} \times \frac{\vert outgoing edges from v \vert}{\vert {avg}_{u ɛ D} ( \vert outgoing edges \vert ) \vert}$$

where coeff_{ƒ0}<1 and can be initialized to 0.1

D. The described technologies increase the score of each node in the cdag for each outgoing edge to a node which can be new within the described platform, and hence it did not have any local reputation before.

b|(v, u) ε cdag and ƒ_{C}(u)=0: u|

Phase B—Reward for Reputation

The described technologies increase the score of each node in the conversion DAG relative to its local reputation. This can be intend to recognize the ongoing contribution to the campaign.

The score can be increased by a factor proportional to its local reputation, normalized to the total local reputation, of the nodes in the cdag. Denoting the local reputation of a node v for category ω by rep_{C} (v, ω), we define the reputation score increment by:

$$d \frac{{rep}_{C} ( v , ω )}{\text{?} {rep}_{C} ( u , ω )}$$

$$\text{?} \text{indicates text missing or illegible when filed}$$

where rep can be the global reputation function for a node v in a category, rep_{C} can be its local reputation, and the summation can be over the conversion graph.

This normalization can level the playing field for the influencers of the campaign.

Sybil Attack-Proof

The described incentive model satisfies desirable properties specified regarding incentive models and can be Sybil attack-proof.

We satisfy the conditions for guaranteeing Sybil-proof as described herein.

1. Putting an upper bound on the reward a node can get from each child in the referral tree, such that the bound can be relative to the cost of the conversion to the contractor—As the described technologies propagate rewards from the converter, and reduce assigned rewards the closer a node can be to the sources, the reward one can get from each child can be bounded relative to the overall reward per conversion.

2. A node in the referral graph distributes the reward assigned to it from its ancestors among its descendants in the referral graph—As the described technologies propagate the rewards from the converter towards the sources while reducing the assigned reward the closer the node can be to the sources, we satisfy this condition.

Reputation Pumping Attack-Proof

As the reputation model can be a component of the described technologies it can be prone to a different sort of attack intended on inflating reputation. Doing so may distort further operation of the described technologies. In such an attack a collusion of contractor, multiple influencer and converters, all or sonic of each may be fake identities of the same individual, may artificially “pump up” the reputation of nodes, without anything happening in the real world.

The bid which includes a referral cost for each referral, negatively incentivizes any such collusion. Because not only can the participants in the collusion pay during the reputation pumping operation, they can also pay later for referral during a real campaign as their referrals can have a cost. This friction dampens the effect of the reputation pumping.

Moreover, the fact the impact of the global reputation on the local reputation decays throughout the campaign, causes a fake node to slowly lose its reputation—sure, you got it, but you can participate in sonic conversion to actually justify the “pumped-up” reputation. Even if you carry the collusion operation indefinitely across many fake campaigns, you still need to do something real to get a reward in a campaign which can be real. But the periodic assignment of rewards to a reputation increase and the extra increase of reputation for increase across a period, can amplify the effects of such a collusion.

To protect against this attack, the described technologies can require sign up through identity providers, thereby reducing the risk of fake identities. Additionally, the described technologies can employ fraud detection measures through ongoing analysis of the influence graph. Such collusion can be identified as isolated graph clusters. Such fraud detection can consider the proportion of nodes participating in a campaign whose identity was explicitly verified.

The described Reward Model can Contribute to The described KPIs in various ways, e.g., to achieve desirable target values.
The geometric assignment of rewards in the conversion DAG, incentivizes short paths from influencer to converter, thereby encouraging short time to conversion.
Decreasing the reward for nodes with relatively many outgoing edges contributes to the targeted referral KPI.
Increasing the reward to nodes with larger reputation contributes to the no span KPI and indirectly to the active participation KPI
Increasing relative to whether the whole conversion process added new nodes to the described technologies, incentivizes the increasing reach KPI.

The Small Graph Case

The reward model works for small referrals graphs, and can be not trivial for those referral graphs. These are simple formulas that are practical even for small graphs, and can be measured with the described KPIs even for small graphs. It can be evident by examining the graphs describing the described KPIs that they are applicable in such cases.

The Reputation Update

The reputation model can be the memory of past performance global across the described ecosystem and locally within a campaign. Reputation can be used to provide the bid, and in calculating the rewards per conversion.

As the reputation for each node in the influence graph can be according to role (converter, influencer, contractor) and each role can be broken down to categories, any reputation update of an individual can be for a combination of role and category.

In certain implementations, a reputation update can occur automatically upon the following events in the lifetime of the campaign:

1. Start of campaign—for the contractor

2. End of campaign—for the contractor

3. End of campaign—influencers in the referral graph of the campaign

4. End of campaign—converters in the referral graph of the campaign

5. On each referral, for the influencer doing the referral

6. On each conversion, for the converter and the influencers participating in the conversion DAG of that conversion

A manual reputation update can be performed by the contractor, the influencers, and the converter during the lifetime of a campaign.

Smoothness and Debouncing of Updates

Because the reputation can be the historical memory of the described technologies and can be crucial in determining rewards and the operating assumptions of the influencer, the incentive model can be careful in updating reputations. Such carefulness can be required for two reasons. First, the described technologies can be configured to smooth the updates both global and local during the course of the campaign. It can be known that spikes of referrals and conversions can occur that are insignificant of the when measured along the whole lifetime of the campaign. Moreover, when considering referrals and conversions we are interested in long-term effects. This further requires smoothing short-term effects.

Automatic updates of reputation are governed by the described technologies, so malicious updates are not possible.

Manual updates may be guided by malicious motives, so for updates coming from convertors and influencers, the described technologies can be configured to limit their effect both locally and globally. Contractors are less likely to be malicious and anyway they are paying the bill so local reputation can be their sole discretion. While local reputation can be overall at the sole discretion of the contractor, the described technologies can be configured to limit its effect on the global reputation, as malicious contractors that want to damage the whole the described technologies ecosystem are certainly a risk.

For manual updates, which are well intentioned and whose purpose can be tuning, we still can apply some filtering to make sure the tuning does not cause wild swings in an otherwise successful operation. So, any manual update can be relativized to the actual observed performance.

Initializing the Local Reputation

The local reputation can be initialized at the start of the campaign from the global reputation, and it can be incrementally updated during the lifetime of the campaign, according to the actions of referral and conversion within the campaign. As time passes in the campaign, the contribution of the global reputation to the local reputation can be decreased automatically.

Technically, we compose the local reputation as a weighted sum of two elements:
Continuously updated local reputation, rep′, that can be changed due to actions during the campaign
A decaying snapshot of the global reputation at the start of the campaign.

Formally, the local reputation of a node v, at time t+1, in a campaign C, for a category ω, denoted rep_{C} (v, ω, t+1) is:

μ(t)rep(v, ω, t₀)+υ(t) rep′(v, ω, t)

Where the weights μ(t) and v(t) can be continuously decaying and increasing, respectively. Any local reputation update can be done into the rep′ component. A snapshot of the global reputation was taken at time t₀, the start of the campaign.

Driving the Global Reputation Through the Local Reputation

The global reputation can be derived from the accumulation of local reputation of many campaigns. Thus, at the end of each campaign, the described technologies update the global reputation using the local reputation. In effect, we persist the local reputation into the global reputation,

As such, the described technologies can be configured to smooth variations in local reputation models across all campaigns when combining these local reputation models into the global reputation model. We may not want a single campaign good or bad performance to cause major change in the global reputation. Moreover, as reputation measures accumulate for each contractor, influencer and converter, the described technologies can be configured to normalize the contribution of each local reputation to the global reputation.

Overall, summing the above discussion, the update Δ across time to a reputation ƒ, either local or global, can take the form:

ƒₜ₊₁=aƒₜ+bΔ (1)

Where ƒₜ₊₁ can be the reputation at time t+1 derived from the reputation ƒₜ at time t, and the update Δ. The coefficient a can be significantly larger than t. This can achieve smooth operation, and to prevent wild swings. It also dampens short-term and singular effects, and protects against malicious collusion.

In detail, the global reputation for an edge e at time t+1, ƒₜ, for a particular role r and category ω can be derived from the update Δ(e, r, ω) for this edge, role, and category, and the corresponding reputation at time t, ƒt (e, r, ω), as:

ƒₜ₊₁(e, r, ω)=aƒₜ(e, r, ω)+bΔ(e, r, ω)

The coefficients are initially, a=0.9, b=0.1. After the described technologies amasses data on a significant number of campaigns the described technologies can dynamically vary them using machine learning techniques.

The continuous update of reputation along time incorporates time-based effects into the reputation. Thus, considering the landscape of reputation, active users can have their reputation evolve, while less active users can be left behind. Our discussion so far assumed reputation for a node can be defined as the sum of its influence along outgoing edges in the influence graph. Hence, the relative weight of outgoing edges from a node in the influence graph can vary over time, thereby taking into account time-based effects. One may consider whether the sum of influence across edges can be the best aggregation function, or we can consider functions like, maximum or median. In certain implementations, the described technologies can be configured to dynamically change the aggregation function using machine learning techniques.

Each such update can be done for each edge along each role separately, and within each role along each category separately.

Update of the global reputation as a result of changes to the external reputation can follow this pattern, for the same reasons.

The update to the global reputation can occur with a certain time frequency, to be configured by the described technologies, in order to smooth variations at two levels:

1. Across contracts

2. Along the lifetime of each contract—as the local reputation acts as a mediator and smoother of the updates to the local reputation

Given this mechanism of global update, we can specify in detail how we do the local reputation update, manually, and automatically.

Automatic Local Update

Let us break the automatic local update to the various cases. The two simpler cases are the updates for events within a campaign:

1. Update on referral—no update—as any such update can incentivize spam.

2. Update on conversion—for the converter and influencers participating in the conversion DAG of that conversion.

The update for a converter cv can be to its converter role for the campaign category—one unit can be added to its reputation, by adding to each inverse of outgoing edge in conversion DAG, cdag:

1/(number of outgoing edges from cv in cdag)

thereby ensuring the reputation of the node can be incremented by 1.

The update for an influencer can be proportional to its reward relative to the total reward for this conversion. This update can be done by adding to each inverse of incoming edge into the influencer in the conversion DAG:

1/(number of incoming edges in conversion DAG)

The reputation of a contractor at the start of the campaign, can be increased for the category of the campaign, by adding 1/(number of outgoing edges in referral graph) to each edge from the contractor to a node in the source seeding.

The reputation of a contractor can be decreased at the end of the campaign by the difference between full conversion and actual conversion in order to reflect to future influencers how worthy it can be to work for a campaign for that contractor. This decrease can be performed by decreasing the influence of the contractor on each node in the source seeding by (1-conversation ratio)/(number of outgoing edges from contractor in referral graph).

At the end of a campaign, the described technologies can update the reputation with a summary of the campaign. For a converter, the described technologies can be configured to determine how significant was the conversion relative to the overall performance. So the update can be a weighted sum of:

1. The inverse of the conversion rate of the campaign—you are more valuable in a tougher campaign

2. The quotient of the number of conversions and the desirable number of conversions—how close are we to the goal—or it was a total failure overall

The weight for the inverse of the conversion rate can be larger because lower success thresholds may be subject to dishonest gaming by contractors.

This update can be done by dividing it by the number of incoming edges to the converter in the referral graph, and updating the influence degree of each edge.

At the end of a campaign, the reputation of influencers in the referral graph of the campaign can reflect some measure of effort, beyond the direct contribution to conversion, as can be done with each conversion. This update can be important to reflect to the contractor the effort invested by influencers. This can be important substantially, as these influencers have a value in brand awareness. Globally, the ability of influencers to spread the word, expands the utility of the the described technologies/ecosystem for future campaigns, and can impact the influencer bid in future campaigns. On the other hand, the magnitude given to the update due to just referral can be much smaller than that for a referral which can be part of the conversion graph, in order to protect against spam. Moreover, effort can be relativized to the size of referral graph as we are interested in direct and short campaigns.

Hence, the reputation of an influencer v can be updated at the end of a campaign, based on the referral graph R, using the referral as a weighted sum of:

1. Inverse of the product of the size of the graph and the lifetime of the campaign—participating in short and targeted campaigns can be encouraged

1/(size of R*lifetime of campaign)

2. Ratio of the quantity of edges in the referral graph outgoing from the influencer that were part of some conversion DAG, and the total number of outgoing edges from the influencers in the referral graph.

(Σ_{cdag} in R|outgoing edges from v in cdag|)/|outgoing edges from v in referral graph|

This update cart be done by dividing it across all outgoing edges from the influencer at the referral graph.

Manual Local Update

Manual update involves two individuals: the subject and the reporter—the reporter wants to update the reputation of the subject. Each update applies always to edges outgoing from the subject.

Manual update has two goals, tuning and spans reporting. For the sake of tuning, the described technologies can be configured to smooth the manual update to avoid wild swings, and for the same of fighting we can protect against the spam being spam itself. The dampening effect of equation (1) can be generally useful for this smoothing effect. The coefficient for the update can be much smaller than for an automatic update for this reason.

To protect against the manual update being spam itself, we need the coefficient of update to incorporate some filtering with respect to the known facts about the performance of the subject. And similarly to protect the interests of the contractor and any other participant, the described technologies can be configured to filter any tuning so as not to damage an ongoing successful operation.

As global reputation can be derived from local reputation, these measures can be needed to protect the described technologies/ecosystem itself.

The following guidelines can be used to set the coefficient for update.

Hence, the coefficient for an influencer subject is:

1. Inversely proportional to the ratio of the number of outgoing edges from the subject in the referral graph participating in a conversion DAG to the total number of outgoing edges from the subject in the referral graph

The coefficient for a contractor reporter is:

1. Size of referral graph of campaign—reduce the risk from a small operation spam

2. Conversion rate of the campaign—a total failure cannot tweak the system

To avoid wild swings for any reporter and subject:

1. Inversely proportional to derivative with respect to time of the conversion of the campaign—normalized to the size of the referral graph—if it can be going well—do not damage the automatic operation through tuning. So tuning can be most beneficial in the beginning

To avoid wild swings for an influencer reporter, the coefficient is:

1. Inversely proportional to derivative with respect to time of the amount of reward assigned during the campaign—normalized to the size of the referral graph—if rewards flow, we downplay complaints.

Machine Learning

As more data can be accumulated, the described technologies can refine the functions and weights used in the update of reputation, both the update of the global reputation from the local reputation, and the update of the local reputation.

Groups

The described technologies can enable organic distribution so naturally we expect an influencer to share a referral to large groups, e.g., via social media services. Such an influencer membership in the group can be reflected in the influencer external reputation, thereby bringing into the described technologies reputation model the influencer potential for referral through groups. Such membership when actually used within a campaign can be transformed from a potential to an actual referral which may lead to further referrals by the members of the group.

Working with blockchain technology in mind, the described technologies can incorporate such groups as nodes in the influence graph, the referral graph, and the reputation model. Naturally, as such groups are owned or moderated, the described technologies can reward their owners and moderators, and reward influencers for sharing to such groups.

However, as the described incentive model as described so far can prevent spam, and hence penalizes influencers for widespread distribution, a special treatment can be needed for groups because for groups widespread distribution can be the norm. Such a treatment can be Sybil attack proof, to protect against fake groups and fake membership in real groups.

We next discuss in detail, the special treatment to be given to groups within the described general incentive model.

No Bid to Groups

While groups are influencer nodes in the referral graph, we have no conditions on them. The referral quota, the referral cost, and the reward projection do not apply to them as they are not applicable. They are applicable to any member of a group that becomes an influencer by doing a referral.

The Reward Model for Groups

Considering groups as influencers, the described reduction in the reward for actions phase of the reward because of a large number of outgoing links can be just as applicable for groups. It prevents spun, and encourages sharing for targeted groups. However, it can incentivize a group when many of its outgoing referrals were part of conversion, as the group can be rewarded for the conversion.

The Reputation Update for Groups—All the considerations for an individual are applicable to the group.

Sybil Attack Proof—As a group cannot be a converter, and the reward model can be the same for groups and individuals, the described Sybil attack proof holds.

The Campaign User Interface

The incentive model can be built from several layers of algorithms and computation, yet to the contractor it provides a simple user interface with a few knobs. Essentially, the contractor can select the form of several trajectories from which the campaign policy and the bid can be derived throughout the lifetime of the campaign.

For the campaign policy:
The form of the conversion rate trajectory
The form of the reward trajectory

For the bid:
The referral quota trajectory as a function of influencer reputation
The cost of referral trajectory as a function of normalized influencer reputation.

It should also be noted that while the technologies described herein are illustrated primarily with respect to a decentralized protocol for maintaining cryptographically proven multi-party state networks, the described technologies can also be implemented in any number of additional or alternative settings or contexts and towards any number of additional objectives. It should be understood that further technical advantages, solutions, and/or improvements (beyond those described and/or referenced herein) can be enabled as a result of such implementations.

Certain implementations are described herein as including logic or a number of components, modules, or mechanisms. Modules can constitute either software modules (e.g., code embodied on a machine-readable medium) or hardware modules. A “hardware module” is a tangible unit capable of performing certain operations and can be configured or arranged in a certain physical manner. In various example implementations, one or more computer systems (e.g., a standalone computer system, a client computer system, or a server computer system) or one or more hardware modules of a computer system (e.g., a processor or a group of processors) can be configured by software (e.g., an application or application portion) as a hardware module that operates to perform certain operations as described herein.

In some implementations, a hardware module can be implemented mechanically, electronically, or any suit able combination thereof. For example, a hardware module can include dedicated circuitry or logic that is permanently configured to perform certain operations. For example, a hardware module can be a special-purpose processor, such as a Field-Programmable Gate Army (FPGA) or an Application Specific Integrated Circuit (ASIC). A hardware module can also include programmable logic or circuitry that is temporarily configured by software to perform certain operations. For example, a hardware module can include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) can be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering implementations in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor can be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In implementations in which multiple hardware modules are configured or instantiated at different times, communications between such hardware modules can be achieved, for example, through the storage and retrieval of information in memory structures to which the multiple hardware modules have access. For example, one hardware module can perform an operation and store the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by ore or more processors that are temporarily configured (e.g., by software) or permanently configured to perform the relevant operations. Whether temporarily or permanently configured, such processors can constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors can also operate to support performance of the relevant operations in a “cloud computing” environment or as a “software as a service” (SaaS). For example, at least some of the operations can be performed by a group of computers (as examples of machines including processors), with these operations being accessible via a network (e.g., the Internet) and via one or more appropriate interfaces (e.g., an API).

The performance of certain of the operations can be distributed among the processors, not only residing within a single machine, but deployed across a number of machines. In some example implementations, the processors or processor-implemented modules can be located in a single geographic location (e.g., within a home environment, an office environment, or a server farm). In other example implementations, the processors or processor-implemented modules can be distributed across a number of geographic locations.

The modules, methods, applications, and so forth described herein are implemented in some implementations in the context of a machine and an associated software architecture. The sections below describe representative software architecture(s) and machine (e.g., hardware) architecture(s) that are suitable for use with the disclosed implementations.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture can yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

FIG. 8 is a block diagram illustrating components of a machine 800, according to some example implementations, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein can be executed. The instructions 816 transform the general, non-programmed machine into a particular machine programmed to carry out the described and illustrated functions in the manner described. In alternative implementations, the machine 800 operates as a standalone device or can be coupled (e.g., networked) to other machines. In a networked deployment, the machine 800 can operate in the capacity of a server machine or a client machine in a server-client network environment, or as a peer machine in a peer-to-peer (or distributed) network environment. The machine 800 can comprise, but not be limited to, a server computer, a client computer, PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 can include processors 810, memory/storage 830, and I/O components 850, which can be configured to communicate with each other such as via a bus 802. In an example implementation, the processors 810 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) can include, for example, a processor 812 and a processor 814 that can execute the instructions 816. The term “processor” is intended to include multi-core processors that can comprise two or more independent processors (sometimes referred to as “cores”) that can execute instructions contemporaneously. Although FIG. 8 shows multiple processors 810, the machine 800 can include a single processor with a single core, a single processor with multiple cores (e.g., a multi-core processor), multiple processors with a single core, multiple processors with multiples cores, or any combination thereof.

The memory/storage 830 can include a memory 832, such as a main memory, or other memory storage, and a storage unit 836, both accessible to the processors 810 such as via the bus 802. The storage unit 836 and memory 832 store the instructions 816 embodying any one or more of the methodologies or functions described herein. The instructions 816 can also reside, completely or partially, within the memory 832, within the storage unit 836, within at least one of the processors 810 (e.g., within the processor's cache memory), or any suitable combination thereof, during execution thereof by the machine 800. Accordingly, the memory 832, the storage unit 836, and the memory of the processors 810 are examples of machine-readable media.

As used herein, “machine-readable medium” means a device able to store instructions (e.g., instructions 816) and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 816. The term “machine-readable medium” shall also be taken to include any medium, or combination of multiple media, that is capable of storing instructions (e.g., instructions 816) for execution by a machine (e.g., machine 800), such that the instructions, when executed by one or more processors of the machine (e.g., processors 810), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 850 can include a wide variety of components to receive input, provide output, produce output, transmit information, exchange information, capture measurements, and so on. The specific 110 components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 can include many other components that are not shown in FIG. 8. The I/O components 850 are grouped according to functionality merely for simplifying the following discussion and the grouping is in no way limiting. In various example implementations, the I/O components 850 can include output components 852 and input components 854. The output components 852 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), visual input components (e.g., a camera, such as may be configured to capture and/or detected image(s) of QR codes and/or other content) and the like.

In further example implementations, the I/O components 850 can include biometric components 856, motion components 858, environmental components 860, or position components 862, among a wide array of other components. For example, the biometric components 856 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 858 can include acceleration sensor components (e.g., accelerometer), gravitation sensor components, rotation sensor components (e.g., gyroscope), and so forth. The environmental components 860 can include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that can provide indications, measurements, or signals corresponding to a surrounding physical environment. The position components 862 can include location sensor components (e.g., a Global Position System (GPS) receiver component), altitude sensor components (e.g., altimeters or barometers that detect air pressure from which altitude can be derived), orientation sensor components (e.g., magnetometers), and the like.

Communication can be implemented using a wide variety of technologies. The I/0 components 850 can include communication components 864 operable to couple the machine 800 to a network 880 or devices 870 via a coupling 882 and a coupling 872, respectively. For example, the communication components 864 can include a network interface component or other suitable device to interface with the network 880. In further examples, the communication components 864 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 870 can be another machine or any of a wide variety of peripheral devices (e.g., a peripheral device coupled via a USB).

Moreover, the communication components 864 can detect identifiers or include components operable to detect identifiers. For example, the communication components 864 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information can be derived via the communication components 864, such as location via Internet Protocol (IP) geolocation, location via Wi-Fi® signal triangulation, location via detecting an NFC beacon signal that can indicate a particular location, and so forth.

In various example implementations, one or more portions of the network 880 can be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fir network, another type of network, or a combination of two or more such networks. For example, the network 880 or a portion of the network 880 can include a wireless or cellular network and the coupling 882 can be a Code Division Multiple Access (CDMA) connection, a Global System for Mobile communications (GSM) connection, or another type of cellular or wireless coupling. In this example, the coupling 882 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 8G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 816 can be transmitted or received over the network 880 using a transmission medium via a network interface device (e.g., a network interface component included in the communication components 864) and utilizing any one of a number of well-known transfer protocols (e.g., HTTP). Similarly, the instructions 816 can be transmitted or received using a transmission medium via the coupling 872 (e.g., a peer-to-peer coupling) to the devices 870. The term “transmission medium” shall be taken to include any intangible medium that is capable of storing, encoding, or carrying the instructions 816 for execution by the machine 800, and includes digital or analog communications signals or other intangible media to facilitate communication of such software.

Throughout this specification, plural instances can implement components, operations, or structures described as a single instance. Although individual operations of one or more methods are illustrated and described as separate operations, one or more of the individual operations can be performed concurrently, and nothing requires that the operations be performed in the order illustrated. Structures and functionality presented as separate components in example configurations can be implemented as a combined structure or component. Similarly, structures and functionality presented as a single component can be implemented as separate components. These and other variations, modifications, additions, and improvements fall within the scope of the subject matter herein.

Although an overview of the inventive subject matter has been described with reference to specific example implementations, various modifications and changes can be made to these implementations without departing from the broader scope of implementations of the present disclosure. Such implementations of the inventive subject matter can be referred to herein, individually or collectively, by the term “invention” merely for convenience and without intending to voluntarily limit the scope of this application to any single disclosure or inventive concept if more than one is, in fact, disclosed.

The implementations illustrated herein are described in sufficient detail to enable those skilled in the art to practice the teachings disclosed. Other implementations can be used and derived therefrom, such that structural and logical substitutions and changes can be made without departing from the scope of this disclosure. The Detailed Description, therefore, is not to be taken in a limiting sense, and the scope of various implementations is defined only by the appended claims, along with the full range of equivalents to which such claims are entitled.

As used herein, the term “or” can be construed in either an inclusive or exclusive sense. Moreover, plural instances can be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and can fall within a scope of various implementations of the present disclosure. In general, structures and functionality presented as separate resources in the example configurations can be implemented as a combined structure or resource. Similarly, structures and functionality presented as a single resource can be implemented as separate resources. These and other variations, modifications, additions, and improvements fall within a scope of implementations of the present disclosure as represented by the appended claims. The specification and drawings are, accordingly, to be regarded in an illustrative rather than a restrictive sense.

What is claimed is:

1. A system comprising:
a processing device; and
a memory coupled to the processing device and storing instructions that, when executed by the processing device, cause the system to perform operations comprising:
receiving a first link comprising a first private key generated with respect to a first user;
generating, with respect to a second user, a key pair comprising a second private key and a second public key;
computing, using the first private key, a cryptographic signature of the second public key; and
generating a second link comprising the second private key and the cryptographic signature.

2. The system of claim 1, further comprising disseminating the second link.

3. The system of claim 1, wherein the first private key corresponds to a first public key.

4. The system of claim 3, wherein the first public key is associated with a smart contract.

5. The system of claim 1, wherein the second link further comprises one or more parameters that define one or more aspects of a subsequent dissemination of the second link.

6. The system of claim 5, wherein the second link further comprises a weight assigned by the second user.

7. The system of claim 1, wherein computing a cryptographic signature comprises computing the cryptographic signature via a decentralized application accessed via the first link.

8. The system of claim 1, wherein the first link initiates execution of a decentralized application.

9. The system of claim 1, wherein generating a second link comprises generating a reference to a storage resource that stores the second public key and the cryptographic signature.

10. The system of claim 1, wherein the first link further comprises a contract address.

11. The system of claim 1, wherein the second link further comprises a signature generated using another private key associated with the second user.

12. The system of claim 1, wherein the second link further comprises a weight assigned by the second user.

13. The system of claim 1, wherein the second link further comprises an address associated with the first user.

14. The system of claim 13, wherein the second link further comprises a signature of at least the second public key.

15. The system of claim 13, wherein the second link further comprises a signature of at least the second public key and an address associated with the second user.

16. The system of claim 1, wherein the second link further comprises an address associated with the second user.

17. The system of claim 16, wherein the second link further comprises a signature of at least the second public key and the address associated with the second user.

18. The system of claim 1, wherein the second link further comprises one or snore parameters.

19. The system of claim 18, wherein the one or more parameters comprise at least one of: one or more parameters that define one or more aspects of a subsequent dissemination of the second link, a contract address, an identifier associated with the second user, or a weight assigned by the second user.

20. The system of claim 18, wherein the one or more parameters comprise at least one of: one or more parameters provided by the first user within the first link.

21. The system of claim 18, wherein the one or more parameters comprise one or more parameters associated with the second user.

22. The system of claim 21, wherein computing a cryptographic signature comprises computing a cryptographic signature of the second public key and the one or more parameters.

23. The system of claim 1, wherein the second link further comprises one or more parameters corresponding to one or snore other users associated with the first link.

24. The system of claim 1, wherein the second link further comprises one or more parameters corresponding to one or more users associated with the first link other than the first user and the second user.

25. The system of claim 1, wherein the second link further comprises content from the first link without the first private key.

26. A system comprising:
a processing device; and
a memory coupled to the processing device and storing instructions that, when executed by the processing device, cause the system to perform operations comprising:
receiving a first link comprising a first secret associated with a first user;
computing a zero knowledge cryptographic proof that a second user received the first secret, wherein the proof requires knowledge of an identifying parameter associated with the second user; and
generating a second link comprising a second secret associated with the second user and the zero knowledge cryptographic proof.

27. The system of claim 26, wherein the identifying parameter comprises an address associated with the second user.

28. The system of claim 26, wherein computing a zero knowledge cryptographic proof comprises computing a zero knowledge cryptographic proof that the second user knew the value of the first secret.

29. The system of claim 26, wherein computing a zero knowledge cryptographic proof comprises computing a zero knowledge cryptographic proof that the second user knew the value of the first secret without exposing the first secret.

30. The system of claim 26, wherein the proof requires public knowledge of the identifying parameter associated with the second user.

31. The system of claim 26, wherein the proof requires public knowledge of the identifying parameter associated with the second user and one or more other parameters added to the second link by the second user.

32. The system of claim 26, wherein the zero knowledge cryptographic proof comprises a cryptographic signature.

33. The system of claim 26, wherein the zero knowledge cryptographic proof comprises a cryptographic signature in which the identifying parameter associated with the second user is signed with the first secret.

34. The system of claim 26, wherein the first link further comprises another zero knowledge cryptographic proof.

35. The system of claim 34, wherein the computed zero knowledge cryptographic proof is aggregated into the zero knowledge cryptographic proof included in the first link.

36. The system of claim 26, wherein the second link further comprises content from the first link.

37. The system of claim 26, wherein the second link further comprises content from the first link without the first secret.

38. The system of claim 26, wherein the second link further comprises content from the first link without the first secret.

39. A system comprising:
a processing device; and
a memory coupled to the processing device and storing instructions that, when executed by the processing device, cause the system to perform operations comprising:
receiving a first link comprising a first secret associated with a first user;
computing a zero knowledge cryptographic proof that a second user received the first secret; and
generating a second link comprising a second secret associated with the second user and the zero knowledge cryptographic proof.

40. The system of claim 39, wherein the first secret comprises a first private key.

41. The system of claim 40, wherein the zero knowledge cryptographic proof comprises a cryptographic signature of an identifying parameter associated with the second user, wherein the cryptographic signature is generated using the first private key.

42. The system of claim 39, wherein the second link further comprises an identifying parameter associated with the second user.

43. A system comprising:
a processing device; and
a memory coupled to the processing device and storing instructions that, when executed by the processing device, cause the system to perform operations comprising:
receiving a first link comprising a first secret associated with a first user;
computing a zero knowledge cryptographic proof that a second user knew the value of the first secret without exposing it, wherein the proof requires the public knowledge of an identifier associated with the second user; and
generating a second link comprising a second secret associated with the second user and the zero knowledge cryptographic proof.

44. A method comprising:
receiving, from a first user, a contract initiation request;
generating, in response to the contract initiation request, a contract address;
providing the contract address to the first user;
receiving, from a second user, an activation of a first link containing the contract address and generated by the first user;
receiving, from a third user, an activation of a second link generated by the second user and containing the contract address; and
initiating an execution of the contract with respect to the third user.

45. The method of claim 44, wherein the contract initiation request further comprises one or more parameters associated with the rout met.

46. The method of claim 44, wherein the contract initiation request further comprises a public key associated with the first user.

47. The method of claim 44, wherein the contract initiation request further comprises a bounty provided by the first user.

48. The method of claim 44, wherein the contract initiation request further comprises an address within a decentralized network and a cryptographic signature of the address, wherein the cryptographic signature of the address is generated using a secret inserted into the second link by the second user.

49. The method of claim 44, wherein the contract initiation request further comprises an address within a decentralized network.

50. The method of claim 44, wherein initiating an execution of the contract comprises validating one or more signatures within the second link.

51. A non-transitory computer readable medium having instructions stored thereon that, when executed by a processing device, cause the processing device to perform operations comprising:
receiving a first link comprising a first private key generated with respect to a first user;
generating, with respect to a second user, a key pair comprising a second private key and a second public key;
computing, using the first private key, a cryptographic signature of the second public key via a decentralized application accessed via the first link; and
generating a second link comprising the second public key, the cryptographic signature, and a signature generated using another private key associated with the second user.
